(19) United States
(12) Patent Application Publication
(10) Pub. No.: US 2026/0306966 A1
(43) Pub. Date: Oct. 8, 2026

(54) DEVICES, SYSTEMS, AND METHODS FOR THE ANALYSIS OF MEMBRANE-MEDIATED PROCESSES

(71) Applicant: THE ADMINISTRATORS OF THE TULANE EDUCATIONAL FUND, New Orleans, LA (US)

(72) Inventors: Wayne F. REED, New Orleans, LA (US); Curtis W. JARAND, New Orleans, LA (US)

(21) Appl. No.: 19/479,054

(22) PCT Filed: Apr. 26, 2024
(86) PCT No.: PCT/US2024/026575

§ 371 Date: Oct. 27, 2025

Related U.S. Application Data
(60) Provisional application No. 63/498,403, filed on Apr. 26, 2023.
(60) Provisional application No. 63/545,333, filed on Oct. 23, 2023.

(51) Int. Cl. B01D 15/10

(52) U.S. Cl. CPC B01D 15/10; B01D 2313/21; B01D 2313/345; B01D 2313/365; B01D 2313/60

(57) ABSTRACT

Disclosed are devices, systems, and methods that relate to the real-time monitoring of membrane-mediated processes between two fluids in a receptacle separated by a membrane. The receptacle can be placed in a principal monitoring instrument, which can monitor one or more properties of one of the fluids during the membrane-mediated process. Optionally, one or both fluids can also circulate through external flow paths, allowing reservoirs for volume proportioning between the two fluids. Optionally, the fluids in these external flow paths can be characterized using one or more external monitoring instruments. Optionally, electrodes inside the receptacle can measure conductivity and ionic concentration in the first fluid, and can be used at higher electric fields to affect properties of macromolecules and colloids in the first fluid.

### CROSS-REFERENCE TO RELATED APPLICATIONS

This application claims benefit of priority of U.S. Provisional Application No. 63/498,403, filed Apr. 26, 2023, and U.S. Provisional Application No. 63/545,333, filed Oct. 23, 2023, each of which is hereby incorporated by reference in its entirety.

### BACKGROUND

The transfer of molecules and other agents between liquids separated by membranes occurs in widely different contexts. These include chemical dialysis, separation of ions, gases, and perfusion through selective membranes by many different types of substances. ‘Dialysis’ as used herein includes diafiltration, ultrafiltration, microfiltration, and other membrane-mediated separation, purification, and exchange processes. Because these transfer processes are time-dependent, much understanding can be gained by monitoring properties of the transfer process and the effects that the transfer may have on various substances, such as small molecules, polymers, and colloids, including biological cells, clusters of cells, and cellular organelles. If one or more additional measuring instruments is used, the behavior of substances involved in the membrane-mediated processes can also be represented versus concentrations of substances involved, independently of time.

As an example, membrane dialysis is frequently employed in chemical, biochemical, pharmaceutical, and other sectors for a variety of purposes. In many cases dialysis is used to purify compounds after they have been synthesized or extracted from some organism. In other cases it is desirable to change the solution conditions of a polymer or colloid solution, such as eliminating soluble components—e.g. ions or small molecules—or controlling the concentration of soluble small molecules. Dialysis is often used to change from the solvent a polymer or colloid is in, to another type of solvent; e.g. from an organic solvent to an aqueous solvent, or vice versa. In other cases, such as a disperse polymer sample, dialysis membranes can remove oligomers and small polymers from larger ones.

In these processes the properties of polymers and colloids can change as solution conditions change. As an example, electrically charged natural and synthetic polymers (polyelectrolytes) and colloids are sensitive to ionic strength, that is, the concentration of dissolved simple electrolyte. Natural polyelectrolytes include RNA, DNA, proteins, many polysaccharides, and associations among these. As ionic strength decreases a polyelectrolyte will generally swell, while a polyampholyte (a polymer bearing both positive and negative charges) will generally shrink. When organized structures, such as DNA, RNA and proteins in their native state are placed in chaotropic solutions, such as those containing guanidine hydrochloride or urea, the structures will usually unfold, that is, become denatured. Some solvents and solvent conditions, such as temperature, can cause reversible associations and dissociations among charged polymers, while others can lead to irreversible associations, or aggregates.

Given the importance of such membrane-mediated processes in a wide variety of fields, especially in the discovery and formulation of biologic drugs, improved devices, systems, and methods for analyzing membrane-mediated processes, particularly in real-time, are needed.

### SUMMARY

Described herein are devices, systems, and methods that relate to the real-time monitoring of time-dependent membrane-mediated processes between two different fluids in a receptacle separated by a membrane. The receptacle containing the fluids separated by the membrane can be placed in a principal monitoring instrument, which can monitor one or more properties of one of the fluids during the time-dependent membrane-mediated process. Optionally, one or both fluids can also circulate through external flow paths, allowing reservoirs for volume proportioning between the two fluids. If desired, the fluids present in these external flow paths can be further characterized using one or more external monitoring instruments configured to interrogate fluids circulating within these flow paths. Thus, these systems can be used to collect multiple simultaneous measurements of the fluids independently, providing a wealth of information by which to assess characteristics of the membrane and/or membrane-mediated processes occurring within the fluids.

These devices, systems, and methods can provide many capabilities, including the ability to analyze how the properties of polymers or colloids in solution change as they are being dialyzed, to quantitatively establish when dialysis is complete, and/or to control aspects of a dialysis process. The devices, systems, and methods described herein can allow for the monitoring and/or study of the transfer of small molecules between two liquids separated by a membrane, including the transfer of ions, gases, dyes, fluorophores, surfactants, oligomers, emulsifiers, chelating agents, buffer components, biocides, toxins, drugs, and monomers. The devices, systems, and methods described herein can also allow for the monitoring and/or study of the response of biological cells to stimuli, such as potential toxins, potential active agents, and/or changes in environmental conditions such as tonicity. The devices, systems, and methods described herein can also be used to assess the reversibility of a membrane-mediated process, such as the reversibility of denaturation of proteins or polynucleic acids.

By way of example, in some aspects, the techniques described herein relate to a system including: a receptacle housing a first fluid and a second fluid, wherein the first fluid and the second fluid are separated by a membrane; and a principal monitoring instrument configured to repeatedly interrogate the first fluid; wherein the receptacle is reversibly insertable within the principal monitoring instrument.

Optionally, the system can include a first fluid circulation path through which the first fluid is circulated, a second fluid circulation path through which the second fluid is circulated, or a combination thereof. For example, the system can include a first fluid circulation path through which the first fluid is circulated, but not a second fluid circulation path through which the second fluid is circulated. Alternatively, the system can include a second fluid circulation path through which the second fluid is circulated, but not a first fluid circulation path through which the first fluid is circulated. Alternatively, the system can include a first fluid circulation path through which the first fluid is circulated and a second fluid circulation path through which the second fluid is circulated.

In some aspects, the system can further include a first fluid circulation path fluidly connected to the first fluid. Such a first fluid circulation path can be a closed-loop circulation path or an open-loop circulation path. In some aspects, the first fluid circulation path can terminate in a waste container. In some aspects, the first fluid circulation path can further include an external reservoir, at least one external monitoring instrument configured to repeatedly interrogate the first fluid present in the first fluid circulation path, or a combination thereof. The at least one external monitoring instrument can include, for example, a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a chromatographic separation system allowing periodic injection of small aliquots of the first fluid present in the first fluid circulation path, or a combination thereof. In certain aspects, the first fluid circulation path passes through a flow-cell equipped instrument.

In some aspects, the system can further include a second fluid circulation path fluidly connected to the second fluid. Such a second fluid circulation path can be a closed-loop circulation path or an open-loop circulation path. In some aspects, the second fluid circulation path can terminate in a waste container. In some aspects, the second fluid circulation path can further include an external reservoir, at least one external monitoring instrument configured to repeatedly interrogate the second fluid present in the second fluid circulation path, or a combination thereof. The at least one external monitoring instrument can include, for example, a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a chromatographic separation system allowing periodic injection of small aliquots of the second fluid present in the second fluid circulation path, or a combination thereof. In certain aspects, the second fluid circulation path passes through a flow-cell equipped instrument.

The first fluid and the second fluid can have the same or different compositions. In some examples, the first fluid, the second fluid, or a combination thereof can include a mixture of components. For example, in some embodiments, the first fluid, the second fluid, or a combination thereof can include a small molecule, a polymer, a colloid, or a combination thereof. In some aspects, the first fluid and the second fluid have different compositions.

In some aspects, the membrane can include a dialysis membrane, an ion-selective membrane, a 3D membrane, a biological membrane, or a synthetic biological membrane. In some aspects, the membrane can be hydrophilic. In other aspects, the membrane can be hydrophobic.

In some aspects, the receptacle can be reversibly insertable within a sample holder disposed within the principal monitoring instrument. For example, in some embodiments, the receptacle can be dimensioned to be inserted within a sample holder disposed within the principal monitoring instrument. In some examples, the receptacle has a perimeter defined by a geometric shape chosen from square, rectangular, polygonal, hemi-polygonal, and circular. In certain aspects, the receptacle can include a 1 cm pathlength cuvette cell sized to be received within a sample holder of a spectrometer.

The receptacle can be fabricated from any suitable material. In certain examples, the receptable can be fabricated from an optically transparent material, such as glass, quartz, or a polymer (e.g., a plastic). In certain aspects, the receptacle can be fabricated from quartz when the principal monitoring instrument interrogates or emits electromagnetic radiation in the ultraviolet (UV) region of the electromagnetic spectrum, such as for example, UV absorption spectrometers and fluorimeters.

In some aspects, the receptacle can include a cap assembly. In some embodiments, the cap assembly can be separately formed from the receptacle and insertable (or seatable) within the receptacle. In other embodiments, the cap assembly can be fused with the receptacle. In some examples, the membrane can be mounted on the cap assembly. The cap assembly can further include one or more fluid inlets and one or more fluid outlets to provide for fluid connection of external circulation paths (if desired).

In some aspects, the first and second fluids in the receptacle can be partitioned by a sheet formed from the membrane secured by a hermetic sealing means.

In some aspects, the techniques the principal monitoring instrument can be chosen from include a static light scattering detector, a dynamic light scattering detector, combined static and dynamic light scattering detector, a fluorimeter, an absorption spectrometer, a refractometer, a differential refractometer, a turbidity monitor, an NMR, a polarimeter, or a circular birefringence or circular dichroism detector. In some aspects, the principal monitoring instrument can measure more than one property of the first fluid. For example, in some embodiments, the principal monitoring instrument can measure more than one property of the first fluid selected from static light scattering, dynamic light scattering, fluorescence, ultraviolet absorption, visible absorption, turbidity, and infrared absorption.

In some aspects, the principal monitoring instrument can be configured to continuously interrogate the first fluid.

In some aspects, the principal monitoring instrument can be configured to interrogate the first fluid at discrete intervals. In some aspects, the system can be configured for real-time monitoring of a membrane-mediated chemical processes.

In some aspects, the system can further comprise an electrode assembly configured to apply an electric field within the receptacle. In some aspects, the electrode assembly can be positioned within the receptacle (e.g., in electrochemical contact with the first fluid, the second fluid, or a combination thereof). In other aspects, the electrode assembly can be positioned outside of the receptacle. In some aspects, the system can comprise an electrode assembly in electrochemical contact with the first fluid, the second fluid, or a combination thereof.

In some aspects, the system can further comprise a stirrer configured to stir/circulate the first fluid, the second fluid, or a combination thereof. In some aspects, the stirrer can provide for non-contact stirring on the first fluid, the second fluid, or a combination thereof.

Also provided herein are devices, including receptacles and cap assemblies, that can be used as components of the systems described herein. For example, provided herein are devices that comprise a cap assembly dimensioned to be received within and seal a receptacle, wherein the cap assembly includes: a body portion insertable within an opening of a receptable; and a mounting post extending from a bottom of the body portion, wherein the mounting post is configured for attachment of a membrane.

In some aspects, the cap assembly can be sized to be received within a 1 cm pathlength cuvette cell. Of course, other dimensions can be used, as well.

In some aspects, the cap assembly can further comprise a first fluid inlet and a first fluid outlet disposed on the body portion and fluidly extending to the bottom of the body portion so as to fluidly connect to a first fluid present within the receptacle when the cap assembly is disposed within an opening of the receptable.

In some aspects, the cap assembly can further comprise a second fluid inlet and a second fluid outlet disposed on the body portion and fluidly extending to the mounting post so as to fluidly connect to a second fluid present within a membrane affixed to the mounting post

In some aspects, the mounting post can include one or more grooves to facilitate attachment of the membrane via a clamp, o-rings, or other means.

In some aspects, the cap assembly can further include a stirrer extending from the bottom of the body portion. In some aspects, the cap assembly can further comprise a motor mounted on the body portion, and a drive shaft operatively coupling the stirrer to the motor.

In some aspects, the cap assembly can further include an access port. The access port can comprise, for example, an aperture (e.g., an opening or airtight access port such as a septum) in the cap assembly that allows a user to add or remove one or more species from the receptacle. In certain aspects, the access port can comprise a needle access port.

In some aspects, the cap assembly can further comprise an electrode support extending from a bottom of the body portion; and a first electrode and a second electrode disposed on the electrode support; wherein the first electrode and the second electrode are each electrically connected to a terminal disposed on the body portion. Such cap assemblies can be capable of (1) measuring the conductivity of the first fluid in the receptacle (e.g., rapidly and reliably, and with very low electric fields between the electrodes, typically much less than 1 V/cm), and/or (2) applying a larger electric field to the first fluid and its chemical contents, typically greater than 1V/cm, which can affect the properties and behavior of the first fluid and its chemical contents. When seated in a receptacle and placed into a principal monitoring instrument, such as a UV/visible spectrometer, fluorimeter, static light scattering, dynamic light scattering, circular dichroism, or other principal monitoring instrument, a user can monitor the effects of the electric field on the first fluid containing the chemical substances as a function of time and/or as a function of other chemical substances.

In some aspects, the electrode support can be dimensioned such that when the cap assembly is disposed within the receptacle, the electrode support extends into the receptacle such that the electrodes are in contact with a fluid present within the receptacle.

In some aspects, the electrode support, the first electrode, and the second electrode are dimensioned to allow for right angle (90°) detection when the cap assembly is seated in a receptacle and positioned within a principal monitoring instrument.

In some aspects, the electrode support, the first electrode, and the second electrode are dimensioned to allow for zero angle to low angle detection (0° to) 30° when the cap assembly is seated in a receptacle and positioned within a principal monitoring instrument.

In some aspects, the electrode support, the first electrode, and the second electrode are dimensioned to allow for transmission of incident electromagnetic radiation and backscatter detection (at angles of from 150° to) 180° when the cap assembly is seated in a receptacle and positioned within a principal monitoring instrument.

In some aspects, the first electrode and the second electrode comprise parallel plate electrodes. In other aspects, the first electrode and the second electrode comprise parallel wire mesh electrodes, or electrodes of other shape.

In some aspects, the first electrode and the second electrode are sized and positioned to generate an electric field that straddles the path length of incident electromagnetic radiation emitted by a principal monitoring instrument when the cap assembly is seated in a receptacle and positioned within the principal monitoring instrument.

In some aspects, the first electrode and the second electrode are separated by a distance of less than 10 mm, such as a distance of from 2 mm to 5 mm. The greater the ratio of the electrode width to interelectrode separation the more uniform the electric field between the plates will be. In some aspects, the cap assembly can further comprise (e.g., can be electrically connected to) a voltage source or current source (e.g., a power supply) and a current loop operatively coupled to the first electrode and the second electrode. The current loop can comprise a resistor; a volmeter configured to measure a voltage across the first electrode and the second electrode; and an ammeter configured to measure a current in the current loop which passes through the power supply, the resistor, the first electrode, and the second electrode. The resistor is chosen so that the power dissipation when the resistor R alone is connected across the power supply, the following expression is satisfied

$${V}_{0}^{2} / R < {P}_{max} ,$$

where Vₒ is the amplitude of the voltage of of the power supply, R is the resistance of the resistor, and Pₘₐₓ is the minimum value of the maximum power dissipations permissible for the power source and associated circuit components.

Also provided herein are methods of using the devices and systems described herein, for example, to monitor a membrane-mediated chemical process. For example, in some aspects, the method can include: introducing a first fluid and a second fluid into a receptacle, wherein the first fluid and the second fluid are separated by a membrane; inserting the receptacle into a principal monitoring instrument; and repeatedly interrogating the first fluid with the principal monitoring instrument.

The first fluid and the second fluid can have the same or different compositions. In some examples, the first fluid, the second fluid, or a combination thereof can include a mixture of components. For example, in some embodiments, the first fluid, the second fluid, or a combination thereof can include a small molecule, a polymer, a colloid, or a combination thereof. In some aspects, the first fluid and the second fluid have different compositions.

In some aspects, the method includes monitoring a change in one or more properties of the first fluid using the principal monitoring instrument.

In some examples, the first fluid can include a polymer, a colloid, a biologic drug, or a combination thereof, and the second fluid does not include a polymer, a colloid, or a combination thereof, but does includes an agent that can affect the polymer, the colloid, or the combination thereof present in the first fluid. For example, in some embodiments, the agent can be chosen from an electrolyte, a denaturing agent, an acid, a base, a surfactant, a chelating agent, an emulsifier, a toxin, a dye, a fluorescent probe, a lipid, a biocide, a drug, a dissimilar liquid phase, an artificial or biological oligomer, a sugar, an alcohol, a free amino acid, a buffering solution, or a combination thereof.

In some aspects, the membrane can include a dialysis membrane, an ion-selective membrane, a 3D membrane, a biological membrane, or a synthetic biological membrane. In some aspects, the membrane can be hydrophilic. In other aspects, the membrane can be hydrophobic.

In some aspects, the method can further include circulating the first fluid through a first fluid circulation path, wherein the first fluid circulation path can further include an external reservoir, one or more external monitoring instruments configured to repeatedly interrogate the first fluid present in the first fluid circulation path, or a combination thereof. In some aspects, the method further includes interrogating the first fluid present in the first fluid circulation path using the at least one external monitoring instrument. In some examples, the at least one external monitoring instrument includes a conductivity sensor, a pH sensor, an ion specific sensor, a dissolved gas sensor, a static light scattering detector, a dynamic light scattering detector, a fluorimeter, an absorption spectrophotometer, a polarimeter, Raman scattering detection, a circular dichroism or birefringence detector, a refractometer, an NMR, a turbidity monitor, a chromatographic separation system allowing periodic injection of small aliquots of the first fluid present in the first fluid circulation path, or a combination thereof.

In some aspects, the method can further include circulating the second fluid through a second fluid circulation path, such that the first fluid and the second fluid each flow through their own fluid circulation path. The second fluid circulation path can further include an external reservoir, one or more external monitoring instruments configured to repeatedly interrogate the second fluid present in the second fluid circulation path, or a combination thereof. In some aspects, the method further includes interrogating the second fluid present in the second fluid circulation path using the at least one external monitoring instrument. In some examples, the at least one external monitoring instrument includes a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a chromatographic separation system allowing periodic injection of small aliquots of the second fluid present in the second fluid circulation path, or a combination thereof.

In some aspects, repeatedly interrogating the first fluid with the principal monitoring instrument can include continuously interrogating the first fluid.

In some aspects, repeatedly interrogating the first fluid with the principal monitoring instrument can include interrogating the first fluid at discrete intervals.

In some aspects, the method further includes altering a composition of the first fluid over time while repeatedly interrogating the first fluid with the principal monitoring instrument.

In some aspects, the method further includes determining when the membrane-mediated chemical process is acceptably complete. In some aspects, the method further includes altering the composition of the second fluid when the membrane-mediated chemical process is acceptably complete.

In some embodiments, a plurality of the devices described herein can be utilized in parallel, for example, to simultaneously measure a plurality of membrane processes.

### DESCRIPTION OF DRAWINGS

FIG. 1. Conductivity vs time for the penetration of NaCl from a second fluid into a first fluid, which was initially free of NaCl. The conductivity is that of the second fluid in a recirculation loop that includes a conductivity meter in a reservoir in the loop.

FIG. 2A. Calibration curve for conductivity vs |NaCl|·β=92.47

FIG. 2B. Calibration curve for obtaining concentration of guanidine, |Gd|, as a function of measured conductivity σ.

FIG. 3. Conductivity (left-hand axis) vs time and [NaCl] (right-hand axis) vs conductivity (upper x-axis)

FIG. 4A. Decrease in UV absorbance in a first fluid containing acrylamide (Am), as the Am diffuses into a second fluid across a dialysis membrane.

FIG. 4B. Fluorescence intensity vs. time of fluorescein in a first fluid. It decreases in time as the fluorescein permeates through the dialysis membrane into the second fluid.

FIG. 5A. The scattering intensity of poly-L-lysine vs the ionic strength of a first fluid, represented as [NaCl].

FIG. 5B. Second virial coefficient A₂ vs [NaCl].

FIG. 6A. Scattering from bovine serum albumen (BSA) in the first fluid and conductivity of the second fluid vs. time. The second fluid contains 6M guanidine hydrochloride.

FIG. 6B. Light scattering from BSA in the first fluid, represented as M_{w}(t)/M₀ vs. the concentration of Gd in the first fluid.

FIG. 6C. The irreversibility of the BSA denaturation is seen as Gd leaves the BSA solution in the first fluid.

FIGS. 7A-7B. Example designs for devices including a cap assembly, allowing for circulation of a second fluid.

FIG. 8. An example design for the device including cap assembly, allowing for circulation of both a first fluid and a second fluid.

FIG. 9. An example design for device including a cap assembly, with capability for non-contact stirring and circulation of both a first fluid and a second fluid. Contact-stirring of proteins is known to cause aggregation of the proteins. Non-contact stirring has been demonstrated to significantly slow or eliminate protein aggregation. This leads to the embodiment where a shaft with a stir bar is seated in the cap and is driven by a magnetic coupling, or by a motor (e.g., stepping motor) without contacting the bottom or sides of the receptacle.

FIG. 10. An example design for device including a cap assembly, such as that shown in FIG. 7A, seated in a common cuvette (quartz, glass, plastic) with 1 cm pathlength.

FIG. 11. An example system including a receptacle coupled to external circulation using a peristaltic pump, and passing through a dialysate reservoir, whose conductivity is monitored.

FIG. 12. Block diagram showing an example system in which an automatic switching valve is ued to periodically inject circulating second fluid into a separation system, the latter comprising a pump, separation column or channel (for FFF), and separation system detectors.

FIG. 13. Schematic illustration of a system for automatic preparation of second fluid, involving two reservoirs, which can be mixed in any proportion using the proportionating valve.

FIG. 14A. A photograph showing an example device including cap assembly, allowing for circulation of a second fluid. A membrane is shown attached to the mounting post. The cap assembly is received within a 1 cm pathlength cuvette cell. The tubular dialysis membrane is sealed to the post with o-rings.

FIG. 14B shows an embodiment of the device wherein an integral non-contact stir capability is provided by the motor integrated into the cap assembly.

FIG. 14C shows the device of FIG. 14A with a separate electrode assembly on the bottom of the cuvette.

FIG. 14D shows the device of FIG. 14C with the integral stepper motor assembly and shaft for non-contact stir.

FIG. 15. A photograph showing an example system in which the receptacle (a 1 cm pathlength cuvette cell sealed with a cap assembly) is inserted within a Fluence Analytics ARGEN with recirculation of the second fluid. Conductivity measurements are performed in a flow path reservoir fluidly connected to the recirculation.

FIG. 16. A photograph showing an example system in which the receptacle (a 1 cm pathlength cuvette cell sealed with a cap assembly) is inserted within a commercial Ultraviolet/Visible spectrometer, Thermo Scientific Genesys 10S UV-Vis, with recirculation of the second fluid.

FIG. 17. A photograph showing an example system in which the receptacle (a 1 cm pathlength cuvette cell sealed with a cap assembly) is inserted within a commercial fluorimeter, Perkin Elmer LS50B Luminescence Spectrometer, with recirculation of the second fluid. Conductivity measurements are performed in a flow path reservoir fluidly connected to the recirculation.

FIG. 18. A photograph showing an example system in which the receptacle (a 1 cm pathlength cuvette cell sealed with a cap assembly) is inserted within a commercial dynamic light scattering instrument, Brookhaven Instruments Nanobrook Omni.

FIG. 19. A custom built dual-head peristaltic pump allows two independent membrane mediated processes to be run simultaneously (i.e., in parallel). For example, two receptacles containing the device can be placed in two separate principal monitoring instruments. Also, for instruments such as the Fluence Analytics ARGEN, multiple light scattering experiments can be performed simultaneously in the same instrument.

FIG. 20. An example design for a cap assembly that includes electrodes to facilitate conductivity measurements of a fluid present in the receptacle (e.g., in the first fluid). In this embodiment, parallel plate electrodes are positioned vertically adjacent to the optical path of the irradiation source from the principal monitoring instrument, allowing for the rapid and accurate conductivity measurements of a fluid present in the receptacle (e.g., a first fluid). A sealed dialysis membrane can be secured to the dialysis membrane mounting post.

FIG. 21. An example design for a cap assembly that includes electrodes to facilitate conductivity measurements of a fluid present in the receptacle (e.g., a first fluid). In this embodiment, parallel wire mesh electrodes are positioned parallel to the optical path of the irradiation source from the principal monitoring instrument, allowing for the rapid and accurate conductivity measurements of a fluid present in the receptacle (e.g., a first fluid). A sealed dialysis membrane can be secured to the dialysis membrane mounting post.

FIG. 22. An example design for a cap assembly that includes electrodes to facilitate conductivity measurements of a fluid present in the receptacle (e.g., a first fluid). In this embodiment, parallel wire mesh electrodes are positioned vertically adjacent to the optical path of the irradiation source from the principal monitoring instrument, allowing for the rapid and accurate conductivity measurements of a fluid present in the receptacle (e.g., a first fluid).

FIG. 23. An example design for a cap assembly that includes electrodes to facilitate conductivity measurements of a fluid present in the receptacle (e.g., a first fluid). In this embodiment, the parallel plate electrodes include an aperture in the optical path of the irradiation source from the principal monitoring instrument, allowing for the rapid and accurate conductivity measurements of a fluid present in the receptacle (e.g., a first fluid). A sealed dialysis membrane can be secured to the dialysis membrane mounting post. A stirring shaft with an impeller allows stirring of the first fluid through the use of a stepper motor located above the apparatus which is attached to the stirring shaft.

FIG. 24. An example design for a cap assembly that includes electrodes to facilitate conductivity measurements of a fluid present in the receptacle (e.g., a first fluid). In this embodiment, parallel wire mesh electrodes are positioned parallel to the optical path of the irradiation source from the principal monitoring instrument, allowing for the rapid and accurate conductivity measurements of a fluid present in the receptacle (e.g., a first fluid). A sealed dialysis membrane can be secured to the dialysis membrane mounting post. A stirring shaft with an impeller allows stirring of the first fluid through the use of a stepper motor located above the apparatus which is attached to the stirring shaft.

FIG. 25. An example electrode assembly that can be used to apply an electric field within a receptacle described herein (e.g., within fluids present within a receptacle described herein. The electrode assembly can be dimensioned such that a receptacle described herein (e.g., a cuvette) can be inserted within the electrode assembly. The electrode assembly can include one or more apertures within the electrodes to permit spectroscopic investigation of fluid(s) present within the receptacle.

FIG. 26. An example electrode assembly that can be used to apply an electric field within a receptacle described herein (e.g., within fluids present within a receptacle described herein. The electrode assembly can be dimensioned such that the electrode assembly can be inserted with a receptacle described herein (e.g., a cuvette). The electrode assembly can include one or more apertures within the electrodes to permit spectroscopic investigation of fluid(s) present within the receptacle.

FIG. 27. An example design for device including a cap assembly, with capability for non-contact stirring and circulation of a fluid present in the receptacle (e.g., a first fluid) . . . . Contact-stirring of proteins is known to cause aggregation of the proteins. Non-contact stirring has been demonstrated to significantly slow or eliminate protein aggregation. This leads to the embodiment where a shaft with an impeller is seated in the cap and is driven by an impeller motor mounted on the cap assembly. In this way, a fluid present in the receptacle (e.g., a first fluid) can be stirred without contacting the bottom or sides of the receptacle.

FIG. 28. An example design for device including a cap assembly, with capability for non-contact stirring and circulation of a fluid present in the receptacle (e.g., a first fluid). The cap assembly also includes electrodes to facilitate conductivity measurements of a fluid present in the receptacle (e.g., a first fluid).

FIG. 29. Kc/I_{R} vs [PSS] for PSS in 100 mM NaCl, with corresponding values of M_{w}, A₂, and A₃, obtained by the quadratic fit to the data.

FIG. 30. Complete dialysis cycle for 0.00326 g/cm³ PSS starting in 100 mM [NaCl] against pure water, and the reverse portion from 0.25 mM NaCl to 100 mM NaCl. [NaCl] in the PSS solution is also shown for the forward dialysis.

FIG. 31. A₂ and A₃ versus [NaCl]. The inset shows the ratio of 2A₂/A₃c, which measures the relative importance of the A₂ effect to the A₃ effect.

FIG. 32. d_{H,ap} obtained from <D>_{z} by Equation 17. At 3.27 mg/ml PSS the interchain hydrodynamic parameter k_{D} dominates d_{H,ap}, whereas at 0.50 g/ml the coil shrinkage with increasing [NaCl] dominates.

FIG. 33. The hydrodynamic interaction parameter k_{D} versus [NaCl] (mM) for PSS. Also shown is the dimensionless ratio of the combined A₂ and A₃ effects divided by the 1/M_{w} in Equation 1, represented in Equation 11.

FIG. 34. Apparent hydrodynamic diameter d_{H,ap} and scattering intensity for forward dialysis of 0.001 g/cm³ gelatin in 10 mM NaCl against 5M NaCl, and reverse against water.

FIG. 35. d_{H,ap} for dialysis of gelatin in 10 mM NaCl from water against 6M Gd, and reverse.

FIG. 36. Net energies Uₙₑₜ for gelatin versus [NaCl] and [Gd]. Both start negative but quickly become positive, leading to dissociation of chains. Uₙₑₜ remains positive for Gd and so the chains continue to dissociate and never re-associate. In contrast Uₙₑₜ for NaCl drops back to negative as [NaCl] increases, leading to a re-association of gelatin chains. The constituent potentials are shown with dashed lines.

FIG. 37A. Alginate under forward dialysis from water against 4M NaCl, stopping at 2.5M NaCl, and reverse.

FIG. 37B. Alginate under forward dialysis from water against 6M Gd, stopping at 3.8M Gd, and reverse.

FIG. 38. <Uₙₑₜ> for alginate in Gd and in NaCl. At very low IS both Gd and NaCl have negative potentials, leading to interchain associations. Gd, because it suppresses HP effects quickly leads to a positive <Uₙₑₜ> and dissociation of alginate chains. In contrast, Uₙₑₜ for NaCl remains negative throughout, causing further irreversible aggregation, as seen in FIG. 37A.

FIG. 39A. Dialysis of BSA against Gd, showing thresholds for onset of abrupt colloidal aggregation. The process is irreversible in both cases. The inset shows the energy model, where the postulated attractive polyampholyte potential turns on abruptly at the aggregation threshold.

FIG. 39B. Fluorescence data using the dialysis device shows the same type of abrupt aggregation threshold as detected by SLS and DLS.

FIG. 40. Aggregation of lysozyme above 0.5M NaCl at fixed [IS] (i.e. non-dialysis). Non-aggregation regime starts somewhere below 0.75M NaCl, continuing to 0 NaCl. Non-aggregation was found over 0-4M Gd.

FIG. 41. d_{H,ap} and Q for IgG undergoing forward dialysis against 6M Gd, and reverse dialysis against water.

FIG. 42. Q vs d_{H,ap} in forward dialysis of IgG versus 6M Gd, and reverse against water. Remarkably, Q increases as d_{H,ap} decreases, suggesting the inhomogeneous fragmentation of the oligomer formed at the maximum of d_{H,ap} in FIG. 41.

FIG. 43. Contrast between NaCl and Gd dialysis for proteinase k.

FIG. 44. Contrast in dialysis behavior against NaCl and Gd for casein.

FIG. 45. Schematic illustration of an example system described herein.

FIG. 46. Schematic illustration of an example device described herein.

FIG. 47. Schematic illustration of an example device described herein.

FIG. 48. Schematic illustration of an example device described herein.

FIG. 49. Schematic illustration of an example device described herein.

FIG. 50. Schematic illustration of an example device described herein.

FIG. 51. Schematic illustration of an example device described herein.

FIG. 52. Schematic illustration of an example device described herein.

FIG. 53. Example device with an access port, here shown as a needle port.

### DETAILED DESCRIPTION

### Definitions

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

The term “receptacle,” as used herein, refers to a fluid containment vessel in which a first fluid and a second fluid co-exist, separated by a membrane. The receptacle containing the first and second fluids separated by a membrane can be dimensioned so as to be reversibly insertable with a principal monitoring instrument. In some embodiments, the receptacle can be a square cuvette made of glass, quartz, or a transparent polymer. In other embodiments, its shape can be circular, polygonal, elliptical, or irregular.

The term “fluid,” as used herein, refers to a liquid, which may be pure, or have dissolved or suspended components. For example, a fluid may be a pure solvent such as, but not limiting, water, dimethylsulfoxide (DMSO), toluene, tetrahydrofuran, acetone, methanol, ethanol, carbon disulfide, and many other pure solvents. The pure fluid may be a mixture of two or more solvents. The pure fluid may have dissolved components such as, but not limiting, ions, small neutral molecules, surfactants, dyes, fluorescence markers, chelation agents, buffers, oligomers, and polymers of biological or synthetic origin. Suspended materials in the fluid include, for example, whole cells, clusters of cells, organelles from cells, micelles, liposomes, vesicles, nanoemulsions, microemulsions, emulsions, surfactant stabilized structures, quantum dots, metal sols, and combinations thereof.

The terms “device” and “current device,” as used herein, refer to the receptacle and the apparatus used to separate, using a membrane, the first and second fluids within the receptacle. The device can further include other components that provide for circulation or recirculation of the first and/or second fluids, such as a pump and external reservoir(s). The device may include the principal monitoring instrument into which the current device is placed, and any external monitoring instrument(s) used to monitor circulating or recirculating first and/or second fluid.

The term “membrane’ refers to any type of membrane, whether open or closed, through which matter can pass, including, but not limited to, fluids, small molecules, ions, gases, polymers, colloids, and specific types of fluids, such as various polar and non-polar fluids. Examples, not limiting, include membranes made of polyvinylidene difluoride (PVDF), polyimide, polyamides (e.g., nylons and aramids), carboxymethylcellulose, hybrid membranes such as hyaluronic acid/carboxymethylcellulose, polyethersulphone, cellulose acetate, cellulose nitrate, sintered metals, gels, polycarbonate, polysulfone polytetrafluoroethylene (PTFE, sometimes called by one of its commercial names ‘Teflon’). Examples of membranes used in medical dialysis include Theranova 400, Theralite 2100, Revaclear 400, Polyflux 17L. The Membrane may also comprise a biological tissue, such as, but not limited to, skin, muscle, fat, neurons, and bone.

It will be understood that a membrane need not be a flat 2D membrane. The term “membrane” can also encompass 3D membranes, such as hollow filter ultrafiltration membranes, membranes used in lithium-ion batteries, and in hydrogen production. Makers of example membranes include Membrane System Specialists, Inc., Pall Corporation, MilliporeSigma, Dow Chemical Company, Sigma-Aldrich, Lab Filtration Papers, Koch Membrane Systems, SPX Flow, Alfa Laval, Merck Group, Siemens Corporation, GEA Goup Aktiengesellschaft, Toray Industries, International Polymer Solutions, J. G. Rinneran, and others.

The term “open membrane,” as used herein, refers to a single lamina or single surface of membrane used to separate the first and second fluids.

The term “closed membrane,” as used herein, refers to a membrane existing in 3 dimensions, which can be filled by a fluid, such as in cylindrical form, not limiting, which may also allow flow of liquid into and out of said membrane. In the case where the membrane is initially open on both ends, e.g., a length of dialysis tubing, the membrane can be formed into a closed membrane by sealing one end. In such circumstances, sealing may be accomplished using an adhesive, such as, but not limited to, Gorilla Super Glue Gel XL, and/or a mechanical fastener, such as a clip. Alternatively, the membrane with both ends initially open can have both open ends sealed to the cap assembly post with o-rings or other fasteners, such that no glue or other substance is needed for sealing the initially both open ends of the membrane. Alternatively, the membrane may be manufactured to have one sealed end. The portion of the cap assembly that holds the membrane can also have grooves and a solid base, such that an open membrane can be sealed around said portion without need of sealing one end of the open membrane.

The term “monitoring instrument,” as used herein, refers to a device that can perform continuous or rapid periodic measurements of a liquid sample. Examples of monitoring instruments include both optical instruments, such as, but not limited to, static and dynamic light scattering instruments, turbidity probes, UV/visible spectrometers, fluorimeters, polarimeters, refractometers, circular dichroism or circular birefringence instruments, as well as non-optical instruments, such as conductimeters, pH meters, viscometers, dielectric spectrometers, dissolved gas sensors, ion-specific probes, and other molecular specific probes. Other suitable monitoring instruments include chromatographic separation systems that allow periodic injection of small aliquots of the first fluid and/or second fluid (e.g., present in a fluid circulation path) for chromatographic analysis. In these embodiments, the circulation path can contain a manual or automatic injection valve, which can periodically inject a small portion of fluid circulating within a fluid circulation path into a chromatographic separation system for analysis.

The term “optical instrument,” as used herein, refers to an instrument which has a source of electromagnetic radiation, whose radiation can be directed to impinge on a fluid sample for purposes of analyzing one or more characteristics of the fluid sample. Examples include, but are not limited to static light scattering (SLS) instruments (also termed ‘total intensity light scattering instruments), dynamic light scattering (DLS) instruments, electrophoretic light scattering instruments, Mie scattering instruments, turbidity measuring instruments, laser diffraction scattering instruments, ultraviolet absorption instruments, visible light absorption instruments, infra-red absorption instruments, microwave absorption instruments, spectrofluorimeters, polarimeters, circular dichroism instruments, and circular birefringence instruments.

The term “principal monitoring instrument,” as used herein, refers to a monitoring instrument positioned and configured to receive a receptable and interrogate a fluid sample present within the receptacle. In the case of an optical instrument, the principal monitoring instrument can include an optical measuring path, and the receptacle can be placed within the optical measuring path, such that electromagnetic radiation from the optical instrument can impinge on a fluid sample present within the receptacle. This can allow the optical instrument to analyze one or more characteristics of the fluid sample within the receptacle. The principal monitoring instrument can also be a non-optical instrument, such as a head space gas chromatograph for monitoring the emission of gas from a fluid in the receptacle.

The term “external monitoring instrument,” as used herein, refers to any monitoring instrument that is physically separated from the receptacle such that it does not house or enclose the receptacle. In some embodiments, the external monitoring instrument can be configured to interrogate a circulating fluid present within a flow path. For example, one or more external monitoring instruments can be fluidly connected to circulation tubing forming a circulation path through which the first fluid and/or the second fluid is circulated. Examples of such instruments include, but are not limited to, flow-cell equipped light scattering, UV/visible absorbance, fluorescence, turbidity, polarimeter, and circular dichroism and birefringence instruments. In other examples, the external monitoring instrument (or a portion thereof) can be submerged in a reservoir forming part of the circulation of the first fluid and/or second fluid. Examples of such instruments include pH, conductivity, specific ion sensitive, and dissolved gas probes. An external monitoring instrument can also interrogate a fluid present within a receptable located within the principal monitoring instrument, provided its active measuring component does not make direct measurements on the receptacle and its contents.

The phrase “flow-cell equipped instrument,” as used herein, refers to any instrument equipped with a flow-cell that can make measurements on the fluid passing through the flow-cell. Examples of flow-cell equipped instruments include, but are not limited to, refractometers, differential refractometers, UV/visible spectrophotometers, static light scattering instruments, dynamic light scattering instruments, fluorescence detectors, turbidity, pH, and conductivity detectors, polarimeters, NMR, Infra-red detectors, near infra-red detectors, and circular dichroism and birefringence detectors.

The phrase “instrument components,” as used herein, refers to any and all components used in any embodiment of the Device. These include, but are not limited to, Principal and External Monitoring Instruments, tubing used in circulation flow paths, pumps or other means of causing circulation through circulation flow paths, reservoirs in the circulating flow paths, any computer used for data gathering, analysis, and interpretation from the Device.

The phrase “first fluid,” as used herein, refers to the fluid sample in the receptacle which is characterized via the principal monitoring instrument, for example, by passing electromagnetic radiation from the principal monitoring instrument through the fluid sample or by measurements made directly on the receptacle contents, such as the evolution of gas in a chemical or biological process.

The phrase “second fluid,” as used herein, refers to the fluid sample in the receptacle which is not measured by the principal monitoring instrument in which the receptacle is located, whether this fluid be contained inside a closed membrane, or separated from the first fluid by a sealed membrane sheet.

The phrase “membrane-mediated process,” as used herein, refers to the flow or exchange of material between the first fluid and second fluid, across the membrane that separates them, including, but not limited to the fluids themselves, small molecules, ions, oligomers, polymers and colloids. Membrane-mediated processes may also be referred to as membrane exchange processes.

The phrase “heterogeneous time-dependent static light scattering (HTDSLS),” as used herein, refers to the instrumentation and methods whereby diffusive or convective motion of colloids in solution is used to produce countable light scattering spikes which can be counted and characterized to determine number density of the colloids. In certain cases, information on the colloidal size distribution can also be obtained. Such instrumentation and methods are described in R. Schimanowski, R. Strelitzki, D. A. Mullin, W. F. Reed “Heterogeneous Time Dependent Static Light Scattering”, Macromolecules, 1999, 32:7055-7063.

The phrase “continuous monitoring,” as used herein, refers to measurements made at time intervals sufficiently short that no time-dependent information is lost between successive measurements. Such monitoring measurements can also be termed “substantially continuous.” Typically, continuous measurements imply that at least twenty, but preferably more, measurements are made during the complete time-course of the process.

The phrase “discrete monitoring,” as used herein, refers to measurements made at intervals not considered continuous, such as measurements whose time between measurements is limited by the instrument. Examples of discrete monitoring include, but are not limited to, measurements made using chromatographic systems such as gel permeation chromatography, size exclusion chromatography, interaction chromatography, two-dimensional chromatography, high pressure liquid chromatography, and field flow fractionation.

The terms “macromolecule” and “polymer” are used interchangeably and also include small polymers and oligomers. These terms refer to any polymer or oligomer of synthetic or biological origin, including proteins, polysaccharides, RNA, DNA and related polynucleic acids, combinations of these, monoclonal antibodies and other protein and biologic drugs.

The term “colloid,” as used herein, refers to any entity, on the nanometer, micrometer, or millimeter scale which is suspended in a fluid but not dissolved in the chemical sense. Examples include biological cells, clusters of cells, cell organelles, virus particles, lipid nanoparticles, viral capsids, metal, semi-conductor, and dielectric particles, micelles, liposomes, vesicles, and other self-organizing structures.

The phrase “biological cells,” as used herein, refers to, but not limited to, bacteria, yeast and other fungi, blood cells, neurons, and other specialized cells, and other microbes, such as, but not limited to any species of archaea, protozoa, algae, and lichens.

The phrase “electromagnetic radiation,” as used herein, includes any wavelength or frequency of the electromagnetic radiation spectrum, including, but not limited to, ultra-violet and visible light, and infrared, x-ray, and microwave radiation.

The phrase “acceptably complete”, as used herein, refers to a process that is carried out so that some specification of an acceptable final state is reached. Examples include, but are not limited to, a minimum or maximum final concentration of one or more components in the first fluid and/or the second fluid, such as the concentration of ions, small molecules, and polymers.

The term “circulation,” as used herein, can refer both to open loop and closed-loop circulation of the first fluid and/or second fluid. For example, a circulating second fluid may be diverted to a measuring instrument or waste container, without being re-circulated into the receptacle.

The term “recirculation,” as used herein, refers to a closed-loop circulation of the first fluid or second fluid with any type of pumping device, such as, but not limited to, a peristaltic pump, piston pump, slot pump, diaphragm pump, gear pump, reciprocating syringe pump. The closed circulation loop may contain a reservoir of fluid content the same as the first fluid or second fluid itself. The circulating fluid may pass through a measuring device, such as, but not limited to, an optical instrument, a conductivity meter, a pH meter, or a dissolved gas probe.

The phrase “first fluid circulation path” is used to refer to a circulation path through which the first fluid is circulated. The phrase “second fluid circulation path” is used to refer to a circulation path through which the second fluid is circulated.

The phrases “first fluid inlet” and “first fluid outlet” are used to refer to a fluid inlet and a fluid outlet, respectively, that fluidly connect the first fluid to the first fluid circulation path.

The phrases “second fluid inlet” and “second fluid outlet” are used to refer to a fluid inlet and a fluid outlet, respectively, that fluidly connect the second fluid to the second fluid circulation path.

The phrase “control of a membrane-mediated process,” as used herein, refers to any action taken by a human, machine, or automaton that interrupts or changes the conditions of the membrane exchange process. Examples include, but are not limited to; stopping the membrane exchange process when it is acceptably complete, changing the rate of circulation or recirculation of the first fluid and/or second fluid, and changing the nature or composition of the first fluid and/or second fluid.

The term “reversibility,” as used herein, refers to a process in which a polymer or colloid, having an initial state under initial solution conditions, changes its characteristics due to a change in solution conditions (for example, but not limiting, ionic strength, pH, electrolytes, temperature, mechanical agitation, presence of denaturant, chelating agent), and then reverses to its initial state when the solution conditions are brought back to the initial solution conditions. For example, ionic strength, pH, electrolytes, denaturants and chelating agents can be removed using dialysis, wherein the state of the polymer or colloid is monitored.

The phrase “means of circulation or recirculation,” as used herein, refers to any device, such as a pump, such can direct fluid along a fluid flow path. Examples include, but are not limited to peristaltic pumps, piston pumps, slot pumps, syringe pumps, reciprocating syringe pumps, gear pumps, diaphragm pumps, and pressurized lines.

The phrase “small molecule,” as used herein, refers to molecules having a molecular weight of less than 1000 Da (e.g., less than 800 Da, or less than 500 Da), including gases, dyes, fluorophores, surfactants, oligomers, emulsifiers, chelating agents, buffer components, biocides, toxins, and simple electrolytes, which can include salts, and their respective ions, such as, but not limited to, NaCl, KBr, MgCl₂, CaSO₄, and borax, as well as acids and bases, such as HCl, NaOH, H₂O₄, and organic acids, but not limited to, formic, acetic, butyric, ascorbic, and oxalic acids. Other soluble small molecules include, but are not limited to, chaotropic agents which can interrupt non-covalent bonds, such as hydrogen bonds, leading to, for example, unfolding or denaturation of polynucleic acids (e.g., RNA and DNA) and proteins. Chaotropic agents include, but are not limited to, urea, guanidine hydrochloride, and norbornene salts. Other small, soluble molecules include anti-chaotropic agents (also termed ‘kosmotropic’), which contribute to the stability of structure stabilized by hydrogen bonds and other non-covalent bonds and effects. Small Molecules also include small molecule active agents (drugs), such as, but not limited to salicylic acid, losartan, naproxen, fexofenadine, carvedilol, trazondone, lamictal, and valproic acid.

The phrase ‘biologic drug’ includes any therapeutic agent, whether in discovery, formulation, or commercial production, derived from natural biological sources or synthesized to resemble or be equivalent to biological products. Biologic drugs include, but are not limited to, proteins of any sort, including monoclonal antibodies, polyclonal antibodies, polysaccharides, protein-polysaccharide complexes, oligopeptides, vaccines, lipid nanoparticles, viral capsids, nucleic acids, oligonucleotides, and polynucleic acids such as RNA and DNA. Biologic drugs are also termed ‘Biologic medicine products’. Also included are agents, not necessarily biological, which are used to enhance, functionalize, encapsulate, or deliver a biological agent, such as, but not limited to, encapsulation/delivery synthetic polymers, dendrimers, liposomes, vesicles, and micelles.

The phrase “osmotic virial coefficient,” as used herein, refers to coefficients used to express non-ideality in solutions that contain two or more components. For example, a solvent, such as water might contain a polymer at a certain concentration, and one or more virial coefficients can be used to express light scattering, osmotic pressure, chemical potential, or other quantities to characterize the non-ideality. One set of virial coefficients for this, not limiting, are those expressed in mass terms, such as the second virial coefficient A₂ (cm³-mole/g²), third virial coefficient A₃ (cm⁶-mole/g³), etc. Other, related definitions and terminology are also found, such as B₂ (cm³) instead of A₂, B₃ instead of A₃, and other forms.

The phrase “supramolecular assembly,” as used herein, refers to a structure composed of molecules, polymers, and/or colloids that are held together by non-covalent forces and effects. These include, but are not limited to micelles, block copolymer assemblies, liquid crystals, natural and artificial membranes, and emulsions, including nano- and microemulsions. The assembly may be driven by electrostatics, hydrogen bonding, dipolar forces, hydrophobic effects, depletion effects, entropic effects, and osmotic pressure.

The phrase ‘cap assembly’ refers to a cap which can fit onto the receptacle in which the first fluid and second fluid are separated by a membrane. The cap assembly may be a simple cap that fits onto the receptacle. Alternatively, the cap assembly may include additional components to facilitate containment and/or manipulation of the first fluid and/or the second fluid, positioning of the membrane, or measurement/interrogation of the first fluid and/or the second fluid. For example, the cap assembly may be a cap with apertures to allow conductors attached to the electrodes, such as wires, to pass from the electrodes (whether integral with the cap assembly or present within a separate electrode assembly) and through the cap for external electrical connections. The cap assembly may include an integral electrode assembly that fits into the receptacle. The cap assembly may include a means of stirring the contents of the receptacle, whether the electrode assembly is integral with the rest of the cap assembly, or resides inside the receptacle independently of the cap assembly, or resides external to the receptacle. The cap assembly may contain a means of affixing a membrane that divides the solution within the receptacle into a first fluid and a second fluid. This latter aspect may contain and combine any of the previously mentioned features.

The phrase ‘convection’ refers to the movement of a liquid through space, as opposed to the liquid being stationary in space.

The phrase ‘convection means’ includes any means for driving convection in a cuvette. It includes, but is not limited to, rotational stirring, oscillatory stirring, reciprocal plunging, bubbling gas, and shaking.

The phrase ‘motor’ includes any type of electrical motor, such as an externally controlled stepper motor, simple d.c. and a.c. motors, and reciprocating motors. In the case of motors requiring external control, a control means is connected reversibly to the motor. Where the motor requires only a voltage or current source, this can be supplied by a battery integral to the device assembly, or provided by an external d.c. or a.c. source.

The phrase ‘drive shaft’ refers to a shaft of any shape or material that can be coupled to the motor and either has an integral stirrer, such as an impeller, or can be coupled to a stirrer, such as an impeller.

The phrase ‘impeller’ refers to a component of any shape that produces convection in a fluid present in the receptacle. It can be shaped to provide any desired fluid flow field. It may have one or more blades with no angle, or angled in such as way as to provide vertical convection.

The phrase ‘contact stir’ refers to any means of stirring the liquid in the receptacle such that the agent that causes the stirring motion is in contact with the receptacle itself. An example, not limiting, is where the agent that causes the stirring motion is a magnetically driven stir bar that resides and spins on the bottom inside surface of the receptacle.

The phrase ‘non-contact stir’ refers to a means of causing convection in the fluid in the receptacle where the agent that causes the convective motion makes no contact with any surface of the receptacle. An example, not limiting, is a shaft with an impeller connected to one of its ends and inserted into the fluid contained in the receptacle, without the impeller making contact with the walls of the receptacle, the impeller being driven by a motor to provide the convective motion, or, in the case of a suspended magnetic stir bar impeller making no contact with the receptacle, the magnetic stir bar impeller can be driven by a rotating magnet external to the receptacle.

The phrase ‘stir’ can mean the reciprocal motion of an impeller within the fluid contained in the cuvette, in addition to a rotational stir motion.

### Systems and Methods

Described herein are devices, systems and methods that relate to the real-time monitoring of time-dependent membrane-mediated processes between two different fluids in a receptacle separated by a membrane. The membrane can be any suitable membrane permeable that is permeable to one or both fluids and/or to molecular, polymeric, or colloidal components in one or both fluids. The receptacle containing these fluids can be operatively positioned within a principal monitoring instrument, such that the principal monitoring instrument can interrogate the first fluid (e.g., to measure changes in the first fluid due to a membrane-mediated process, including the effects on polymers and colloids in one or both of the fluids due to a membrane-mediated process).

Analysis of the first fluid can reveal the rate and time-dependent mathematical signature of the membrane mediated process. The changing properties measured can also be represented vs the concentration of different solutes instead of time.

By way of example, in some embodiments, the first fluid and the second fluid are stationary, and the membrane-mediated process is governed by diffusion. Next, without further change to the receptacle, the first fluid can be stirred magnetically with a stir bar. In some embodiments, the receptacle can be equipped with a stir bar suspended from a cap assembly of the receptacle, wherein the stir bar does not make contact with the bottome of the receptacle. The stir bar can be driven either by any suitable means, such as a magnetic drive integrated into the principal monitoring instrument, or by a motor. It is well known that contact stirring—e.g. by a stir bar contacting the base of a receptacle—can cause considerable damage to certain polymers, such as proteins. Alternatively, the first fluid can be stirred using an integral non-contact convection device. If desired, in addition to the principal monitoring instrument interrogating the first fluid in the receptacle, additional sensors may optionally be configured to interrogate the first fluid and/or the second fluid in the receptacle. For example, in some embodiments, the additional sensors may be inserted into the first fluid and/or the second fluid in the receptacle. Examples of suitable additional sensors include, but are not limited to, conductivity probes, pH probes, specific ion probes, thermocouples, and dissolved gas sensors.

One or both of the fluids can be circulated or re-circulated. If one or both of the fluids is circulated or re-circulated, the fluid flow can contact one or more external monitoring instruments, which are external to the receptacle and the detection path of the principal monitoring instrument in which the receptacle is placed. External monitoring instruments can be configured in series and/or parallel along the circulating flow path.

External monitoring instruments can be interfaced with the first fluid and/or the second fluid in multiple ways. In some embodiments, a reservoir can be placed in the flow path of the circulating fluid, such that the reservoir remains at a desired level due to the recirculation. Homogenization of the fluid can be achieved by stirring or agitating the fluid in the reservoir, and/or configuring the inlet and outlet geometry to enhance mixing. An external monitoring instrument can then be configured to analyze the fluid present in the reservoir. For example, in some embodiments, the external monitoring instrument can comprise a probe that is inserted into the fluid in the reservoir. Examples of suitable external monitoring instruments include, but are not limited to, conductivity probes, pH probes, ion-specific probes, substance-specific probes, submersible near infra-red or infra-red probes, and submersible turbidity probes.

In some embodiments, the external monitoring instrument can comprise a flow-cell equipped instrument. In these embodiments, the circulation path can fluidly connect to the flow-cell equipped instrument, allowing the flow-cell equipped instrument to interrogate fluid flowing through the circulation path. In such embodiments, the circulation path may also contain a reservoir; however, a reservoir is not necessarily required. Many such flow-cell equipped instruments are available, such as, but not limited to, instruments to measure refractive index, differential refractive index, absorption of electromagnetic radiation, changes in chirality, changes in conformational state, coalescence, aggregation, degradation and viscosity. The viscosity measurements can also be made by flow through a capillary tube whose ends are connected, via a fluidic ‘T’, to a differential pressure transducer.

A reservoir in an external circulation path can have an important function, beyond accepting a measuring instrument. Namely, the volume of the external reservoir can be adjusted to give a desired volume ratio between the first and second fluids. The desired volume ratio can be achieved in the case where only one fluid is circulated, and in the case where both the first and second fluids are circulated. As an example, not limiting, the first fluid in the receptacle might contain 2 ml of a polymer in water with no added electrolyte. If the external reservoir for the second fluid, including the circulation tubing and amount of second fluid in the receptacle is 200 ml with 4M NaCl in water, and is dialyzed agains the first fluid, then the final electrolyte concentration in the first fluid, after dialysis equilibrium is reached, will be 3.96M.

Data from the principal monitoring instrument, any additional sensors interrogating the first fluid and/or the second fluid in the receptacle, and any external monitoring instruments interrogating the first fluid and/or the second fluid within external circulation paths can be used to quantify the changes in the fluids' characteristics, including changes in the components within the fluids. These changes can be represented both versus time and versus the concentration of an exchanged substance. This data can then be analyzed to gain information about an analyte of interest present in the first fluid, an analyte of interest present in the second fluid, or a combination thereof. Some examples include, but are not limited to, interpretation of conductivity in terms of an electrolyte concentration; using refractive index and/or UV absorbance measurements to obtain polymer of colloid concentration, combined with total intensity light scattering to compute a polymer or colloid weight average molecular weight M_{w}, z-average mean square radius of gyration, <S²>_{z}, and second virial coefficient; the same concentration can be combined with the viscometer measurement to yield reduced viscosity, including the possibility of making the viscosity measurements at different shear rates to detect non-Newtonian fluid behavior.

The ability to monitor the condition and growth of biological cells is also important. Conditions of biological cells can include, not limiting, size, due to shrinking, swelling, aggregating, disaggregating, collapsing or bursting, and amount of a specific radiation absorbed (e.g visible, UV). Such monitoring can determine the robustness and health of cells as environmental conditions changes, such as, but not limited to, the tonicity and pH, presence or absence of nutrients, toxins, drugs, growth factors, and hormones. The growth of biological cell populations, such as, but not limited to, bacteria and fungi, can be monitored in response to the same types of factors mentioned above, with the goal of assessing the effect of an agent on the reproduction of the biological cells; some agents may enhance growth, have no effect, retard growth, or lead to death of the entire population. While the many instruments mentioned throughout can potentially be used, especially turbidity, SLS, DLS, and HTDSLS, monitoring of metabolically generated gas can be an indicator of the growth or decline of a population of propagating biological cells. This can be accomplished by measurements of dissolved gases, such as, but not limited to, oxygen, carbon dioxide, methane, and sulfur-based gases.

The length of time the membrane mediated process takes can be decreased by increasing the membrane surface area and/or by stirring the first fluid. Some instruments (e.g., ARGEN from Fluence Analytics) contain magnetic stirring capabilities for the sample cells. The magnetic stir bar can be in contact with the bottom of the cuvette, or, when contact-stirring can damage polymers (e.g., proteins) or colloids, non-contact stirring can be provided by a stir bar suspended from a specialized cuvette cap. This latter can run off of either the magnetic stir capability of the instrument or via a motor. The non-contact stirring can also be provided by a stir bar driven by a motor integral to the cap assembly. Where time-dependent effects may be important (e.g., aggregation of proteins) it may be desirable to slow down the membrane-mediated process. This can be done by decreasing the membrane surface area, increasing the membrane thickness, and decreasing or eliminating stirring. Increasing and decreasing the rate of the membrane-mediated process can also be affected by the rate of circulation of the second fluid and/or first fluid.

In some embodiments, the cap assembly can further include an access port. The access port can comprise an optionally sealable aperture in the cap assembly that allows a user to add liquids, solids, or gases to the receptacle and/or to withdraw liquid from the receptacle. Examples of adding solids include, but are not limited to, powders or crystals such as salts, sugars, or any other agent in dry form. Examples of addition of liquids include, but are not limited to, diluting the contents of the cuvette with a liquid of the same type already in the cuvette, changing the ionic strength by adding an electrolyte solution, changing the pH by adding an acidic or basic solution, adding a liquid different from the one already in the cuvette. Examples of adding gas include, but are not limited to, bubbling in inert gases, such as Argon or Nitrogen, to make possible certain reactions, such as free radical polymerization, bubbling in an active gas, such as oxygen, to quell a chemical reaction or promote a chemical reaction. Examples of withdrawal of liquid in the cuvette include, but are not limited to, withdrawing liquid aliquots for analysis by some other means, such as another spectroscopic method, a chromatographic method, a thermodynamic method, pyrolysis, atomic absorption, viscometry, or other types of analysis. Withdrawal of aliquots can also be used to subsequently add more liquid to the cuvette to dilute the contents. In some embodiments, the access port can comprise and open or sealed needle access port.

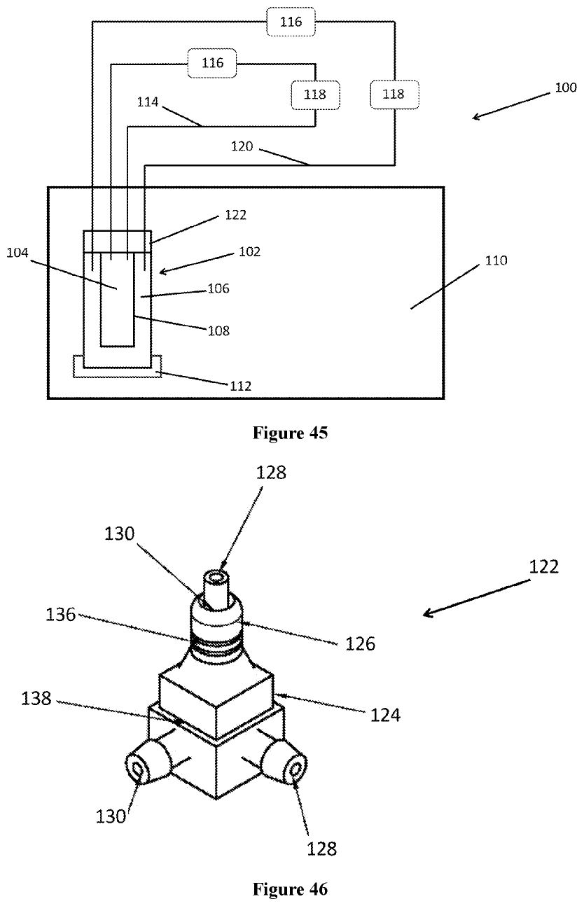

By way of example, referring now to FIG. 45, described herein are systems (100) including: a receptacle (102) housing a first fluid (106) and a second fluid (104), wherein the first fluid and the second fluid are separated by a membrane (108); and a principal monitoring instrument (110) configured to repeatedly interrogate the second fluid, the first fluid, or a combination thereof; wherein the receptacle is reversibly insertable within the principal monitoring instrument. In some embodiments, the receptacle (102) can be reversibly insertable within a sample holder (112) disposed within the principal monitoring instrument. In some aspects, the receptacle (102) can include a cap assembly (122), examples of which are described in more detail below.

Optionally, the system can include a second fluid circulation path (114) through which the second fluid is circulated, a first fluid circulation path (120) through which the first fluid is circulated, or a combination thereof. For example, the system can include a second fluid circulation path through which the second fluid is circulated, but not a first fluid circulation path through which the first fluid is circulated. Alternatively, the system can include a first fluid circulation path through which the first fluid is circulated, but not a second fluid circulation path through which the second fluid is circulated. Alternatively, the system can include a first fluid circulation path through which the first fluid is circulated and a second fluid circulation path through which the second fluid is circulated.

In some embodiments, the system can further include a second fluid circulation path (114) fluidly connected to the second fluid. Such a second fluid circulation path can be a closed-loop circulation path or an open-loop circulation path. In some embodiments, the second fluid circulation path can terminate in a waste container. In some embodiments, the second fluid circulation path can further include an external reservoir (116), at least one external monitoring instrument (118) configured to repeatedly interrogate the second fluid present in the second fluid circulation path, or a combination thereof. The at least one external monitoring instrument can include, for example, a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a chromatographic separation system allowing periodic injection of small aliquots of the second fluid present in the second fluid circulation path, or a combination thereof. In certain aspects, the second fluid circulation path passes through a flow-cell equipped instrument.

In some embodiments, the system can further include a first fluid circulation path (120) fluidly connected to the first fluid. Such a first fluid circulation path can be a closed-loop circulation path or an open-loop circulation path. In some embodiments, the first fluid circulation path can terminate in a waste container. In some embodiments, the first fluid circulation path can further include an external reservoir (116), at least one external monitoring instrument (118) configured to repeatedly interrogate the first fluid present in the first fluid circulation path, or a combination thereof. The at least one external monitoring instrument can include, for example, a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a chromatographic separation system allowing periodic injection of small aliquots of the first fluid present in the first fluid circulation path, or a combination thereof. In certain aspects, the first fluid circulation path passes through a flow-cell equipped instrument.

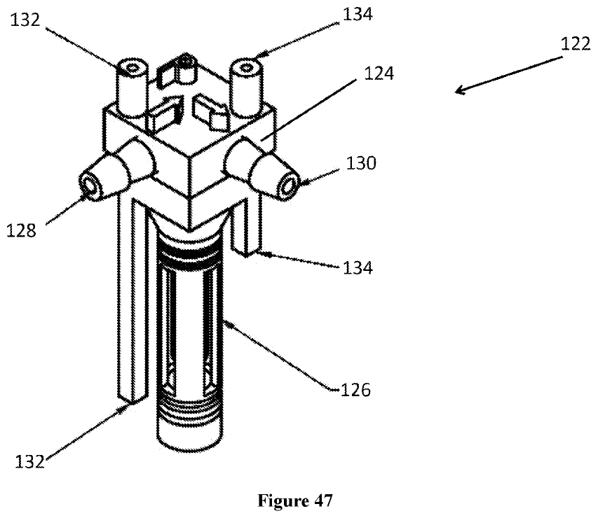

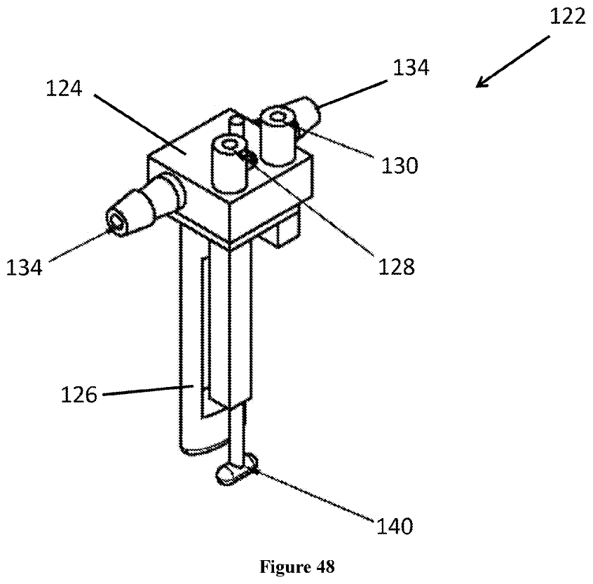

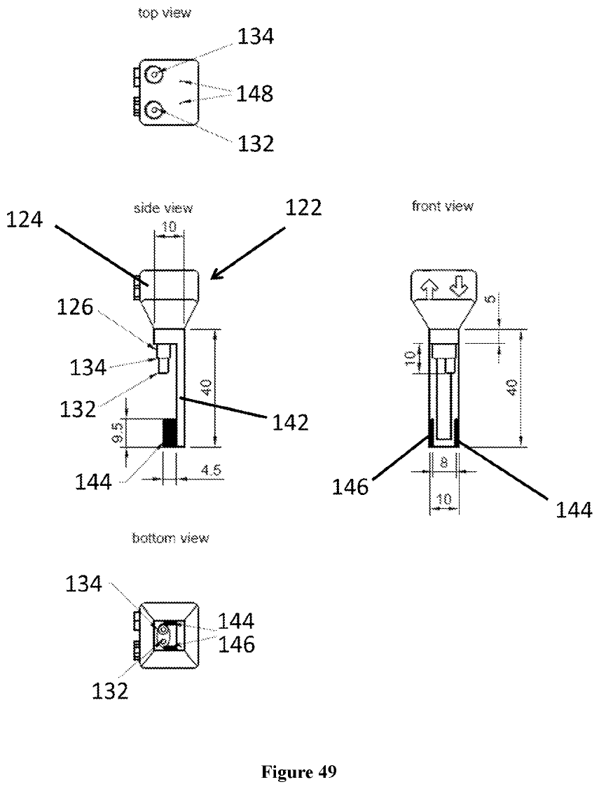

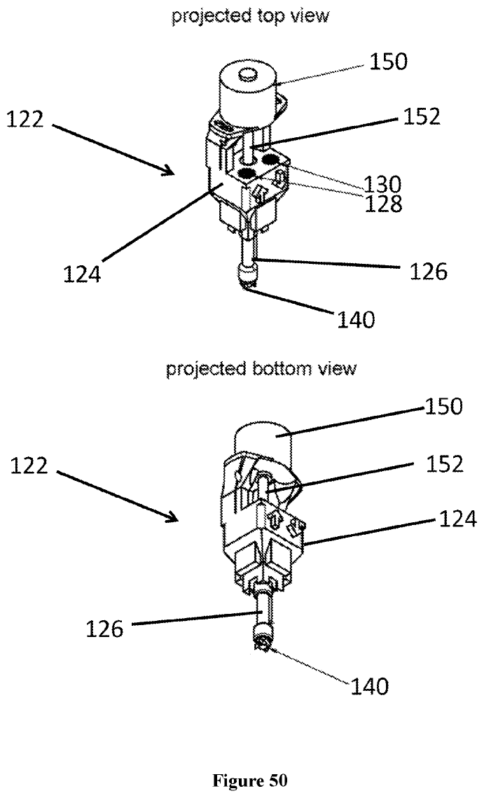

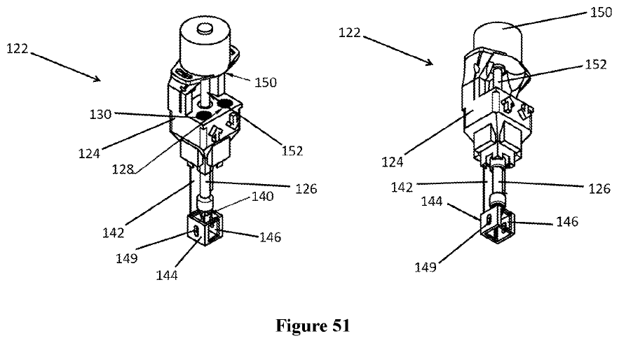

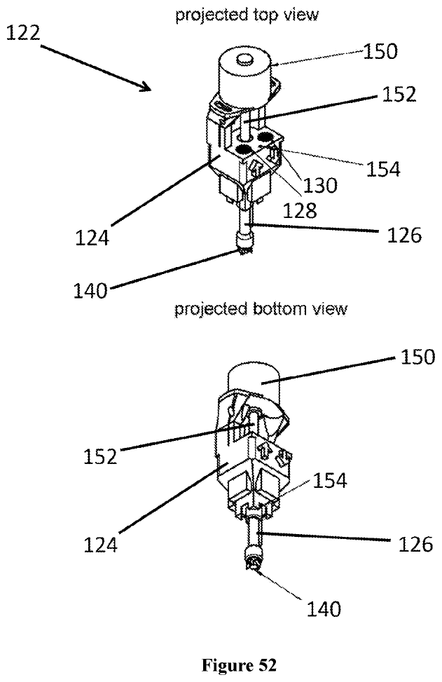

Referring now to FIGS. 46-52, also provided herein are devices, including receptacles (102) and cap assemblies (122), that can be used as components of the systems described herein. For example, provided herein are devices that comprise a cap assembly (102) dimensioned to be received within and seal a receptacle, wherein the cap assembly includes: a body portion (124) insertable within an opening of a receptable; and a mounting post (126) extending from a bottom of the body portion, wherein the mounting post is configured for attachment of a membrane.

In some embodiments, the cap assembly (122) further comprises a first fluid inlet (132) and a first fluid outlet (134) disposed on the body portion (124) and fluidly extending to the bottom of the body portion so as to fluidly connect to a first fluid present within the receptacle when the cap assembly is disposed within an opening of the receptable. In some embodiments, the cap assembly (122) further comprises a second fluid inlet (128) and a second fluid outlet (130) disposed on the body portion (124) and fluidly extending to the mounting post (126) so as to fluidly connect to a second fluid present within a membrane affixed to the mounting post

In some embodiments, the body portion (124) can comprise a shoulder (138) to facilitate placement and seating of the cap assembly within the receptacle.

In some embodiments, the mounting post (126) can include one or more grooves (136) to facilitate attachment of the membrane via a clamp.

In some embodiments, the cap assembly (122) can further include a stirrer (140) extending from the bottom of the body portion (124). In some embodiments, the cap assembly (122) can further include a motor (150) integrally attached to a drive shaft (152) that operates the stirrer (140). The stirrer can comprise, for example, an impeller.

In some embodiments, the cap assembly (122) can further comprise an electrode support (142) extending from a bottom of the body portion (124); and a first electrode (144) and a second electrode (146) disposed on the electrode support; wherein the first electrode and the second electrode are each electrically connected to a terminal (148) disposed on the body portion. If desired, the first electrode and/or the second electrode can further comprise an aperture (149) that provides a line of sight for interrogation of a fluid (e.g., for spectroscopic interrogation of a fluid) without interference from the electrode(s).

In some embodiments, the cap assembly (122) can further include an access port (154) that allows a user to add or withdraw components from a receptacle while the cap assembly remains in place.

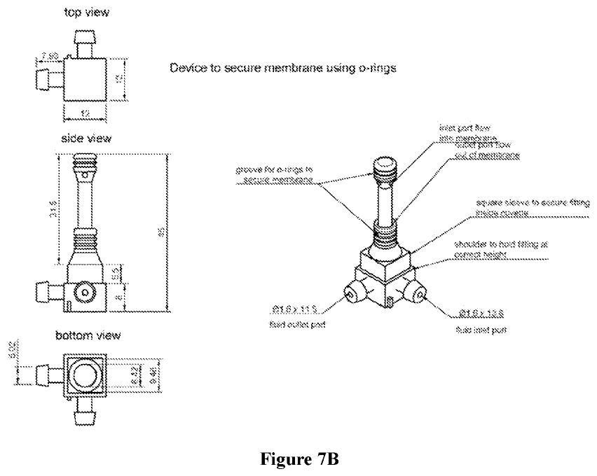

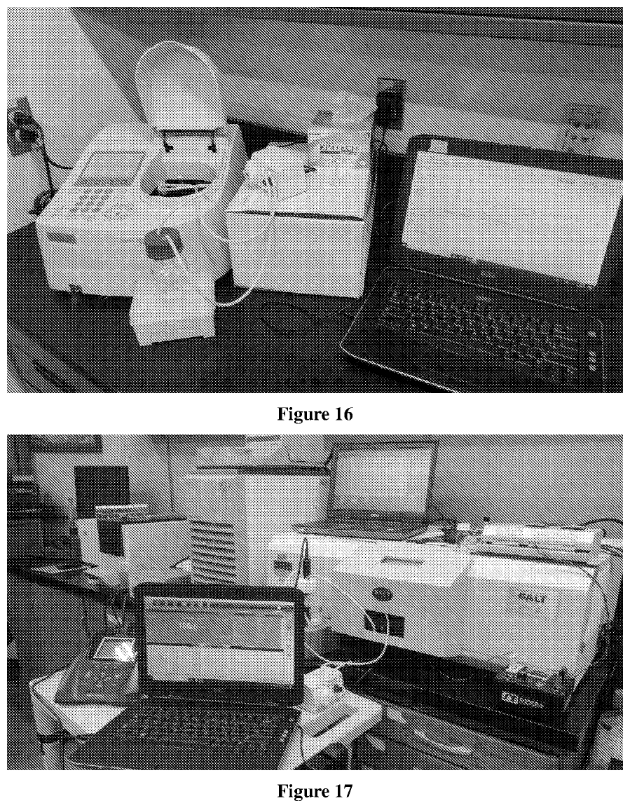

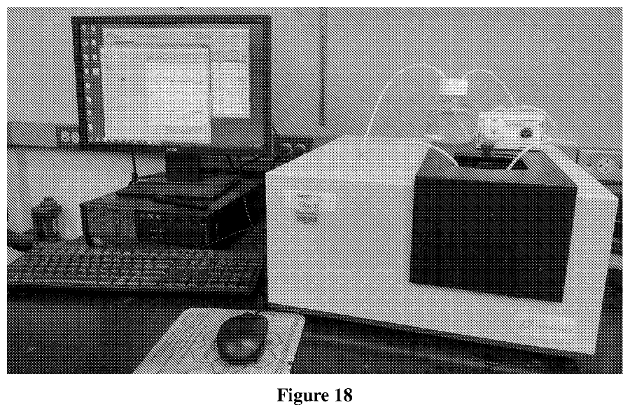

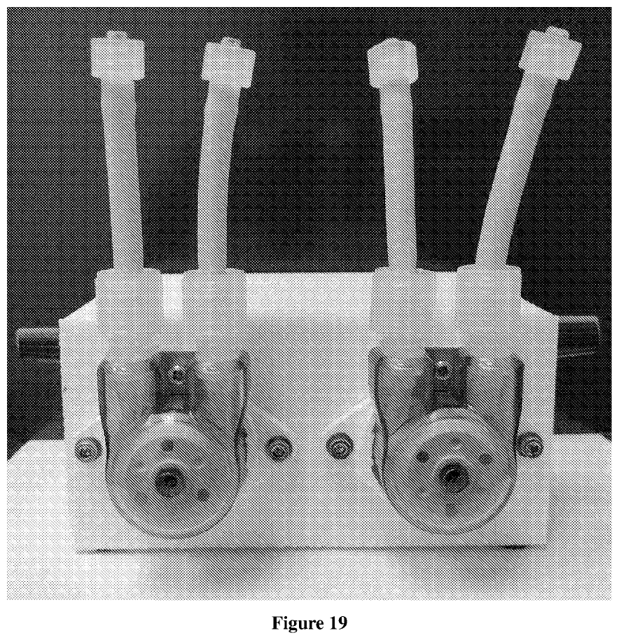

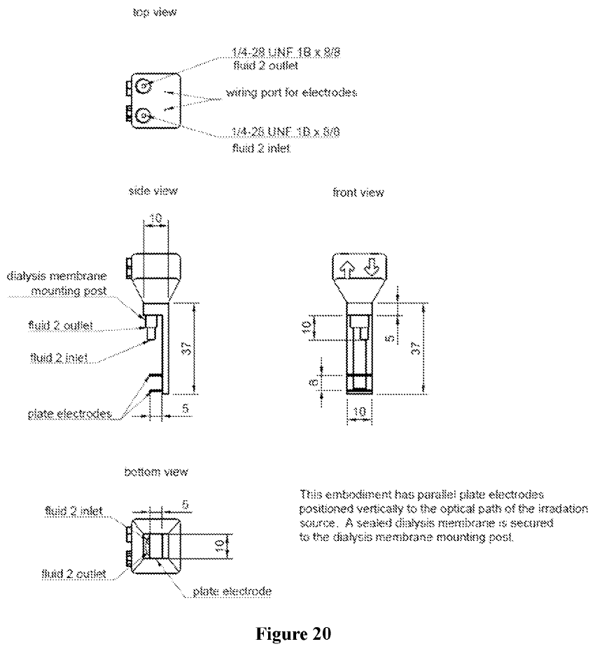

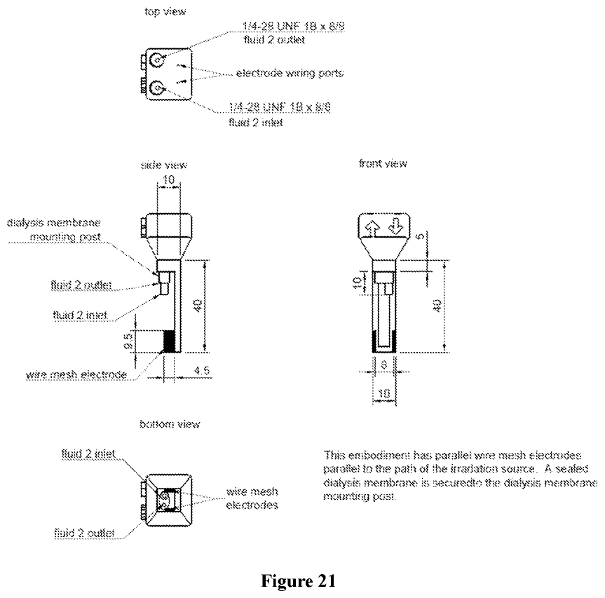

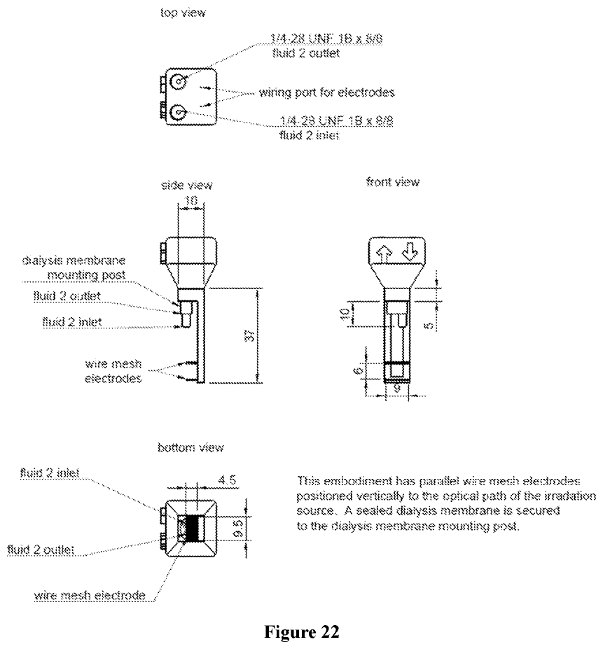

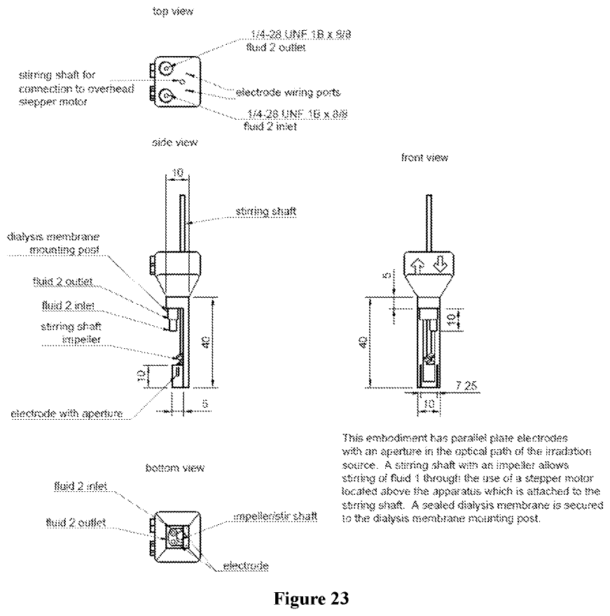

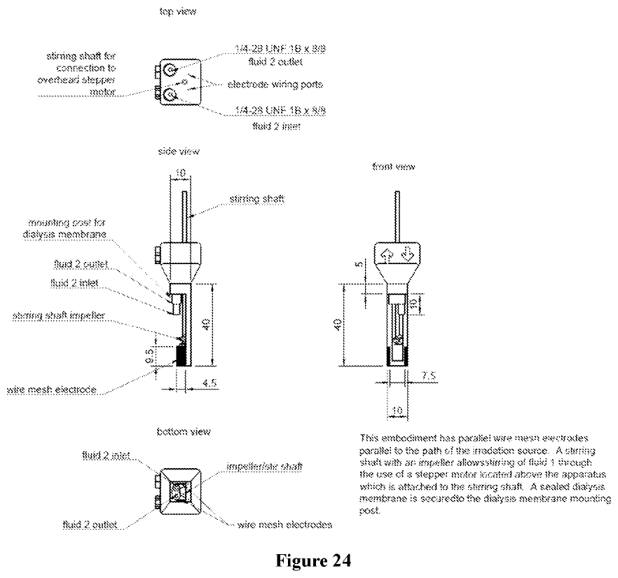

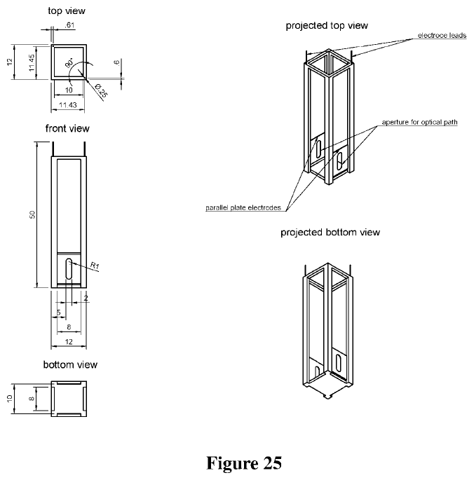

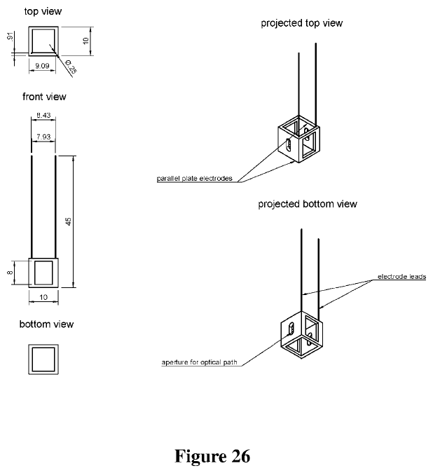

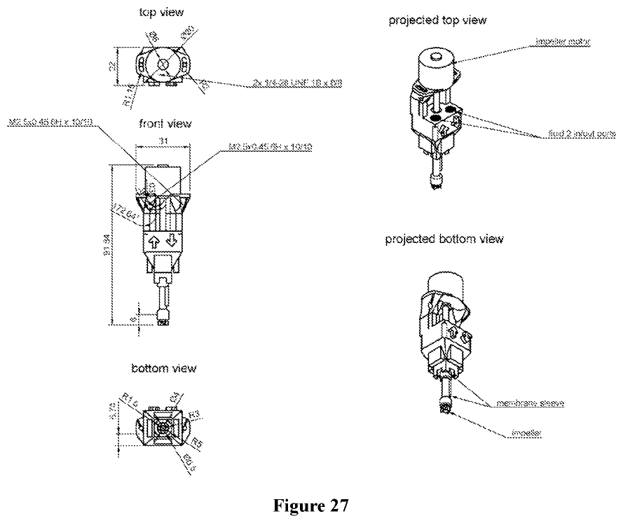

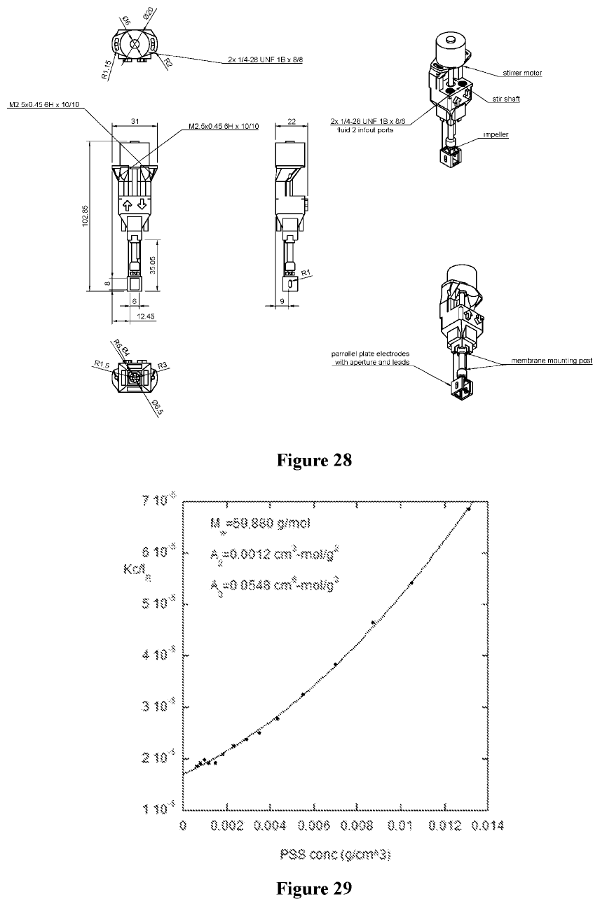

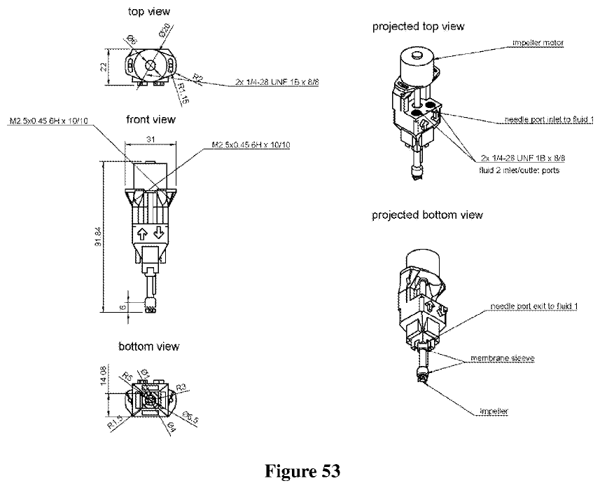

Further examples of the devices and systems described herein are illustrated, for example, in FIGS. 7A-7B and FIGS. 8-28 and 53.

The devices, systems, and methods described herein can offer a range of advantages over conventional systems and methods. First, if desired, the receptacle can be dimensioned for companibilty with a wide variety of commercial optical measuring instruments. This eliminates the need for any modifications to principal monitoring instruments when utilizing the devices, systems, and methods described herein.

Further, the devices, systems, and methods described herein can be used as molecular agents (e.g., electrolytes) are both added and taken away (e.g., to assess reverible processes). Many conventional devices, systems, and methods can only measure impacts during addition of molecular agents, with a second, separate process, such as dialysis, required to remove the molecular agent.

In some embodiments, the devices, systems, and methods described herein can be used to assess the reversibility and irreversibility of a transition observed in a polymer and/or colloid as they are subjected to a continuous increase and decrease in the concentration of a molecular agent (e.g., an electrolyte, denaturation agent, surfactant, etc.), or increase and decrease in the concentration of more than one agent. The devices, systems, and methods described herein can provide continuous measurements of a polymer and/or colloid as a molecular agent is added and/or removed, as opposed to discrete measurements on sample aliquots. This can allow for time derivatives, and other derivatives, of solution properties, to yield instantaneous values of these properties. Examples, not limiting, include instantaneous values of M_{w}, reduced viscosity, and the component composition of the fluids.

The real-time monitoring of polymers and/or colloids during dialysis can also reveal the conformational and association states of the polymers, and whether, and under what conditions they undergo reversible or irreversible denaturation. The specified devices and methods are embodied in small receptacles, which can be placed directly into a wide variety of commercially available analytical monitoring instruments. Additionally, the small receptacles placed in a measuring instrument can be equipped with circulation flow paths in which reservoirs of fluids and additional monitoring instruments can be placed. Flow can be provided by a wide variety of pumps; piston pumps, peristaltic pumps, gear pumps, slot pumps, diaphragm pumps, screw pumps, and other. The entirety of these components may be integrated into a single instrument. The instrument may also contain multiple external measuring instruments and be able to accept multiple receptacles, in which different membrane-mediated processes are occurring independently and simultaneously.

In some embodiments, the devices, systems, and methods described herein can be used to monitor and assess the reversibility of processes involving polymers and/or colloids. For example, it is straightforward to add electrolytes or other agents to a solution of polymers and/or colloids to monitor if and at what agent concentration levels certain phenomena occur, such as shrinking or swelling of the polymers or colloids, phase transitions, such as protein or polynucleic acid denaturation. Often, the only way to return to the starting composition of the polymers and/or colloids solution is to dialyze it against the initial solvent. But, in order to assess the reversibility, or the lack thereof, i.e. irreversibility, and under what conditions reversibility occurs, if at all, the effects of the dialysis process on the polymers and/or colloids must be monitored.

The devices, systems, and methods described herein can be used to assess reversibility in these systems. For example, in a first stage, the concentration of electrolyte or other agent in the first fluid can be increased as the agent(s) permeate in from the second fluid, and the effects on the polymers or colloids monitored. In a second stage the second fluid can be replaced with the initial buffer or solvent the polymer or colloids were originally in, which will return the polymers or colloids back to their initial solution conditions. The return can be monitored and factors such as hysteresis in the properties measured (e.g., size of polymers or colloids, phase changes, etc) can be continuously measured, and it can also be determined if the return to the initial solution conditions brings the polymers or colloids back to their initial characteristics, or if these are only partially regained (partial reversibility), or if they are not gained at all (irreversibility).

Other advantages of the devices, systems, and methods described herein become apparent when comparing these devices, systems, and methods to conventional alternatives. By way of example, a means of monitoring polymer properties, when such variables as polymer concentration or added electrolyte change continuously, was demonstrated with an Automatic Continuous Mixing (ACM) method. See R. Strelitzki, W. F. Reed, “Automated Batch Characterization of Polymer Solutions by Static Light Scattering and Viscometry”, J. App. Polym. Sci., 73, 2359-2368 1999. While producing good, continuous data the method requires tens of milliliters of polymer solution, whereas the the devices, systems, and methods described herein can be designed to utilize much smaller volumes (e.g., about 1 milliliter). Furthermore, the ACM method cannot monitor the removal of ionic or molecular agents. Another method of determining polymer properties with changing variables is to manually or automatically prepare discrete changes in polymer concentration or added electrolyte. This method produces only discrete data points versus the changing variable. Importantly, neither method is capable of reversing the addition of electrolyte, polymer or other substances. For example, after sufficient simple electrolyte is added to a s solution containing polyelectrolytes these latter will shrink in size until a certain ‘high salt limit’ is reached. The only way to test for the reversibility of the process is to remove the electrolyte, and one of the few means for doing this is by dialysis against an electrolyte-free solution or solution of dilute electrolyte. However, neither of the mentioned methods can monitor the effects of decreasing electrolyte via dialysis, and so cannot readily assess the reversibility of a process. In contrast, the the devices, systems, and methods described herein can monitor the effects on polymers and colloids during both the increase and decrease of added agents, such as simple electrolytes.

The devices, systems, and methods described herein can also be used to study a variety of other processes, including but not limited to the effects of chelation agents, ion penetration through ion selective membranes, combining temperature ramps or steps during membrane mediated processes, and formation of supramicellar assemblies due to added agents (e.g., dodecanol added to SDS solutions), and the effect of continuously changing pH on biomolecules, biopolymers, synthetic molecules, and/or synthetic polymers.

The devices, systems, and methods described herein can also be used to guide the formulation of biologic active agents (e.g., biologic drugs) to find concentration regimes of specific formulation components over which the biologic drug formulation is stable. For example, not limiting, the stability of a biologic drug, such as a monoclonal antibody, over a range of concentrations of formulation components can be determined, including pH ranges. These formulation components can include, but are not limited to, electrolytes of different valences and symmetries—e.g. NaCl (monovalent, symmetric), MgCl₂ (asymmetric with divalent cation), MgSO₄ (symmetric divalent)-surfactants, and any other additives, excipients, and stabilizers.

Examples of biologic active agents include, but are not limited to, Adalimumab (sold under the trade name Humira), Rituximab (sold under the trade name Rituxan), Etanercept (sold under the trade name Enbrel), Trastuzumab (sold under the trade name Herceptin), Bevacizumab (sold under the trade name Avastin), Infliximab (sold under the trade name Remicade), Insulin glargine injection (sold under the trade name Lantus), Pegfilgrastim (sold under the trade name Neulasta), Interferon beta-la (sold under the trade name Avonex), Ranibizumab (sold under the trade name Lucentis), insulin, glucagon, interferons, interleukins, hormones, blood factors, recombinant proteins (e.g. erythropoietin), fusion proteins (alefacept), classical viral vaccines, polysaccharide conjugate vaccines, and mRNA/lipid nanoparticle vaccines.

### EXAMPLES

The devices, systems, and methods will be described in greater detail by way of certain specific examples described below. The following examples are offered for illustrative purposes, and are not intended to limit the invention in any manner. Those of skill in the art will readily recognize a variety of non-critical parameters which can be changed or modified to yield essentially the same results.

### Example 1. Preliminary Investigation of Membrane-Mediated Processes

### Materials and Methods

Prototype device components, including cap assemblies, were fabricated via additive manufacturing using a Creality Ender 3 V2 Neo printer. While the prototypes were made by 3D printing using PETG Polymaker Polylite PETG), neither this material nor means of construction are limiting. Many other types of 3D printing and materials can be used. Modes of 3D printing include, but are not limited to, melted/extruded plastics, laser curing of thermosetting resins, laser sintering of to fuse small particles. Materials can include a wide variety of reversible thermoplastics and thermosetting plastics. Chloropolymers and fluoropolymers can be used where high resistance to chemical agents is required. Metals can also be used in 3D printers, including, but not limited to, titanium, stainless steel, tool steel, and nickel alloys. Other suitable means of construction besides 3D printing include, but are not limited to, injection molding, welding, extrusion, thermoforming, and machining, including cutting, bending, and assembling. As an example, not limiting, it may be desirable to use organic solvents or caustic agents not compatible with most plastics, so that a metal, such as aluminum, or a plastic, such as polytetrafluoroethylene (PTFE) might be chosen.

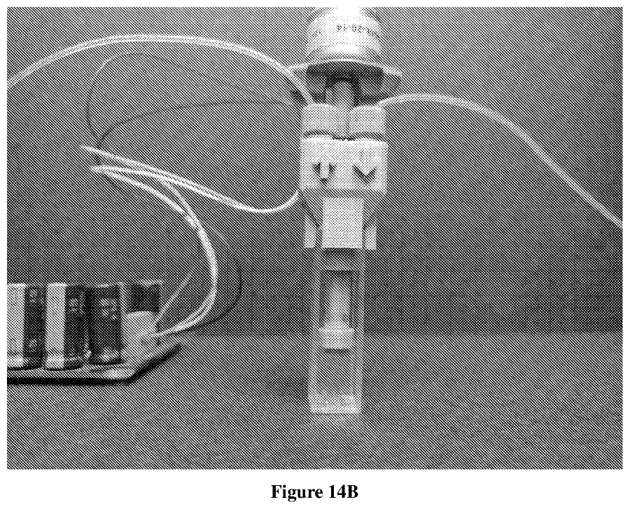

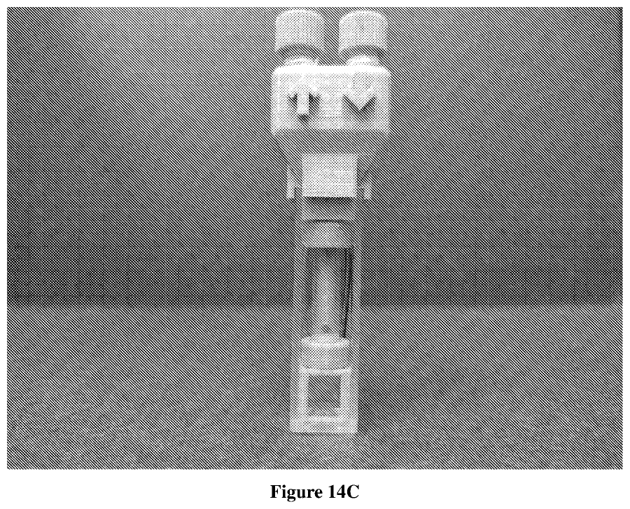

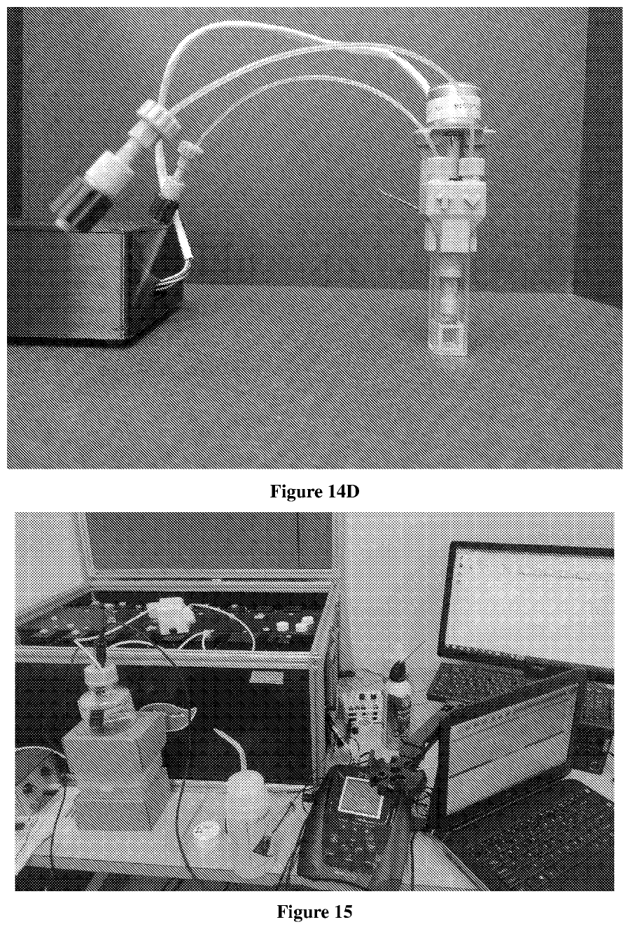

Sigma-Aldrich D9277-100 FT Dialysis tubing cellulose membrane, 10 k MWCO, 10 mm width was used as an example membrane in Examples below. Gorilla Super Glue Gel XL was used to seal the end of the dialysis tubing. FIG. 14A shows the device with the dialysis tubing sealed by Gorilla Super Glue Gel XL.

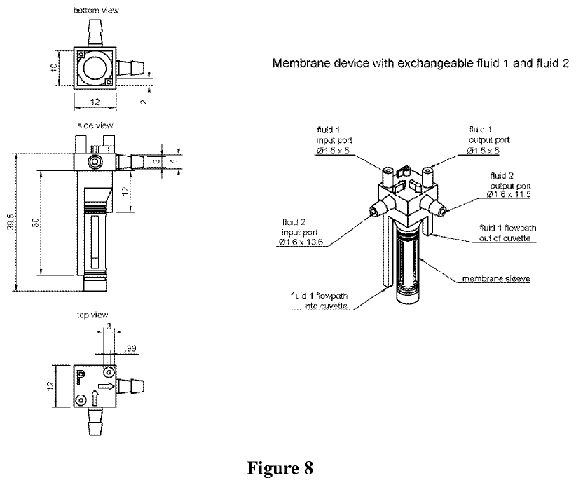

An alternate means of sealing the tubular dialysis membrane without a glue or sealing substance was also used and is shown in the schematic of FIG. 8b, wherein a circular post protrudes from the bottom of the cap assembly and contains grooves which accept o-rings that seal the dialysis tube at both ends without need of actually sealing the end of the dialysis tube. FIG. 14B shows the device without the dialysis tubing in place. FIG. 14C shows the device with the dialysis tubing secured and sealed in place by two o-rings on the bottom and three o-rings on the top.

Another means of sealing the bottom of the dialysis membrane is via a clip which pinches the tubular membrane shut.

Peristaltic tubing was Saint Gobain Pharmed® BPT, and peristaltic pumps were either Intllab Dosing Pumps, or a custom-fabricated peristaltic pump. In this latter dual-head peristaltic pumps are fabricated using 12V micro peristaltic pump heads (Kamoer KEF Low Flow dosing pump) with each head having individual control via low voltage DC rheostat switches. Housing for the peristaltic pump heads, switches and 12V power input are fabricated by 3-D printing.

A Thermo Orion Star A212 probe (conductivity only) and Thermo Orion Star A215 probe (conductivity/pH) were immersed in the external circulation reservoirs in various examples below.

### Example Devices and Systems

FIG. 7A shows an embodiment of an example device including a cap assembly with a fluid inlet and outlet port which can allow either the first or second fluid to be circulated or recirculated through the device. A closed membrane can be attached to the sleeve (also referred to as a mounting post) to contain the second fluid. The bottom of the tubular membrane used can be sealed by glue or a clip. In an alternative embodiment, the inlet and outlet ports can be eliminated, and the membrane-mediated process can occur via simple diffusion. Optionally, in this usage, the first fluid could be stirred with a magnetic stir bar, driven by a magnetic drive, or by a non-contact stir bar rotated via a motor, in the principal monitoring instrument.

FIG. 7B is an alternative embodiment of FIG. 7A, which has a long, cylindrical stalk protruding from the bottom, to which the membrane can be affixed and sealed with o-rings, thus avoiding the use of glue or clips for sealing the lower end of the membrane.

FIG. 8 shows an embodiment of an example device including a cap assembly with an additional fluid inlet and outlet port which allows both the first and second fluids to be independently circulated or recirculated through the device. A membrane can be attached to the elongated sleeve (also referred to as an elongated mounting post) to contain the second fluid. The membrane can be fixed in place by o-rings at the top and bottom of the sleeve which hold the membrane in place, thus eliminating the use of glue or a clip to seal the lower end of the tubular membrane.

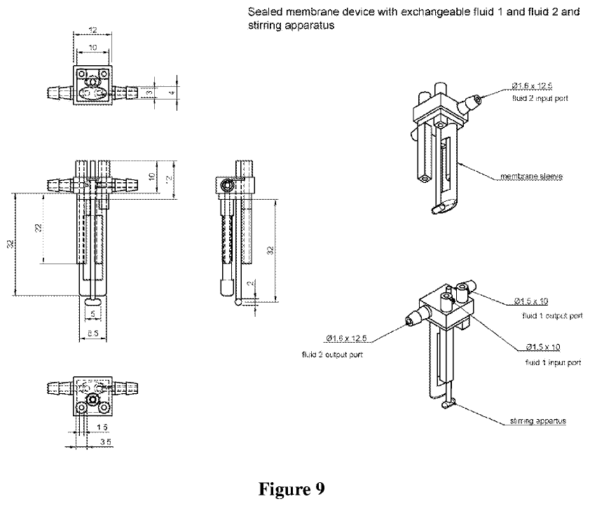

FIG. 9 shows an embodiment of an example device including a cap assembly with the same type of dual inlet and output ports of FIG. 8, allowing the first and second fluids to be independently circulated, and uses the same means of sealing the dialysis membrane to the mounting post as in FIG. 8. This embodiment of an example device includes a stirrer that allows a user to stir the first fluid without contact. This stirrer uses a stir-bar suspended by a shaft integral to the cap of the device. The stir bar can be driven, for example, magnetically or by a motor. The mounting post has been made into an oval shape and is set off to one side (i.e. it is not centered in the receptacle) to accommodate the suspended stirrer. It is well known that contact-stir, e.g. a magnetic stir bar rotating on the bottom of a receptacle, can severely damage proteins, RNA, DNA, and other macromolecules.

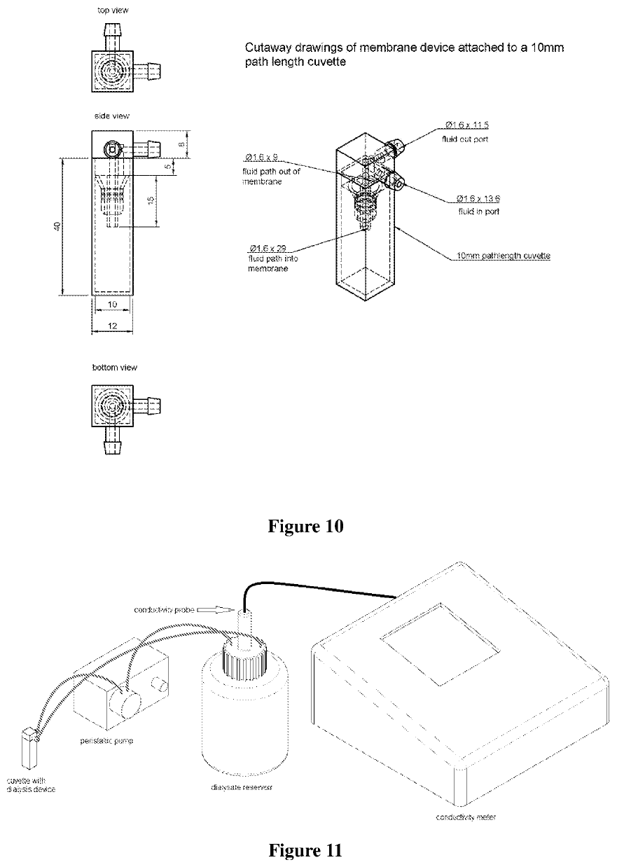

FIG. 10 illustrates the cap assembly of FIG. 7A inserted into a standard 10 mm pathlength cuvette. The embodiments shown in FIGS. 7B, 8, and 9 can likewise be directly inserted into a standard 10 mm pathlength cuvette. While these embodiments relate to cap assembies dimensioned to be inserted within a conventional 10 mm pathlength cuvette, it should be understood that cuvettes (or other containers) of different sizes and shapes can be used. Further, the dimensions of these cap assemblies can be varied so as to be insertable within cuvettes (or other containers) of different sizes and shapes.

FIG. 11 illustrates an example system utilizing the device illustrated in FIG. 7A (disposed within cuvette). The cuvette can be disposed within a principal monitoring instrument (e.g., within the sample holder of a spectrophotometer). As shown in FIG. 11, the fluid inlet and outlet port can be fluidly connected (e.g., via peristaltic tubing) to a circulation path that allows the second fluid to be circulated or recirculated. Circulation is driven using a peristaltic pump, and the circulating fluid passes through a dialysate reservoir. As shown in FIG. 11, an external monitoring instrument can be configured to interrogate the fluid circulating within the circulation path, for example. In this example, a conductivity meter can be immersed within the dialysate reservoir to provide for discrete or continuous measurement of the fluid circulating within the circulation path.

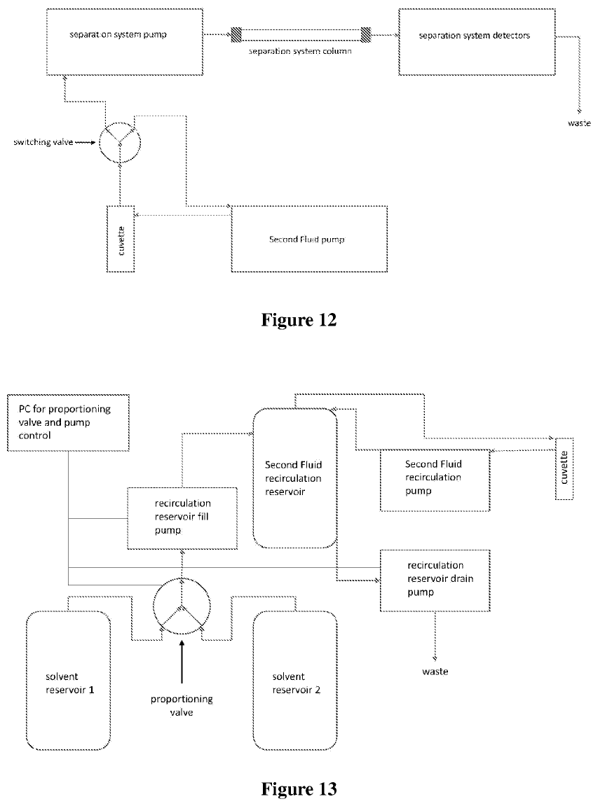

FIG. 12 schematically illustrates an alternative system in which a switching injector valve is used to direct the fluid circulating within the circulation path to an external separation system such as, but not limited to, an HPLC, a GPC, etc. The switching valve allows for sampling of an aliquot of the fluid into the external separation device, the volume of which can be determined by a sample loop on the switching injector valve. Typical injection volumes range from 10 to 250 microliters. The switching valve may be manually controlled or set to periodically introduce a sample of the fluid to the separation system. There is typically a delay of five to thirty minutes for a chromatographic separation on a single aliquot to be made.

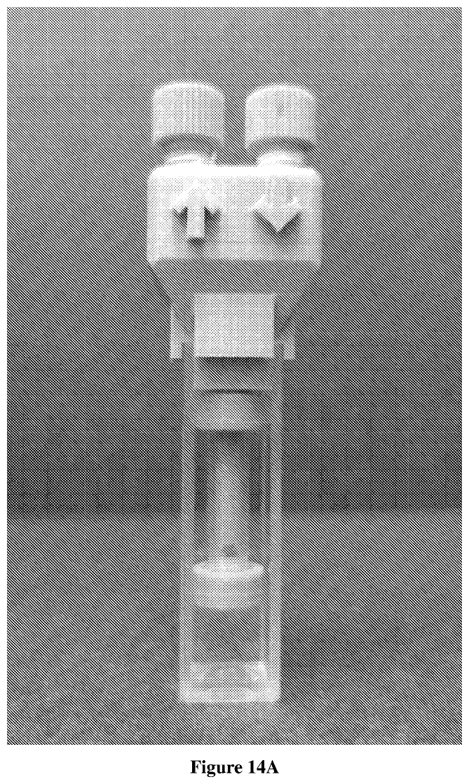

FIG. 13 schematically illustrates an alternative system which allows a user to change the composition of the fluid contained in the fluid recirculation reservoir. To change the composition of the fluid, the recirculation reservoir drain pump removes the fluid and sends it to a waste container. The recirculation reservoir fill pump can then refill the reservoir from a plurality of reservoirs housing fluids with varying compositions (e.g., solvent reservoir 1, solvent reservoir 2, etc., or a mixture of these reservoirs such as a mixture of solvent reservoir 1 and solvent reservoir 2). If desired, the ratio of fluid pulled from solvent reservoir 1 to solvent reservoir 2 can be controlled by the proportioning valve placed in the flow path between solvent reservoir 1 and solvent reservoir 2 and the recirculation reservoir fill pump.

### Monitoring the Time Dependence of a Membrane-Mediated Process

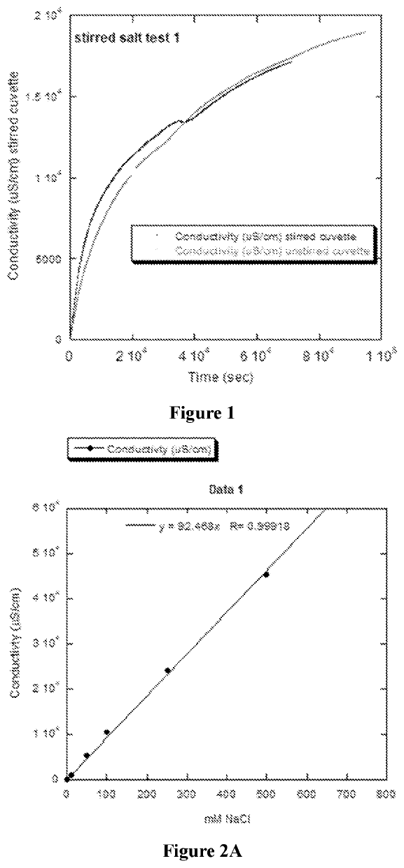

The devices, systems and methods described herein can be used to monitor the time dependence of membrane-mediated processes. By way of example, FIG. 1 shows the simple time-dependent result of starting with 100 mM NaCl in water as the first fluid in a receptacle such as that illustrated in FIG. 7A (when inserted in a cuvette), and circulating a solution of pure water as the second fluid, separated from the first by a membrane permeable to water, Na⁺ and Cl. As in the system illustrated in FIG. 11, a reservoir was placed in the circulation flow path of the second fluid, and a cylindrical conductivity probe was placed in the reservoir to measure the conductivity of the second fluid, which, in turn, yields [NaCl] in the first fluid, by the method described below. Over time, the NaCl in the first fluid permeates across the membrane into the recirculating second fluid, whose concentration of NaCl, and hence conductivity, increases in time. Stirring the first fluid causes an initial increase in ionic transfer. In some embodiments, the change in properties of the first fluid, including polymeric and colloidal components, can be measured versus the concentration of one or more components in the first and/or second fluids.

An example, not limiting, is to determine the concentration of electrolyte in the first fluid as it changes due to its contact with the second fluid, via the membrane, using continuous measurements of conductivity of the second fluid. Term the concentration of electrolyte ‘ionic strength’ (IS), which can be expressed in mass (e.g., g/cm³) or molar terms (e.g., mM=millimolar concentration, that is, millimoles per liter). IS can represent the concentration of electrolyte, e.g., IS=[NaCl] in this example, where [NaCl] is the millimolar concentration of NaCl.

The known quantities are the volumes of the first and second fluids, V₁ and V₂, respectively. Also, known is the initial concentration of electrolyte in fluids one and two, IS_{1.0} and IS_{2,0}, respectively. The total (millimolar) amount of electrolyte in the system comprising the first and second fluids is designated by me and is given by

$${m}_{E} = {V}_{1} {IS}_{1 , 0} + {V}_{2} {IS}_{2 , 0} \qquad 1 )$$

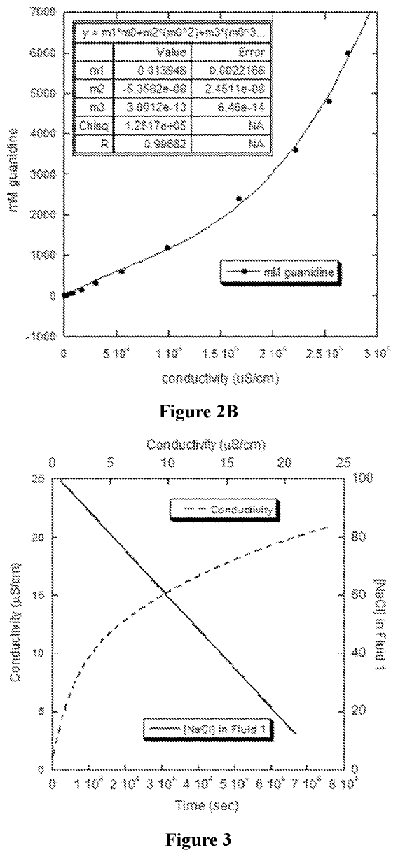

A calibration curve of conductivity, σ, vs IS was made separately for the chosen electrolyte, NaCl in this case, using a conductivity meter and known concentrations of the electrolyte. In the dilute regime, below about 600 mM of NaCl, there is a linear relationship between s and electrolyte concentration, of the form:

$$IS = \frac{σ}{β} \qquad 2 )$$

where β is the proportionality constant. In this example, conductivity was measured in mS/cm, and IS=[NaCl] in mM. As shown in FIG. 2A, β was found to be 92.47 for NaCl.

During a membrane exchange process, the conductivity of the second fluid was monitored in time, σ₂(t). Mass balance then yielded the IS (here, [NaCl]) in the first fluid as shown in the expression below.

$${IS}_{1} ( t ) = \frac{{m}_{E} - \frac{{σ}_{2} ( t ) {V}_{2}}{β}}{{V}_{1}} \qquad 3 )$$

FIG. 2A shows the linear relationship between conductivity and concentration of NaCl, [NaCl]. Above about 600 mM, the relationship became non-linear with a downwards curvature (negative second derivative).

FIG. 2B shows a non-linear relationship between IS and σ, treated below.

FIG. 3 shows a composite of [NaCl] vs time conductivity vs time for the stirred receptacle data of FIG. 1. The right-hand axis shows [NaCl] vs conductivity on the upper x-axis, where the relationship is obtained from β in Equation 2 is obtained from FIG. 2A.

At high IS the relationship between σ and IS is no longer of the linear form shown in equation 2. FIG. 2B shows the non-linear relationship between σ and IS for guanidine hydrochloride, Gd, which was fit with a polynomial, in this case a 3^{rd} order polynomial, not limiting, of the from

$$IS ( σ ) = {c}_{1} σ + {c}_{2} {σ}^{2} + {c}_{3} {σ}^{3} \qquad 4 )$$

where IS=[Gd] (mM), and σ is in micro-Siemens/cm.

The coefficients for Gd were c₁=0.013948, c₂=−5.3582e-8, and c₃=3.0012e-13. The leading constant term c₀ was omitted, since the conductivity of the pure deionized water used was negligible (~18 mS). Thus, Equation 3 became:

$${IS}_{1} ( t ) = \frac{{m}_{E} - IS ( σ ) {V}_{2}}{{V}_{1}} \qquad 5 )$$

Monitoring the Time Dependence of the Passage of a Small Ultra-Violet Absorbing and/or Fluorescing Molecules Through a Dialysis Membrane

In this example, the first fluid in the receptacle included a UV-absorbing molecule (acrylamide; Am) in pure water. In the receptacle, the first fluid was in contact with the second fluid containing pure water in a dialysis membrane (Sigma-Aldrich D9277-100 FT Dialysis tubing cellulose membrane, 10 k MWCO, 10 mm width). The receptacle in this example included the cap assembly illustrated in FIG. 7A with the dialysis membrane in place. The cap assembly was then inserted within a standard 1 cm square cuvette made of quartz. The cuvette containing the fluids was placed in the sample holder of a UV/visible spectrophotometer (Thermo Scientific Genesys 10S UV-Vis).

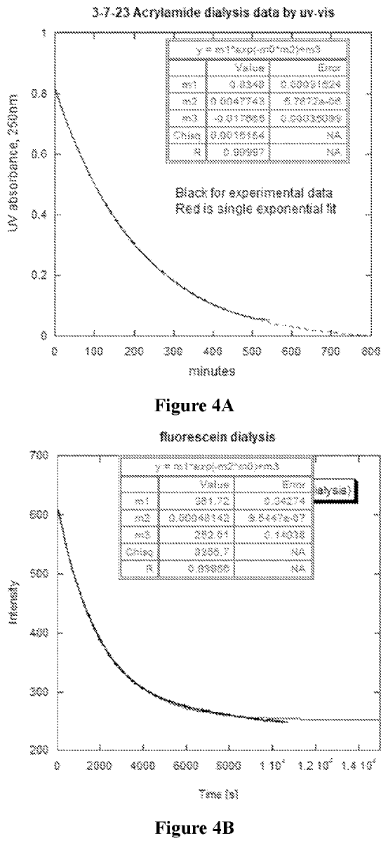

FIG. 4A shows the absorption at the 230 nm UV wavelength, which was monitored in time. The data show the decrease in UV absorption as the Am in the first fluid permeates into the second fluid across the dialysis membrane, and water from the second fluid passes through the membrane into the first fluid, thus diluting the Am in the first fluid and decreasing the UV absorption. Also shown is a single decaying exponential fit to the data. The concentration of the Am is directly proportional to the UV absorbance, as the UV spectrometer is operating in its linear response regime.

In another example, the first fluid was an aqueous solution containing sodium fluorescein in pure water. The second fluid was pure water without any fluorescein. The membrane was a dialysis membrane (Sigma-Aldrich D9277-100 FT Dialysis tubing cellulose membrane, 10 k MWCO, 10 mm width). The receptacle in this example included the cap assembly illustrated in FIG. 7A with the dialysis membrane in place. The cap assembly was then inserted within a standard 1 cm square cuvette made of quartz. The cuvette containing the fluids was placed in the sample holder of a Perkin Elmer LS50B Luminescence Spectrometer.

FIG. 4B shows the decrease of fluorescence as a function of time as the fluorescein permeates from the first fluid through the membrane and into the second fluid, while the aqueous fluid permeates into the first fluid through the membrane from the second fluid. The concentration of the fluorescein is directly proportional to the fluorescence intensity in FIG. 4B.

### Monitoring the Time Dependence of the Replacement of One Solvent by Another Solvent Across a Membrane

As an example, the first fluid can comprise an organic solvent miscible in water, such as, but not limiting, an alcohol, acetone, any number of organic acids, dimethyl sulfoxide, glycerol, tetrahydrofuran, or acetonitrile. The second fluid can comprise an aqueous solvent. The first fluid and the second fluid can be separated by a membrane within a receptacle. The receptacle can be placed in the sample holder of a principal monitoring instrument, such as a, instrument for measuring UV absorption or refractive index. The principal monitoring instrument can then be used to measure the rate of replacement of organic solvent by the aqueous solvent.

The roles of first fluid and the second fluid can also be inverted. Such a method can also be used to monitor the exchange of two different organic solvents, with no aqueous solvent being involved.

### Monitoring the Dependence of a Polymer or Colloid's Behavior as a Function of the Composition of Two Different Solvents

As an example, the first fluid can comprise a polymer soluble in, or colloid suspendable in a water-miscible organic solvent, such as, but not limited to, an alcohol, acetone, any number of organic acids, dimethyl sulfoxide, glycerol, tetrahydrofuran, or acetonitrile. The second fluid can comprise an aqueous solvent. The first fluid and the second fluid can be separated by a membrane within a receptacle. The polymer dissolved in the first fluid can be, for example, a polysaccharide, protein, RNA or DNA, or a synthetic polymer. The colloid suspended in the first fluid can include, for example, biological cells, clusters of cells, cell organelles, liposomes, vesicles, emulsions, or micelles.

The receptacle can be placed in the sample holder of a principal monitoring instrument, such as a static and/or dynamic light scattering instruments, a fluorimeter, a UV/visible spectrometer, or other optical instrument or non-optical instrument, such as a gas sensor, and the effects on the scattering from the polymer can be monitored as the aqueous solution displaces the organic solvent. The properties of the polymer or colloid can then be evaluated at discrete intervals or continuously as the organic solvent is replaced by the aqueous solvent.

In other examples, a mixture of organic solvents can be used instead of a single organic solvent. The composition of the first fluid and the second fluid can be inverted from the above description, i.e. the first fluid can be an aqueous fluid and the second fluid can comprise a water-misible organic solvent.

Monitoring the Dependence of a Polymer's Static and Dynamic Scattering Behavior as a Function of the Concentration of Electrolyte (and/or Determining Whether the Process is Reversible)

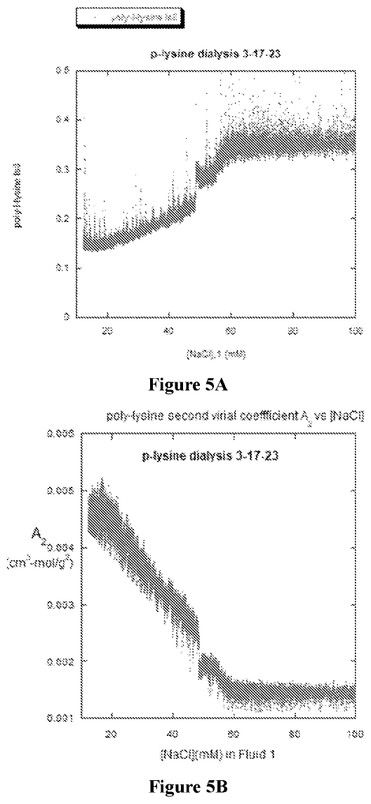

By way of example, a charged polymer, in this example polylysine, was dissolved in water of high ionic strength (IS), 100 mM=[NaCl] in this example, to create 2.5 mL of first fluid. The second fluid was pure water (or could be water at low IS). The second fluid was placed in a tubular dialysis sack, whose portion residing in the first fluid is sealed. The device of FIG. 7A was used and placed in a disposable 1 cm polystyrene cuvette. The solution in the sack was circulated through an external reservoir, and the ionic strength of this was measured as dialysis occurred, via a conductivity meter immersed in a reservoir in the flow path of the circulating second fluid. Via the ratio of volumes of the first fluid and the second fluid, including the circulation loop, the IS of the first fluid was computed and the scattering behavior of the polymer was determined vs IS, such as detailed above. FIG. 5A shows a plot of the light scattering intensity vs [NaCl].

The reversibility of the dialysis behavior was then investigated by leaving the first fluid, a polymer solution at low IS, in the device and circulating high IS water, such that the final IS matches the initial IS of the polymer in the first fluid. The same procedure was then followed, but with DLS monitoring instead of SLS monitoring.

Using the raw static light scattering (SLS) data from FIG. 5A the osmotic second virial coefficient, A₂, was computed vs [NaCl] for the poly-L-lysine via the expression below

$$\frac{Kc}{{I}_{R}} = \frac{1}{{M}_{w}} + 2 {A}_{2} c \qquad 6 )$$

where K=1.563×10⁻⁷ is the optical constant for vertically polarized incident light for water, an incident wavelength of 660 nm, and dn/dc=0.16 cm³/g for p-lysine in low ionic strength (<600 mM IS), c is the p-lysine concentration (0.011 g/cm³) and M_{w}=153,000 g/mole is the weight average molar mas of the p-lysine, and I_{R} is the absolute Rayleigh Ratio, determined from the raw data above via calibration with toluene scattering. This analysis is commonly used by those skilled in the art of polymer characterization using SLS.

FIG. 5B is a plot of A₂ vs [NaCl] for p-lysine. Below [NaCl]=60 mM A₂ rises due to electrostatic repulsion among p-lysine polymer chains. Above [NaCl]=60 mM A₂ remains constant, indicating that the electrostatic contribution to A₂ has been fully shielded by the NaCl. This represents the first time that A₂ has been determined in this type of automatically monitored membrane exchange process. This method can find widespread application in characterizing polyelectrolyte properties.

Using Dynamic Light Scattering (DLS) in the above dialysis experiment as the principal monitoring instrument can give complementary information on how the diffusion coefficient and effective hydrodynamic diameter of the polyelectrolyte varies with [NaCl].

Monitoring the Dependence of a Polyampholyte's Static and Dynamic Scattering Behavior as a Function of Electrolyte Concentration (and/or Determining Whether the Process is Reversible)

By way of example, the first fluid can comprise a polyampholyte (for example, a protein within a certain pH range) in a high ionic strength aqueous solution; e.g. 1M NaCl. The second fluid, separated from the first fluid by a membrane permeable to the electrolytes but impermeable to the polyampholyte, can comprise an aqueous solution of much lower ionic strength solution, than the first fluid (e.g., 0.0001M NaCl), and contain no polyampholyte. The second fluid can be circulated through a conductivity meter to track the ionic strength in the second fluid, and by comparison of the volumes of the first fluid and the entire volume of the recirculation loop of second fluid, the ionic strength of the first fluid can be calculated.

The receptacle containing the first fluid and the second fluid, and separating membrane, can be placed in a static light scattering or dynamic light scattering device, or a device capable of measuring both static and dynamic light scattering. The dimensions and association behavior of the polyampholytes will change as the ionic strength decreases, and these changes can be monitored by the light scattering device. Normally, the dimensions of the polyampholytes will decrease as IS decreases and interpolymer associations will increase, opposite of the effect of IS on single charge polyelectrolytes. Polyampholytes are polymers that contain both positive and negative charges.

The same experiment can then be performed, except that the second fluid can be replaced by an aqueous solution at high IS. The IS of the first fluid containing the polyampholyte is very low after the process above; however, it will now begin to increase. If the process is fully reversible, a plot of the light scattering data versus IS in the first fluid from both parts of this trial should be superposable. If not, the process may involve hysteresis or non-reversibility. The latter can be distinguished by increasing the second fluid IS in steps, rather than starting at high IS. If hysteresis is involved, rather than irreversibility, the slower time of changing IS should bring the scattering behavior closer. If not, the process can be repeated at even slower IS steps, and if the difference in data persists, then the process is irreversible.

These monitoring methods can also be carried out on polyzwitterions, that is, polymers that contain functional groups (moieties) involving both positive and negative charges.

### Monitoring the Denaturation of a Protein as a Function of Denaturant Concentration and Subsequently Determining if the Process if Reversible

By way of example, the reversibility of protein denaturation was investigated by dissolving protein, bovine serum albumen (BSA) in this example, in the first fluid containing an aqueous solution or buffer, a 100 mM NaCl solution in this example. A concentrated 6M aqueous solution of a denaturant (guanidine hydrochloride (Gd) in this example) served as the second fluid. The second fluid was enclosed in a sealed dialysis sack, separating it from the first fluid, using the device of FIG. 7A, which was placed in a disposable 1 cm polystyrene cuvette. The decreasing concentration of Gd, [Gd], was monitored during dialysis by a conductivity probe in the second fluid recirculation reservoir. The denaturation of the protein was monitored, in this case, by SLS, using a Fluence Analytics ARGEN.

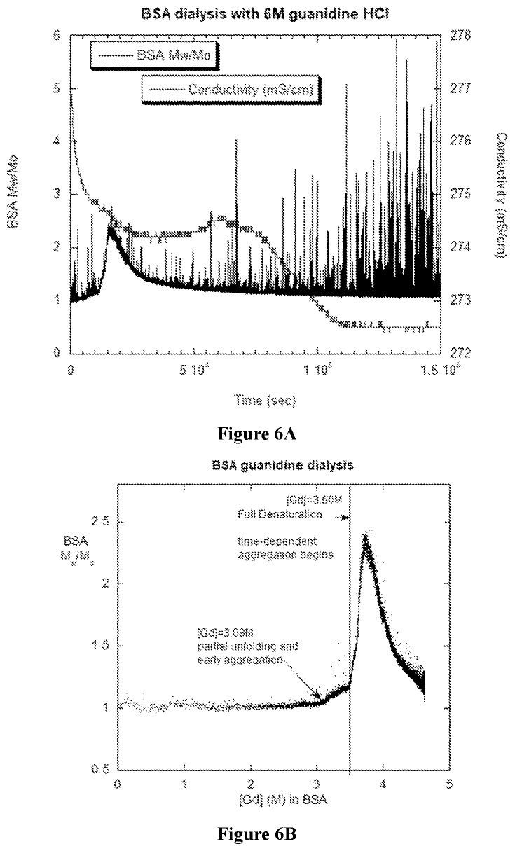

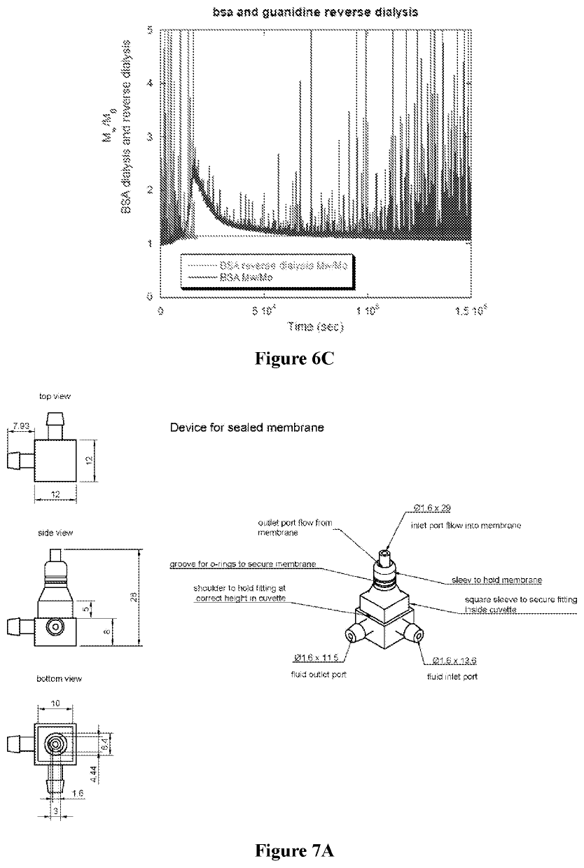

The raw data are shown in FIG. 6A. The left-hand axis is M_{w}(t)/M₀ versus time, was obtained from the static light scattering intensity, where M_{w}(t) is the weight average molecular weight of the protein, both aggregated and unaggregated populations of the BSA, and M₀ is the initial weight average molecular weight of the intact, non-denatured BSA. The concentration was low enough that second virial coefficient effects are negligible, so that M_{w}(t)/M₀=I(t)/I₀, where I₀ is the initial (t=0) excess light scattering intensity (scattering voltage minus the scattering voltage of the pure solvent), and I(t) is its value as time increases. Also shown is the conductivity of the circulating second fluid (right-hand axis) versus time. This can be used to determine the [Gd] in the BSA solution, according to the method explained above.

As shown in FIG. 6A, there was a slow increase in scattering (represented by M_{w}(t)/M₀) starting at 7,800s, and an abrupt increase starting at 12,300s. This latter time marks the point of complete denaturation. The sharp increase in scattering corresponds to aggregation of the protein after the denaturation event. The decrease in scattering after 16,000s corresponds to precipitation of the aggregated BSA, and the increasing density of large scattering spikes corresponds to increasingly large aggregates passing through the scattering volume.

FIG. 6B shows M_{w}(t)/M₀ from FIG. 6A versus [Gd] in the BSA in the first fluid, where [Gd] was found from the conductivity of the circulating second fluid by the method described above. The data suggest that a partial unfolding of the BSA occurs at [Gd]=3.08M, and that complete denaturation occurs abruptly at [Gd]=3.50M. This example demonstrates the ability of the devices, systems, and methods described herein to evaluate the stability of a protein against a denaturing agent.

The reversibility of the denaturation process was assessed as follows. After dialysis, the first fluid containing denatured protein a a solution having a relatively high [Gn]. The second fluid was replaced with pure solvent, 100 mM aqueous NaCl, and recirculated such that the first fluid returns to protein in the original guanidine-free solvent.

FIG. 6 shows the scattering of the BSA as Gd is removed from the BSA solution. There is no change in the scattering, which remains at the previous level. The extrapolated line shows that the scattering was at the same level as when the BSA was at [Gd]=6M. The conclusion is that the denaturation of BSA by Gd, which caused it to aggregate, is irreversible.

These experiments can also be performed with other principal monitoring instruments, such as, but not limited to, DLS, circular dichroism, circular birefringence, fluorescence, and UV absorption.

Monitoring the Denaturation of RNA and/or DNA vs the Concentration of Denaturant (and/or Determining Whether the Process is Reversible)

By way of example, the first fluid can comprise RNA or DNA in a suitable buffer or solvent. The second fluid can comprise a denaturation agent, such as, but not limited to, urea or guanidine hydrochloride.

The first fluid and the second fluid can be separated by a membrane, such as a dialysis membrane (Sigma-Aldrich D9277-100 FT Dialysis tubing cellulose membrane, 10 k MWCO, 10 mm width), within a receptacle. The receptacle in this example can include the cap assembly illustrated in FIG. 7A. The cap assembly can then be inserted within a standard 1 cm square cuvette made of quartz for UV and fluorimeter measurement, or within a 1 cm cuvette made of plastic or glass for measurements not involving UV light. The cuvette containing the fluids can then be placed in the sample holder of a principal monitoring instrument (e.g., UV, Fluorescence, circular dichroism, circular birefringence, SLS, and DLS, among other instruments, that can monitor denaturation). The effect of the denaturant on the RNA or DNA can be monitored by the principal monitoring instrument. The reversibility of the denaturation can be assessed by replacing the second fluid with the original solution composition that was in the first fluid initially, without any RNA or DNA.

### Monitoring Micellization and Demicellization Processes

By way of example, a demicellization process can be monitored using a first fluid that comprises a surfactant above its critical micelle concentration (CMC) dissolved simple electrolyte (e.g., NaCl) at a given concentration [E]. The second fluid can comprise an aqueous solution with the same [E] that recirculates through an external reservoir containing a conductivity probe. The behavior of the dilution of the surfactant in the first fluid can be monitored by SLS and/or DLS, including the passage through the CMC which will lead to an abrupt decrease in both light scattering intensity (SLS) and hydrodynamic diameter measured by DLS. If the CMC is reached in the second fluid the slope of its conductivity versus surfactant concentration will abruptly decrease to a lower value.

A refractive index detector can be substituted for the conductivity probe in the second fluid recirculation loop. This allows not only an alternative means of measuring the concentration of anionic (e.g., sodium dodecyl sulfate) and cationic surfactants (e.g., cetyltrimethylammonium bromide), but also of nonionic surfactants (e.g., polysorbates, triton x-100).

By way of example, a micellization process can be monitored using a second fluid that comprises a surfactant dissolved above its CMC of dissolved simple electrolyte (e.g. NaCl) at a given concentration [E] that is recirculated through an external reservoir containing a conductivity probe. The first fluid can comprise an aqueous solution with the same [E]. The behavior of the dilution of the surfactant in the first fluid can be monitored by a principal monitoring instrument, such as SLS and/or DLS, including the passage through the critical micelle concentration (CMC) which will lead to an abrupt increase in scattering (by SLS) and hydrodynamic diameter (by DLS)

IS effect on CMC can also be assessed using the devices systems and methods described herein. By way of example, the first fluid and second fluid can comprise a surfactant at the same concentration, such that the surfactant at this concentration in pure water or low ionic strength solution is below the CMC. The surfactant in the first fluid can be in pure water or low ionic strength aqueous solution, whereas the surfactant in the Second Fluid is in a high ionic strength aqueous solution, such as, but in no way limiting, a 200 mM NaCl solution. Conductivity, refractive index, or an alternative external monitoring instrument can be used to determine [NaCl] (and hence IS) in the second fluid, and hence also in the first fluid. As [NaCl] increases in the first fluid, the CMC will eventually be reached, and detected by SLS and/or DLS, and in the behavior of the conductivity or refractive index of the circulating second fluid.

To map out the CMC versus IS, after the CMC is found for [NaCl] in the first fluid, the [NaCl] can be lowered, by dilution or replacement of the second fluid, and the micelles in the first fluid will eventually demicellize at a certain [NaCl] in the first fluid. This determines the CMC at a lower [NaCl]. The dilution process can continue until finally pure water flows in the second fluid, each iteration producing a new pair of values for CMC and associated [NaCl]. This iterative process can be performed both manually or automatically. An example of a programmable proportioning valve for up to four separate fluids is the Shimadzu FCV-10AL VP quaternary mixer. It can be used with a pump such as the Shimadzu LC-10AT VP or LC-10AD VP pump.

If this process is done automatically, the system can be configured such that when the system detects CMC has been reached, the system can automatically trigger a change-over of the content of the second fluid, either by dilution or introducing a fresh solution. This can easily be accomplished having dilution reservoirs, all at the same surfactant concentration but different [NaCl], or by having the surfactant at the same concentration in two reservoirs; one comprising the surfactant and pure water, the other the surfactant in high concentration NaCl. A proportioning valve can then be programmed to automatically mix these to any desired [NaCl], whose steps can be pre-programmed, or determined by an algorithm which selects the next [NaCl] based on the magnitude of the change from the previous dilution step.

IS effect on the second virial coefficient, A₂, can also be assessed using the devices systems and methods described herein. By way of example, with surfactant well above the CMC in the first fluid at a fixed [NaCl], the same aqueous solution [NaCl], without surfactant can be placed in the circulating second fluid. The light scattering intensity can be measured as the surfactant concentration decreases, allowing the determination of A₂ at that [NaCl]. A₂ can be determined vs [NaCl] by using different values of [NaCl] in the isotonic determination. This can be accomplished manually, selecting [NaCl] and [surfactant], or automatically, using the type of reservoirs described above.

Monitoring Bursting or Shriveling of Biological Cells when Exposed to Hypotonic or Hypertonic Solutions

By way of example, the first fluid can comprise dilute biological cells in an aqueous solution of physiological or near physiological composition. The second fluid, separated from the first by a membrane, can comprise water and possibly other electrolytes or substances, such that its ionic strength is well below that of the first fluid; i.e. the second fluid is hypotonic for the biological cells. As electrolyte leaves the first fluid through the membrane, the biological cells in the first fluid will swell, which can be detected by the principal monitoring instrument. Ultimately, the first fluid will become hypotonic enough that the cells will burst. The swelling and bursting events can be detected by static and/or dynamic light scattering, as well as UV absorption, fluorescence, and turbidity. The ionic strength at which the bursting of the biological cells occurs can be determined, not limiting, by the increase in conductivity and/or refractivity of the second fluid.

In another example, the first fluid can comprise dilute biological cells in an aqueous solution of physiological or near physiological composition. The second fluid, separated from the first by a membrane, can comprise an aqueous solution whose ionic strength is well above that of the first fluid; i.e. the second fluid can be hypertonic for the biological cells. As electrolyte enters the first fluid through the membrane the biological cells will shrivel as the first fluid becomes more and more hypertonic. The biological cells may also collapse if the first fluid becomes hypertonic enough. The shriveling and possible collapse processes can be detected by static and/or dynamic light scattering, as well as UV absorption and fluorescence. The ionic strength of the first fluid during the process can be determined, not limiting, by the increase in conductivity and/or refractivity of the second fluid.

These methods can also be used to monitor the effects of conditions and agents on synthetic entities such as liposomes, surfactant vesicles, emulsions, microemulsions and miniemulsions.

### Monitoring Blood Clotting Due to Blood Clotting Factors

By way of example, unaggregated blood cells can be suspended in a solution (e.g., Ringer solution) and used as the first fluid. A second fluid with the same or similar solvent composition (e.g., Ringer solution) contains one or more blood clotting factors, either naturally occurring (e.g., a fibrinogen) or synthetic. The concentration of the blood clotting factors in the first fluid can be obtained by monitoring measurements on the second fluid circulating through one or more external monitoring instruments, such as, but not limiting, UV/visible absorption, fluorescence, or conductivity.

Likewise, if a sample of aggregated blood cells are placed in the first fluid and a solvent (e.g., Ringer solution) without clotting factors is used as the second fluid, the reversibility of the clotting can be evaluated. If desired, one or more agents that may cause declotting of the clotted blood cells can be added to the second fluid, providing a method to evaluate the activity of a potential declotting agent.

Monitoring Prion Dissociation and/or Formation

By way of example, prions, such as prions associated with Alzheimer and other neurodegenerative diseases, can be dissolved in the first fluid, and the second fluid can include the same buffer as the first fluid along with one or more agents that may lead to the dissociation of the prions. Light scattering and/or other primary monitoring instrument(s) can be used to follow dissociation, if it occurs. Such methods can be used to seek agents that will dissolve prions as a possible means of mitigating certain neurodegenerative diseases.

In another example, a protein known to form prion aggregates can be dissolved in the first fluid. This protein would normally aggregate under the conditions used. The second fluid can include an agent known to inhibit prion formation, or an agent hypothesized to inhibit prion formation. As these agents perfuse through the separating membrane, the state of aggregation of the prion-forming proteins can be monitored.

### Poisoning or Loss of Biological Function

By way of example, living cells can be placed in the first fluid in a nutrient broth allowing their population to grow. The growth of the cells can be monitored by a principal monitoring instrument, such as an instrument to measure turbidity, HTDSLS, SLS, or metabolically generated gases emitted by the living cells. A suspected toxin can be dissolved in the second fluid. As the suspected toxin permeates through the separating membrane into the first fluid, changes in the growth and health of the cells present in the first fluid can be detected by the principal monitoring instrument (e.g., in HTDSLS the particle density will cease to increase or slow its growth rate, and SLS, turbidity, or head space gas measurements will show decreases in growth).

In some embodiments, this determination can be made incrementally by manually or automatically changing the toxin concentration in the second fluid at intervals, in order to achieve stable toxin levels in the first fluid and hence monitor respond to the toxins at a series of fixed concentrations. The process can also be done with the second fluid containing the living cells and the first fluid containing the toxin. In both cases toxin concentrations can be monitored if run continuously, via the principal monitoring instrument or an external monitoring instrument(s).

### Membrane Degradation and Stability

New membranes are constantly being developed for batteries and other forms of energy storage and release, for biological, medical, and chemical purposes, and for separation processes. The devices, systems, and methods described herein can be used to assess the stability of membranes against different factors. These can include, but are not limited to, temperature, acids, bases, specific ions, other molecular agents, and radiation. A variety of different principal monitoring instruments can be used to detect membrane degradation. By way of example, the membrane in the receptacle degrades it will normally shed fragments of polymers, cross-linked polymers, or fibers. These can be detected by several principal monitoring instruments, such as but not limited to SLS, DLS, UV/visible absorption, fluorescence, chirality, and refractivity.

### Recirculating Fluid Flows Through an Automatic Injection Valve for Periodic Chromatographic Measurements

Automatic injections into a gel permeation chromatography (GPC) are made, where the GPC is used as an external monitoring instrument in the recirculation line. (GPC is sometimes termed SEC, size exclusion chromatography, when separation of the sample occurs due to purely entropic effects, and no enthalpic effects). By way of example, a highly disperse polymer solution can be used as the second fluid and the same solvent (without any polymer) can be used as the first fluid. Automatic or manual GPC injections can be made at intervals (e.g., every ten minutes). An example of a commercially available automatically actuated injection valve is the Rheodyne MXT715-000 autoinjector. The low molecular weight polymer will pass from the second fluid across the membrane that separates the first fluid and the second fluid, which will narrow the molecular weight distribution of the polymer in the second fluid, measured by GPC. The entrance of the small polymers into the first fluid can be monitored by light scattering or other optical instruments.

Automatic injections can also be made into a High-Pressure Liquid Chromatography system (HPLC), where the HPLC is used as an external monitoring instrument in a circulation path. Automatic injections into a Field Flow Fractionation (FFF) can also be made, where the FFF is used as an external monitoring instrument in a circulation path.

### Asymmetric Assessment of Reversibility

The devices, systems, and methods described herein can be used to monitor the effects of removing agents, such as, but not limiting, electrolytes and small molecules. In this case it may be desirable to change the initial condition of the first fluid in a discrete step, or series of discrete steps, adding a certain agent, such as, but not limited to, electrolytes, denaturing agents, and other molecules to which the membrane is permeable, up to a final desired concentration. The effect of removing these added agents can then be monitored as the permeable agent concentration diminishes as it passes into the second fluid, which initially has no, or little of the permeable agent.

By way of example, the devices, systems, and methods described herein can be used to assess the reversibility of the denaturation (unfolding, or loss of secondary, tertiary, or quaternary structure) of a macromolecule, such as a protein, or polynucleic acid, such as RNA or DNA. The denaturation agent at intermediate concentrations may cause some effect, or secondary effect, such as aggregation of the macromolecule, which is itself irreversible. In order to avoid this unwanted effect, the native (undenatured) macromolecule in the first fluid can be measured by the principal monitoring instrument, any additional sensors interrogating fluids in the receptacle, and external monitoring instruments in non-denaturing conditions. The denaturant can then be added, either via a fluid containing the denaturant or by directly adding the solid/powder form of the denaturant, to the first fluid in one addition up to the final desired concentration of denaturant, or added in steps in time periods short enough to avoid aggregation or other undesired effects.

Once the desired concentration of denaturant is reached in the first fluid, it subsequently permeates out of the first fluid through the membrane, and into the second fluid, which either has none of the denaturant, or a much lower concentration of the denaturant. The reversibility or irreversibility of the denaturation can thus be monitored as the denaturant concentration in the first fluid decreases, including any effects, such as aggregation, that may occur during this process. Because the macromolecule in the first fluid initially in non-denaturing conditions is brought up to denaturation conditions in one of more discrete steps, and then allowed to return gradually and continuously to its initial or near-initial solution conditions, the process can be termed ‘asymmetric’. This is contrast to the symmetric process, where the macromolecule is brought to its denatured state through continuous permeation of the denaturant from the second fluid into the first fluid in a first step, and then, in the second step the first fluid is returned to its initial or near-initial fluid composition via the same type of membrane permeation process.

In the case where an agent is added in liquid form to the first or second fluid in the receptacle, the device can include contain a port, or a simple hole, through which the added liquid can be introduced, for example, by a needle or a syringe.

### Example 2. Dialysis Monitoring of Ionic Strength and Denaturant Effects, and their Reversibility, for Various Classes of Macromolecules

### Overview

Monitoring membrane mediated dialysis in realtime with static and dynamic light scattering revealed distinctive differences, including reversibility/irreversibility, in the effects of ionic strength (NaCl) and the denaturant guanidine hydrochloride (Gd) on both a synthetic polyelectrolyte, and several types of biomacromolecules: proteins, a polysaccharide, and polyampholytes. Dialysis cycles against aqueous NaCl and Gd, and reverse back to the original aqueous solution were monitored. The behavior of Na-polystyrene sulfonate (PSS) was reversible and yielded a detailed polymer physics description, while all the biomacromolecules additionally showed hydrogen bond and/or hydrophobic effects (HP effects). An interpretive model for the biomacromolecules is developed which considers the interplay among polyelectrolyte, polyampholyte and HP potential energies in determining the different types of associative, aggregative and dissociative behaviors. NaCl isolated purely electrostatic effects, whereas Gd combined electrostatic and HP effects. Some of the biomacromolecules showed partially reversible behavior, and others were completely irreversible. The dialysis monitoring method should prove useful for investigating fundamental macromolecular and colloid properties, and to aid in drug formulation and stability optimization.

### Introduction

Charged macromolecules respond to added electrolytes and denaturants in different ways. Polyelectrolyte coils with charges of a single sign shrink as ionic strength increases and charges are shielded, whereas polyampholytes, having charges of both signs, generally increase in coil size as ionic strength increases and shielding decreases attractive forces between oppositely charged groups. Certain biomacromolecules—proteins, polysaccharides, RNA, and DNA—can undergo changes in size and also aggregate when ionic strength increases. For molecules with secondary structure a denaturant, such as guanidine hydrochloride (Gd), can cause partial or complete loss of secondary structure, and in some cases, aggregation. Similarly, the tertiary structure of some proteins can be affected by denaturants.

An important question surrounding these changes in characteristics as ionic strength and denaturant concentration changes is whether the changes are reversible, partially reversible, or irreversible. While it is simple to increase the concentration of solutes, such as electrolytes and denaturants, and to measure corresponding changes in the characteristics of macromolecules and colloids, removing these agents requires a method, such as membrane dialysis or ultrafiltration. The current work uses a device that enables macromolecular characteristics to be spectroscopically monitored in realtime, during dialysis or other membrane-mediated processes. Hence, it is possible to continuously monitor, during dialysis, the addition to a macromolecular or colloidal solution, of an agent, such as an electrolyte or denaturant, and then to subsequently monitor the reverse process. The cycle can also start with the agent already present in the macromolecular solution, dialyzing it away against a simple aqueous solution, and then reversing the process and dialyzing the agent back into the solution. The spectroscopic detection means used can be static and dynamic light scattering (SLS and DLS, respectively), fluorescence, UV/visible absorption, circular dichroism, and any other instrument that can accept a 1 cm cuvette.

Proteins are known to denature under certain conditions, including high temperature, extreme pH, and in solution with compounds such as guanidinium hydrochloride and urea. Denaturation is a total loss of a macromolecule's globular native state. In the case of proteins, this typically includes both the secondary and tertiary structures but not necessarily quaternary as those are held together by covalent bonds, while the former two are due to hydrophobic interactions and hydrogen bonds.

Aggregation refers to the phase transition in which a macromolecule loses its native structure and multiple molecules come together to form a structure that has different physical and functional properties than the molecule from which it formed. In the case of proteins, they can misfold either into amyloid fibrils or disordered aggregates. These structures are polymeric complexes formed from several protein molecules that come together. This occurs because it is likely that the native conformation of a protein is not necessarily its lowest possible free energy state. The energy funnel of a protein has multiple minima, of which the native state is simply one.

Both denaturation and aggregation will disrupt a functional protein (i.e. an enzyme or structural element) and prevent it from performing its function. In vivo, this can cause large scale systemic disruption as in the case of aggregation-based neurodegenerative diseases such as Alzheimer's Disease, Amyotrophic Lateral Sclerosis, and prion disorders. Insight into the physical conditions causing denaturation and aggregation can give a better idea of the physical properties that underlie the structural transitions. Additionally, the ability to distinguish between conditions that cause denaturation and conditions that cause aggregation can enable more precise formulation of biologic drugs to prevent either disruption.

Protein unfolding is frequently accompanied by irreversible aggregation. Aggregation is particularly harmful in biologic medicines and great efforts are made to ensure that proteins remain in their native state and don't aggregate. A number of mechanistic models for protein aggregation exist, and solution conditions, including ionic strength, pH and the presence of surfactants and other excipients must be found in order to arrive at stable therapeutic formulations.

Proteins can be treated as polymers despite their lack of true repeated structural units. When using treatments and techniques from polymer physics, understanding related behavior in an organic polymer can aid understanding of the biological phenomena. Thus, this Example describes experiments performed using a variety of natural macromolecules as well as a synthetic polyelectrolytes to verify the validity of both the method and analysis.

### Materials and Methods

Macromolecules. To explore the possibilities of the realtime dialysis monitoring, including reversibility, the following macromolecules were chosen.
1) A synthetic polyelectrolyte. For this, polystyrene sulfonate (PSS) was chosen. PSS was synthesized using KPS-initiated free radical polymerization.
2) A natural polyampholyte. Gelatin was chosen as an example polyampholyte. It was dissolved at 1 mg/mL in salt concentrations between 10 and 100 mM. Gelatin is a fibrous protein, so it requires heating to dissolve. Solutions were placed in an orbital shaker at 40° C. for 2 hours, and then filtered with a 5 μm syringe filter immediately after cooling to minimize bacterial contamination.
3) A natural polyelectrolyte. For this, sodium alginate was chosen. It was from Alfa Aesar/Thermo Fisher Scientific (J61887, Lot M30G001)
4) A selection of proteins.
   i) Bovine Serum Albumen (BSA) was from Sigma Aldrich and had a purity reported as over 99%, purified by gel electrophoresis. Serum Albumen proteins transport fatty acids and other molecules as well as act as antioxidants and anti-coagulants. BSA was dissolved at 2 mg/mL in phosphate buffer PBS (NaH₂PO₄—Na₂HPO₄) or Tris/Trizma buffer systems. BSA is not sensitive to conditions and will dissolve at any pH between 5 and 9 at concentrations below 30 mg/mL.
   ii) Hen Egg White Lysozyme was from ThermoFisher Scientific. Lysozyme is a component of the innate immune system and is an antimicrobial enzyme. Lysozyme is able to cleave the N-acetylmuramic acid linkages found in bacterial peptidoglycan cell walls. Human tears typically have a concentration of around 1.4 mg/mL lysozyme. The lysozyme was dissolved at 5 mg/mL in 10 mM NaCl.
   iii) Immunoglobulin (IgG), a Human serum IgG Lyophilized Fractionated Purified (IRHUGGF-LY) was from Innovative Research, Inc., and had a purity reported as over 97%. IgG is an antibody that aids in controlling infection, neutralizing toxins, and more. Each individual IgG contains two identical antigen binding sites. There are four subclasses of IgG (IgG1, IgG2, IgG3, and IgG4) that have different (and sometimes opposing) properties.
   iv) Proteinase K purified from the fungus Tritirachium album was from Millipore Sigma. It enzymatically cleaves peptide bonds adjacent to the carboxyl group of aliphatic and aromatic amino acids. It is commonly used to inactivate endonuclease enzymes during DNA purification schemes as well as to digest brain tissue for detection of proteinase resistant prion proteins. Proteinase K was dissolved at 20 mg/ml in 18.2 mΩ water.
   v) Casein from Bovine Milk was from Millipore Sigma, 218680. Casein are a family of phosphoproteins, with an isoelectric point around 4.6, and was hence negatively charged in the solutions in this work. It does not have secondary structure, nor any cysteine bonds, so that there is no tertiary structure, and it is not a globular protein. It is a natural emulsifier in milk and self assembles into micelles. The micelles formed from low molar mass k-casein molecules are spherical. Casein was dissolved at 10 mg/ml in pH 8 Tris under heating in an orbital shaker at 40° C. for 24 hours.

### Static and Dynamic Light Scattering, (SLS and DLS, Respectively)

A Brookhaven Instruments BI-90 (Holtsville, New York) was used for dynamic light scattering, using lₒ=640 nm as the vacuum wavelength of the vertically polarized incident light, and q=90° detection, with a fixed scattering vector magnitude of q=4πnₛ/λ₀ sin (θ/2)=178,970 cm⁻¹, where nₛ=1.333 is the index of refraction of water. Standard second order cumulant analysis was used, to yield the z-average diffusion coefficient and polydispersity index, Q, (ratio of quadratic term of the logarithm of power series expansion of the electric field autocorrelation term to the square of the linear term). A second DLS instrument, the Brookhaven 90 Plus with l₀=640 nm, was also used.

SLS was carried out on a Fluence Analytics (now Yokogawa Fluence Analytics, Houston, Texas) Argen device, equipped with 16 independent sample cells, each with its own adjustable temperature and stirring, and incident laser source at l₀=660 nm. Experiments are carried out simultaneously in as many as 16 independent sample cuvettes, inserted into the sample cells.

### Realtime Dialysis Monitoring

A device was developed that provides a cap structure insertable into any 1 cm cuvette, hence allowing realtime monitoring of membrane-mediated processes, such as dialysis, in any optical instrument which accepts this type of standard cuvette, such as static and dynamic light scattering, UV/visible absorption, fluorimeter, circular dichroism, etc. The dialysis cuvettes were used directly with the Brookhaven DLS and the Fluence Argen. The cap structure consists of a hollow cylindrical post around which a tubular membrane can be hermetically sealed, thus partitioning the fluid content of the cuvette into Fluid 1, constant at 2.5 ml, which contains the macromolecule of interest, and a Fluid 2, which contains the dialysate. Fluid 1 is stirred by a tiny impeller suspended in it, making no contact with the cuvette itself, thus providing non-contact stirring. This is a very important feature, since it has been amply demonstrated that contact-stir, where a magnetic stir bar sits on the bottom of the vessel and spins, can degrade most proteins, lipid nanoparticles, protein/polysaccharide conjugate vaccines, and viral capsids. The cap is fitted with an inlet and outlet so that the dialysate can be circulated externally through a reservoir, which allows both proportioning the volumes of Fluids 1 and 2, and accepting conductivity, pH, and other probes. Fluid 1 and any changes in the macromolecules due to dialysis is continuously monitored by whatever instrument the cuvette is placed into. In this work static and dynamic light scattering were used.

In this example, NaCl and guanidine-HCl (Gd) were used as the simple electrolyte and chaotropic agent, respectively. Since NaCl and Gd both increase the conductivity of aqueous solutions their concentration in Fluid 1 could be computed by continuously measuring the conductivity of Fluid 2. When dialyzing against 5M NaCl or 6M Gd Fluid 2 was 100 ml, such that Fluid 1 was at 4.88M NaCl and 5.85M Gd at the end of forward dialysis. In reverse dialysis to pure water Fluid 2 was at 1,000 ml, so that at the end of reverse dialysis Fluid 1 was at 0.00487 NaCl and 0.0058M Gd. For gelatin and BSA Fluid 2 was at 500 ml for reverse dialysis against 10 mM aqueous NaCl and against phosphate (NaH₂PO₄—Na₂HPO₄) or Tris/Trizma buffer systems, respectively.

The dialysis membrane was Sigma Aldrich cellulose D9277 with ~10,000 molar mass cutoff.

### Monitoring at Fixed [NaCl] and [Gd] for Time Dependent Processes

As in all ramped methods (e.g. Differential Scanning calorimetry), it is important that any time dependent processes occurring in the samples be faster than the ramp rate, so that the system is instantaneously in equilibrium at each point during the temporal ramp. Otherwise, the time dependent process in the sample can be convolved with the time dependent ramping procedure, clouding data interpretation. Accordingly, when evidence of time-dependent effects on the time scale of the dialysis was found, complementary time-dependent measurements were also made at fixed [NaCl] and [Gd].

### Interpretive Model for Polyelectrolyte, Polyampholyte, and H-Bond/Hydrophobic Effects

The trends in the results of dialysis for the various types of macromolecules can be interpreted with a basic dimensionless model combining intermacromolecular potential energies of repulsive polyelectrolyte interactions (E), of attractive polyampholyte interactions (A), and of attractive H-bond/hydrophobic effect potential energies (HP), which also subsume entropy changes, especially of the solvent. The object here is to make plausible forms of net potential energies under different interplays of E, A, and HP for chaotropic agents (Gd here), and E and A for simple electrolytes (NaCl here). When the net potential energy is positive no association or aggregation is expected to occur, and if aggregates or associations are present, the positive potential may lead to their dissociation. When the net potential is negative associations or aggregates can be formed. For purposes of terminology, ‘aggregate’ will refer here to irreversible associations of macromolecules, whereas ‘associations’ among macromolecules will be considered reversible. Since the focus in this work is on intermacromolecular processes the dimensionless model here does not include intramolecular potential energies. These can be added in future development, as the need arises.

In the results below, the use of dialysis of the macromolecules against NaCl and Gd can help to separate out which effects are operative and dominant over different concentration regimes. The idea of the dimensionless model is to make the interpretation plausible, not to make fits to the data. Further work can put absolute values on potential energies.

The model starts by allowing macromolecules to interact by all three effects: E, A, and HP. The polyelectrolyte (E) term considers that the macromolecules each have a net charge and hence repulsive interactions expressed by a positive screened electrostatic potential energy, U_{el,E}. The polyampholyte potential energy, U_{el,A}, is the negative screened potential energy between opposite charges of interacting chains. The model then posits a negative interchain potential energy due to possible H-bonds and hydrophobic effects, U_{HP}, but does not attempt to distinguish between the two types of attractive interactions at this level of development, since Gd can suppress both H-bond and hydrophobic effects.

When dealing with a non-chaotropic salt, such as NaCl, only U_{el,E} and U_{el,A} vary with ionic strength, whereas U_{HP}, which is negative, will remain constant. When a chaotropic salt, such as Gd, is considered, the U_{HP} decreases as [Gd] increases.

For a charge Q of a spherical object of radius R, the screened electrostatic potential (volts) of a charge φₑₗ(κ, r) at distance r is given by

$${ϕ}_{el} ( κ , r ) = \frac{Q}{4 π ε ( 1 + κ R )} \frac{{e}^{- κ ( r - R )}}{r} , r \geq R \qquad 1 )$$

where r is the distance from the charge φₑₗ(κ,r) is positive for φ_{el,E} and negative for φ_{el,A}, and κ is the Debye screening parameter, given by (in MKS units)

$$κ = {( \frac{2 {ρ}_{0} z e}{ε {k}_{B} T} )}^{1 / 2} \qquad 2 )$$

where ρ₀ is the charge density (C/m³) due to the bulk concentration of added electrolyte, which is either Gd or NaCl in the current case (ρ₀ is the charge density of positive charge, which of course is equal and opposite in sign to the negative charge density that reflects electroneutrality in the simple bulk electrolyte solution), e is the elementary charge, z is the valence for symmetric electrolytes (z=1 for both Gd and NaCl), ε=ε₀D, where ε₀=8.85×10⁻¹² C²/N-m² is the permittivity of free space and D is the solution dielectric constant (~80 for H₂O at STP), k_{B} is Boltzmann's constant (1.38×10⁻²³ J/K), and T is the temperature in Kelvin (κ is only weakly dependent on T near room temperature). Here, ρ₀ is proportional to the ionic strength of the electrolyte [IS] (mol/L)

$${ρ}_{0} ( C / {m}^{3} ) = 1000 {N}_{A} ze [ IS ] \qquad 3 )$$

[IS] is substituted by [Gd] and by [NaCl], in their respective cases.

The screened electrostatic potential energy between two interacting charges has a more complex expression and so will be synthesized here into an average dimensionless potential energy <Uₑₗ>. This potential energy is the electrostatic potential energy, averaged over all interaction distances between charges. The net electrostatic potential energy <U_{el,net}> is composed of the sum of the similarly spatially averaged positive polyelectrolyte potential energy <U_{el,E}> and negative polyampholyte potential energy <U_{el,A}>

$$〈 {U}_{el , net} 〉 ( [ IS ] ) = 〈 {U}_{el , E} 〉 ( [ IS ] ) + 〈 {U}_{el , A} 〉 ( [ IS ] ) \qquad 4 )$$

where [IS] is the ionic strength from any simple electrolyte, regardless of symmetry and valence, and includes the symmetric, monovalent Gd and NaCl. Because the distance has been averaged out in the dimensionless potential energies, the E and A potential energies can be simplified to

$$〈 {U}_{e l , E} 〉 ( [ IS ] ) = {〈 {U}_{e l , E} 〉}_{0} {e}^{- {β}_{E} \sqrt{[ IS ]}} \qquad 5 a )$$

$$〈 {U}_{el , A} 〉 ( [ IS ] ) = {〈 {U}_{el , A} 〉}_{0} {e}^{- {β}_{A} \sqrt{[ IS ]}} \qquad 5 b )$$

where [symbol] U_{el,E} [symbol] ₀ is the positive potential energy between two unscreened charges of the same sign (i.e. between two polyelectrolyte chains), and [symbol] U_{el,A} [symbol] ₀ is the negative potential energy between two unscreened charges of opposite sign. β_{E} and β_{A} subsumes the factors connecting κ and [IS] in Equations 2 and 3, and an average distance between two charges. β_{E} and β_{A} are different because the intercharge interactions occur on different length scales; i.e. distances between net charged polyelectrolyte chains in β_{E} and distance between opposite sign charges interacting closely between chains. According to Equations 5a,b the polyelectrolyte and polyampholyte potentials have different signs, magnitudes, and spatial variations.

In this treatment, the intrachain charge-charge interactions and HP interactions are ignored because the main features for the biomacromolecules under dialysis in this work are governed by interchain association, dissociations, and aggregation.

While the current model is dimensionless, future development will include absolute electrostatic potential energies. As an indication as to magnitudes, at r=1 nm, <Uₑₗ>₀~2×10⁻¹⁹J≈1 eV, where eV=electron-volt.

Now, <U_{HP}> ([IS]) represents averaged H-bond and hydrophobic associations and may be represented by a sigmoidal type cooperative binding expression for Gd

$$〈 {U}_{H P} 〉 ( [ Gd ] ) = B - {〈 {U}_{HP} 〉}_{0} \frac{1}{1 + {e}^{- γ ( ⌈ Gd ⌉ - {⌈ Gd ⌉}_{1 / 2} )}} \qquad 6 a )$$

where <U_{HP}>₀ is a negative potential energy, which is independent of [NaCl]. For NaCl <U_{HP}> is constant,

$$〈 {U}_{H P} 〉 ( [ NaCl ) ] = {〈 {U}_{HP} 〉}_{0} < 0 \qquad 6 b )$$

where the negative [symbol] U_{HP} [symbol] ₀ is the hydrophobic potential energy at [Gd]=0, [Gd]_{1/2} is the concentration of Gd at which the sigmoidal energy is at its half-value, γ controls the rate at which increasing [Gd] diminishes the H-bond/hydrophobic interaction. (Temperature=25° C. was not varied in the dialysis procedure and so the T-dependence of Uₕₚ is not explicitly shown). B is a constant given by

$$B = {〈 {U}_{HP} 〉}_{0} \frac{2 + {e}^{{γ [ Gd ]}_{1 / 2}}}{1 + {e}^{{γ [ Gd ]}_{1 / 2}}} \qquad 7 )$$

which ensures that

$$〈 {U}_{HP} 〉 ( [ Gd ] = 0 ) = {〈 {U}_{HP} 〉}_{0} \qquad 8 )$$

The average net energy of the system, <Uₙₑₜ> ([Gd]) is just the sum of the electrostatic and hydrophobic potentials. The net potential energies are then

$$〈 {U}_{net} 〉 ( [ Gd ] ) = 〈 {U}_{el , net} 〉 ( [ Gd ] ) + 〈 {U}_{HP} 〉 ( [ Gd ] ) \qquad 9 a )$$

$$〈 {U}_{net} 〉 ( [ NaCl ] ) = 〈 {U}_{el , net} 〉 ( [ NaCl ] ) + {〈 {U}_{HP} 〉}_{0} \qquad 9 b )$$

The behavior of [symbol] Uₙₑₜ [symbol] ([Gd]) and [symbol] Uₙₑₜ [symbol] ([NaCl]) in this model should determine whether interacting macromolecules dissociate or remain dissociated, associate, or aggregate. In developing biologic drug formulations the concentration regimes of electrolytes and other excipients can be determined so as to optimize stability of the formulations.

### Results

a Synthetic Polyelectrolyte, Polystyrene Sulfonate. E Interactions Only at Low Ionic Strength

PSS resembles a negatively charged random coil in solution, whose coil dimension is sensitive to ionic strength. The effects of ionic strength on coil size should be apparent during dialysis. There is no secondary structure in PSS, so that dialysis with Gd should not be substantially different than with NaCl.

FIG. 29 shows a Debye plot of PSS in 100 mM NaCl. PSS is a small molecule with hydrodynamic diameter D_{H}≤12 nm<<640 nm and 660 nm of incident light, so that DLS and SLS measurements should have no significant angular dependence, and measurements at q=90° yield q²<S²>_{z}/3<<1, and the q=0 expression can be used

$$\frac{K c}{{I}_{R}} = \frac{1}{{M}_{w}} + 2 {A}_{2} c + 3 {A}_{3} {c}^{2} + ⋯ \qquad 10 )$$

where c is the polymer mass concentration (g/cm³), I_{R} is the Rayleigh Scattering Ratio (1/cm), K is an optical constant, given for vertically polarized incident light by

$$K = \frac{4 {π}^{2} {{n}^{2} ( dn / d c )}^{2}}{{λ}_{0}^{4} {N}_{A}} \qquad 11 )$$

where n is the index of refraction of the aqueous medium (1.333), λ₀=640 or 660 nm is the vacuum wavelength of the incident light, N_{A} is Avogadro's number, and dn/dc=0.185 cm³/g is the incremental index of refraction of PSS in the aqueous medium.

Fitting the data in FIG. 29 with a quadratic function in concentration, Equation 10, yields weight average molar mass, M_{w}=58,980 g/mol, and at 100 mM NaCl, the second virial coefficient A_{2=0.0012} cm³-mol/g², and third virial coefficient A₃=0.0548 cm⁶-mol/g³.

For random coils A₃ is related to molar mass M by

$${A}_{3} = \frac{5 M {A}_{2}^{2}}{8} \qquad 12 )$$

A₃ from the quadratic fit term in FIG. 29 gives A₃=0.0548 cm⁶-mol/g³. A₃ computed by the theoretical Equation 12, using the values of M_{w} and A₂ in the figure, A₃=0.0539 cm⁶-mol/g³, is in remarkable agreement with the prediction. Furthermore, when scattered intensity is plotted versus c, there is a maximum intensity that occurs at cₘ, after which the intensity decreases due to A₃ as c increases above cₘ. The relationship between cₘ and M is

$${A}_{3} = \frac{1}{3 M {c}_{m}^{2}} \qquad 13 )$$

For the data of FIG. 29, cₘ=0.0105 g/cm³, which yields A₃=0.0505 cm⁶-mol/g³, by Equation 13, using M=M_{w}, which is in good agreement with both the quadratic fit to the data of FIG. 1 and the theoretical expression of Equation 12.

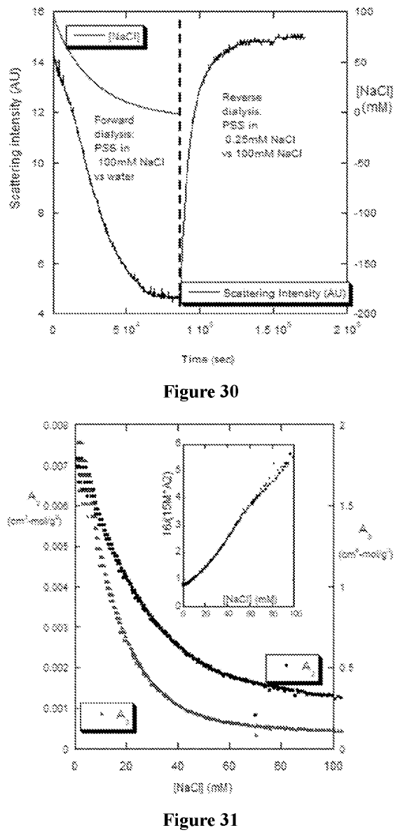

FIG. 30 up to 87,000 seconds shows the scattering intensity (arbitrary units) versus time as PSS at 0.00327 g/cm³ in 100 mM NaCl aqueous solution is forward dialyzed against pure water. Fluid 1 contained 2.5 ml of PSS solution, and the pure water dialysate comprised a reservoir of 1,000 ml. Also shown is [NaCl] in Fluid 1 during this forward cycle. After 87,000 s the PSS solution in Fluid 1, now at 0.25 mM NaCl, is dialyzed against 100 mM NaCl in Fluid 2.

Two immediate observations can be made concerning the complete dialysis cycle:
1) The dialysis process is fully reversible; i.e. PSS returns to its original scattering value after the complete cycle.
2) As expected for a polyelectrolyte, the scattering intensity decreases as the ionic strength ([NaCl]) decreases. This is due to the deshielding of the anionic sulfate groups, which causes the polyelectrolyte coil to expand, increasing the electrostatically enhanced mutual excluded volume b, and hence decreasing scattered intensity by Equation 1, because A₂ increases as

$${A}_{2} = β \frac{{N}_{A}}{2 {M}_{2}^{2}} \qquad 14 )$$

The importance of the A₃ term on scattered intensity increases as A₂ increases with decreasing [NaCl]. This is seen by the ratio of the second to third terms in Equation 10; the smaller the value the greater the effect of A₃ compared to A₂. By using Equation 12, which holds well in FIG. 29, the ratio can be expressed as

$$\frac{2 {A}_{2}}{3 {A}_{3} c} = \frac{16}{15 M {A}_{2} c} \qquad 15 )$$

The ratio runs from 5.4 at 100 mM NaCl to 0.77 at 0.25 mM NaCl. Equation 12 can be used to convert Equation 10 into a quadratic equation in A₂. Solving for A₂ using the Kc/I_{R} data for the forward dialysis, and then computing A₃ by Equation 12 yields the behavior for A₂ and A₃ shown in FIG. 31. The inset to FIG. 31 shows the ratio of the A₂ to A₃ term in Equation 10, given by Equation 15. At high [NaCl] the A₂ effect is much larger than the A₃ effect, but the effects become roughly equal at low [NaCl].

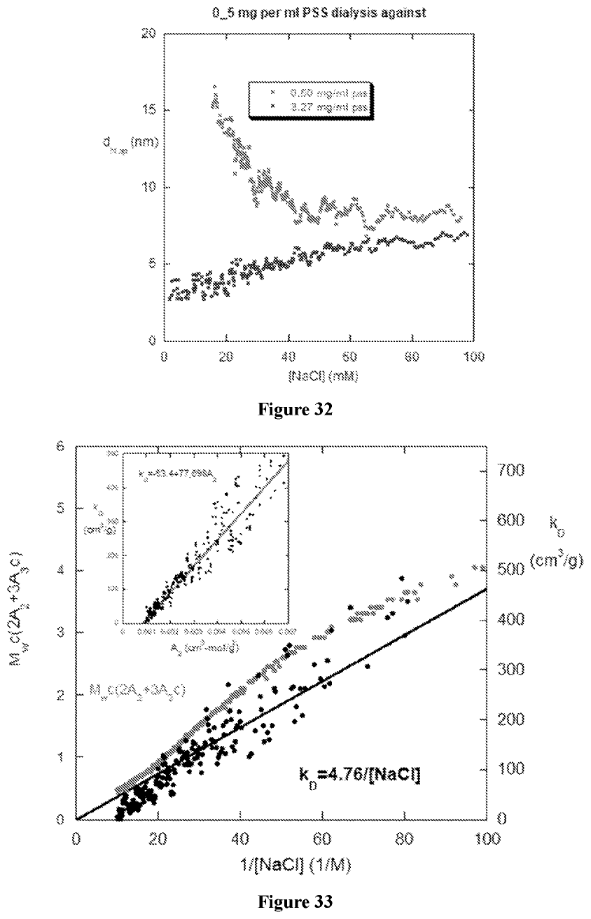

The DLS results are shown in FIG. 32 for the apparent hydrodynamic diameter d_{H,ap}. DLS measures the z-averaged translational diffusion coefficient, <D>_{z}, which is related by the Stokes-Einstein equation to the z-average reciprocal hydrodynamic diameter

$${〈 \frac{1}{{d}_{H}} 〉}_{z}$$

$${〈 D 〉}_{z} = \frac{{k}_{B} T}{3 π η} {〈 \frac{1}{{d}_{H}} 〉}_{z} \qquad 16 )$$

where η is the solution viscosity. The ‘hydrodynamic diameter’ reported by most DLS instruments is an ‘apparent hydrodynamic diameter’, d_{H,ap}, which is the reciprocal of the z-averaged reciprocal hydrodynamic diameter

$${〈 \frac{1}{{d}_{H}} 〉}_{z} ,$$

that is

$${d}_{H , ap} = \frac{1}{{〈 \frac{1}{{d}_{H}} 〉}_{z}} \qquad 17 )$$

The trend in FIG. 32 for PSS at 3.27 mg/ml is that d_{H,ap} increases with [NaCl]. There are two effects that can occur concerning <D>_{z}: i) The polyelectolyte coil should shrink as [NaCl] increases, so that d_{H,ap} decreases and ii) the hydrodynamic interaction parameter k_{D} should decrease as increasing [NaCl] weakens the interpolymer interactions so that d_{H,ap} increases. The interaction effect, expressed to first order is

$${〈 D 〉}_{z} = {〈 D 〉}_{z , 0} ( 1 + {k}_{D} ( [ NaCl ] ) c ) ) \qquad 18 )$$

where k_{D}([NaCl]) explicitly shows that k_{D} depends on [NaCl], c is the polymer concentration, and [symbol] D [symbol] _{z,0} is the z-averaged diffusion coefficient extrapolated to c=0 at high [NaCl].

FIG. 32 shows that the latter effect ii) dominates at 3.27 mg/ml PSS. At very low [NaCl] the scattered intensity was low and erratic, leading to large fluctuations in <D>_{z} and polydispersity (from the second cumulant of the autocorrelation function expansion).

It is interesting to note that at very low |NaCl| there is no ‘slow mode of diffusion’ (i.e. low <D>_{z} at very low [NaCl]); at very low ionic strength the well-dissolved polyelectrolyte scatters very little light, allowing even small amounts of aggregates or impurities to erratically dominate the weak scattering and yield anomalously low diffusion coefficients (‘The stars come out at night’).

FIG. 32 also shows that effect i) dominates at 0.50 mg/ml PSS; the polyelectrolyte coil shrinks as [NaCl] increases. This is contrasted with the opposite trend at 3.27 mg/ml where effect ii) dominates; the hydrodynamic interaction parameter k_{D} should decrease as increasing [NaCl] weakens the interpolymer interactions so that d_{H,ap} increases.

FIG. 33 shows k_{D} ([NaCl]) versus 1/[NaCl] obtained from

$${k}_{D} = \frac{( {〈 D 〉}_{z} - {〈 D 〉}_{z , 0} )}{{〈 D 〉}_{z , 0} c} \qquad 19 )$$

k_{D} becomes quite large as [NaCl] decreases. This is to be expected, since the inter-chain repulsion increases as [NaCl] decreases and the scattering becomes increasingly dominated by the A₂ and A₃ inter-chain interaction terms. FIG. 32 also shows the dimensionless ratio of the A₂ and A₃ terms to the M_{w} term, given by

$${M}_{w} c ( 2 {A}_{2} + 3 {A}_{3} c ) \qquad 20 )$$

FIG. 32 shows that, whereas the M_{w} term dominates at high [NaCl], the combined A₂ and A₃ effects rapidly grow significantly larger than the M_{w} term as [NaCl] decreases. The inset to FIG. 32 shows k_{D} versus A₂. It is frequently claimed that k_{D} is a sort of ‘hydrodynamic A₂’ and should be functionally related. The inset to FIG. 32 shows an essentially linear relationship between k_{D} and A₂.

Dialysis of PSS in pure water against Gd showed the same type of ionic strength behavior as with NaCl, and was fully reversible.

A Natural Polyampholyte: Gelatin. Combined E, A, and HP Interactions

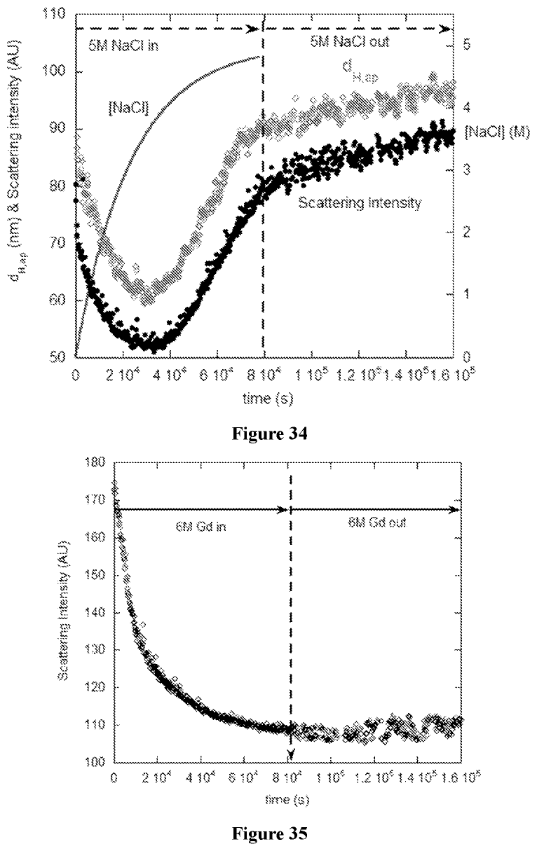

FIG. 34 shows scattering intensity (AU) and d_{H,ap} for gelatin initially in aqueous 10 mM NaCl and dialyzed against 5M NaCl, and for reverse dialysis against pure water. [NaCl] is also shown for the forward dialysis. d_{H,ap} closely follows the form of scattering intensity. FIG. 35 shows scattering intensity for gelatin dialysis against 6M Gd and reverse against 10 mM NaCl (d_{H.ap} was also steady, not shown). Fluid 1 was 2.5 ml and Fluid 2 was 100 ml for the forward dialysis and 500 ml for the reverse dialysis. Hence, at the end of the forward dialysis [NaCl]_{forward,final}=4.87M, and [Gd]_{forward,final}=5.85M, and for the reverse dialysis [NaCl]_{reverse,final}=0.020M, and [Gd]_{reverse,final}=0.029M.

The data are described as follows: In pure water, because there are negative and positive charges on the polymer chains there is some initial association of chains in pure water due to polyampholyte attraction between positive and negative charges. As ionic strength increases initially for both NaCl and Gd the opposite charges are shielded from each other, the attractive polyampholyte potential energy <U,_{el,A}> decreases and the chains dissociate. In NaCl after about 2.8M [NaCl] the chains begin to re-associate, as seen in the increasing intensity and d_{H,ap} in FIG. 35. These arrive at a final value, and these re-associated chains are not reversible, when dialyzing back against pure water, and so are considered irreversible aggregates. In Gd there is likewise a dissociation as [Gd] increases, but there is no re-association all the way up to 6M Gd, and the chains remain dissociated upon reversal. In the Gd case the disassociation is irreversible.

These effects can be conceptually understood by the interpretive model above. Since Gd can interrupt both H-bonds and suppress the hydrophobic effect, it follows that one or both of these latter effects is involved in the re-association of chains in NaCl. This follows because the re-association does not occur in Gd, which suppresses these effects. In NaCl the conjecture is that as [NaCl] initially increases the attractive polyelectrolyte electrostatic associations are suppressed and allow dissociation of chains. As further shielding by NaCl occurs they get close enough to each other that the hydrophobic and/or H-bond forming portions of the chains can form associations. These associations are stronger than the electrostatic associations and so the chains remain irreversibly associated with each other even as [NaCl] decreases during reverse dialysis. This suggests that the initial associations among chains is nearly wholly electrostatic and that the association at high [NaCl] is due to hydrophobic and/or H-bond effects.

The interpretive model considers each of the initial gelatin polymer chains as being both a polyelectrolyte with a net charge and a polyampholyte, which interact with each other via electrostatic potential energies, <U_{el,E}> and <U_{el,A}>, and H-bond/hydrophobic potential energies. For a ‘generic’ gelatin pKₐ~4.7, so that in the unbuffered solution the polymers should have a net negative charge, giving it polyelectrolyte properties in addition to polyampholyte interactions due to mixed positive and negative charge groups in the gelatin amino acids. Furthermore, gelatin can associate via hydrogen bonds (H-bonds) and hydrophobic effects.

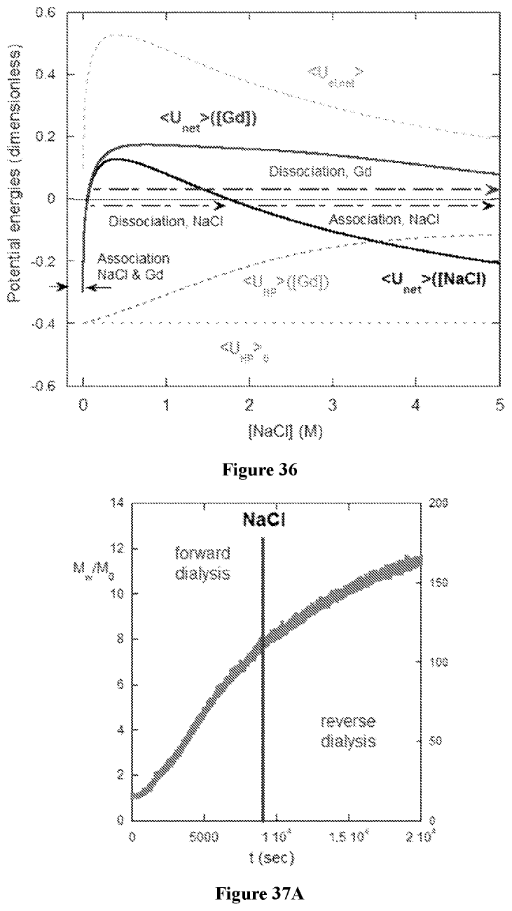

FIG. 36 shows dimensionless <Uₙₑₜ>[Gd]) and <Uₙₑₜ> ([NaCl]), from Equations 9a,b, using the following parameters; β_{E}=1, β_{A}=2 nm, <U_{el,E}>₀=2, <U_{el,A}>₀=−1.9, <U_{hp,0}>=−0.40, γ=1 (1/M), [Gd]_{1/2}=1M, κ (1/nm)∈{0, 2.5}, and [IS]=κ². <U_{el, net}> is also shown, and is the same for NaCl and Gd. <U_{HP}> is also shown for both NaCl, for which <U_{HP}> is constant, and for Gd, for which <U_{HP}> diminishes sigmoidally.

FIG. 36 shows that <Uₙₑₜ><0 at very low [IS], so there is interchain association. At low [IS] during forward dialysis, with both NaCl and Gd, <Uₙₑₜ> quickly becomes positive, with the onset of chain dissociation. As [NaCl] increases <Uₙₑₜ> ([NaCl]) goes negative, due to the unchanging, negative <U_{HP}> ([NaCl]), and so chains begin to re-associate, and continue to re-associate until the end of forward dialysis at 5M NaCl. Upon reverse dialysis against water, the associations are irreversible, and show a slow further increase in time.

In contrast to NaCl, as [Gd] increases during forward dialysis, <U_{HP}> ([Gd]) weakens and <Uₙₑₜ> ([Gd]) remains positive throughout, so that dissociation continues. Upon reverse dialysis the chains remain unassociated.

This behavior is captured over a wide range of the above parameters, and no attempt is made here to set limits on each parameter.

A Natural Polyelectrolyte: Alginate. E and HP Interactions

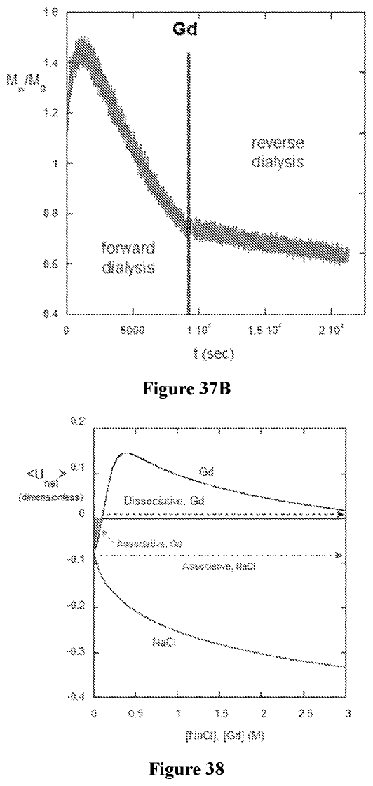

Alginate in its sodium form is a polyanionic polysaccharide. FIG. 37A shows the scattering intensity behavior for 0.001 g/cm³ alginate dialyzed from pure water against 4M NaCl, and the reverse dialysis against pure water after the alginate was at 2.5M NaCl. The data are represented as M_{w}(t)/M₀, where M_{w}(t) is the weight average molar mass at time t, and M₀ is the initial molar mass at t=0. While the initial increase might be construed as an expected polyelectrolyte effect, as for PSS above, it becomes clear that this scattering increase is due to an association process, which continues throughout the forward dialysis, and then continues unabated during reverse dialysis against water. This suggests that the association process is driven by HP effects, and forms aggregates of increasing size, whose ability to further associate under HP effects remains, even as [NaCl] is dialyzed away. The associations are hence irreversible aggregates.

FIG. 37B shows the scattering intensity behavior for 0.001 g/cm³ alginate dialyzed from pure water against 6M Gd, and the reverse dialysis against pure water after the alginate was at 3.8M Gd. The difference from FIG. 37A is striking. There is an initial rise in scattering, similar to FIG. 37A, but then a maximum in scattering is reached and then decreases monotonically for the rest of the forward dialysis, to a value lower than its starting value in water. During the reverse dialysis there is a continued decrease in scattering, but at a highly reduced rate. By the end of the reverse dialysis the scattering is less than at the beginning of the dialysis cycle. This suggests that there were already associations between alginate chains originally, in pure water, and that the Gd both dissociates these as well as aggregates formed in the very early phase of forward dialysis, where intensity increases, before peaking and decreasing as [NaCl] increases further.

The behavior of FIGS. 37A-37B can be interpreted by the above combined electrostatic and HP effects. Now, however, there is no polyampholyte term, so <U_{el,A}>=0, while <U_{el,E}> is the polyelectrolyte term due to the negatively charged alginate chains.

There is a substantial biochemical difference between gelatin and alginate, the former being a complex, polyampholytic protein bearing most of the 20 amino acids, and the latter a relatively simple polysaccharide which is a copolymer of β-D-mannuronate and «-L-guluronate, each with a carboxylate group. Alginate is a well-known gel-forming polymer where stacking of the saccharides between chains occurs in conjunction with Ca ions, and has an ‘eggbox’ structure. While there was no gelation in the low concentration alginate solutions (0.001 mg/ml) dialyzed with NaCl and Gd, there is clearly association occurring and this association is disrupted by Gd. Hence, it seems that the associations occurring under the dialysis conditions here are due to H-bond/hydrophobic (HP) effects. As such, the same type of HP potential energy, <U_{HP}>, used for gelatin can be used here, even though the molecular bass of the HP effects may be quite different between amino acids and uronic acid sugars.

Equations 9a and 9b for gelatin can be expressed for alginate, in the absence of polyampholyte effects, where <U_{el,A}>=0, so that <U_{el,net}>=<U_{el,E}>

$$〈 {U}_{net} 〉 ( [ Gd ] ) = 〈 {U}_{el , E} 〉 ( [ Gd ] ) + 〈 {U}_{H P} 〉 ( [ Gd ] ) \qquad 21 a )$$

$$〈 {U}_{net} 〉 ( [ NaCl ] ) = 〈 {U}_{e l , E} 〉 ( [ NaCl ] ) + 〈 {U}_{H P} 〉 \qquad 21 b )$$

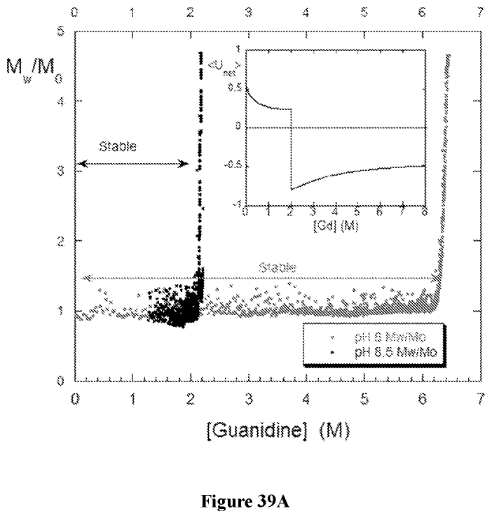

Equations 6a and 6b can be used directly for <U_{HP}>, with the understanding that the parameters appearing in them will be different between gelatin and alginate. FIG. 38 shows the net potentials for Gd and NaCl versus [NaCl] and [Gd]. The model captures the fact that <Uₙₑₜ> ([NaCl]) versus [NaCl] is negative throughout, so that there is always a tendency for alginate chains to associate. Because these associations are irreversible they are ‘aggregates’ in the current terminology.

In contrast <Uₙₑₜ> ([Gd]) starts negative for low [Gd] and so there is initial association. This is seen in the early steep rise from negative to positive potential energy in FIG. 37B. As [Gd] increases Uₙₑₜ ([Gd]) quickly becomes positive, and remains positive for the rest of the dialysis, leading to dissociation.

The parameters used in FIG. 38 were <U_{HP}>₀=−0.45, β_{E}=0.5, U_{el,0}=0., [Gd]_{1/2}=0.5M, γ=2.5 (1/M), [NaCl], [Gd]=2.5κ². These parameters are merely illustrative, and many other combinations predict similar behavior.

### A Selection of Proteins

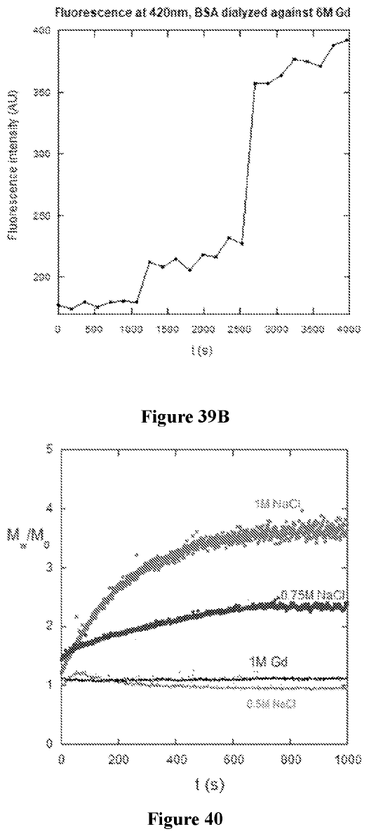

Bovine Serum Albumen (BSA). A, E, and HP interactions. FIG. 39A shows the results of BSA dialysis against 6.5M Gd, where the BSA is buffered with PBS at pH=8.0 in one dialysis run, and at pH=8.5, buffered with Tris in the other. The data are shown in terms of M_{w}(t)/M₀, where M₀ is the initial unaggregated scattering from BSA and M_{w}(t) is the weight average molar mass of all BSA in the solution, in both native and aggregated forms. The isoelectric point of BSA is around 4.7, so it should have a net negative charge at the pH values here.

Remarkably, there is a very sharp threshold in each case in which colloidal aggregation sets in. The data go vertically off scale in each case. It is further striking that there is such a wide difference in stability against Gd due to a fairly small difference in pH. In both cases the aggregation was completely irreversible.

No threshold or large-scale aggregation was found while dialyzing against NaCl. This implies that the aggregation threshold during dialysis against Gd requires HP interactions. Since Gd suppresses HP effects, it would seem the aggregation is electrostatic in nature, and may correspond to association of opposite charges once the BSA denatures due to Gd. When BSA is intact the net negative charge keeps it from aggregating—the opposite charges on two chains can't overcome this barrier to interact—but once the structure opens up, there is the possibility of closer opposite charge associations that are suppressed when the BSA is in globular form.

Following the above model of combined electrostatic and HP potentials it can be surmised that below the threshold only <U_{el,E}> and <U_{HP}> are operative, and the polyampholyte potential <U_{el,A}> is negligible. Upon unfolding, opposite charges between chains can interact more closely and <U_{el,A}>, which is negative (attractive) abruptly becomes much more important. When this potential ‘turns on’, <Uₙₑₜ> goes negative and the aggregation ensues. The inset to FIG. 39A shows what such a net potential might look like, where the same parameters as in FIG. 36 are used, except in FIG. 39<U_{el,A}> is zero until the aggregation threshold at [Gd]_{threshold}=2M for pH 8.5, at which point <U_{el,A}> turns on with the form [symbol] U_{el,A} [symbol] =−1.9e^{-0.3\sqrt{Gd}}.

FIG. 39B shows fluorescence emission at 420 nm when BSA is excited at 280 nm during 6M Gd dialysis in a fluorimeter. There is a sharp threshold at 2,500 s, reenforcing the SLS dialysis result against 6M Gd.

Lysozyme. E and HP interactions. Lysozyme dialysis against 1M Gd showed no effect. Measuring possible time-dependence in separate non-dialysis experiments showed no time dependent effects, including up to 4M Gd. In contrast, NaCl caused time-dependent aggregation of lysozyme after 0.5M NaCl. Hence, running NaCl dialysis crosses time scales with aggregation that occurs at fixed [NaCl], so that the data are not quantitatively meaningful. Under dialysis against 4M NaCl the lysozyme showed immediate aggregation leading to strong particulate formation. Upon reverse dialysis the time-dependent aggregation continued.

FIG. 40 shows the time-dependent aggregation of lysozyme for fixed values of [NaCl] above 0.5M NaCl. It also shows no measurable aggregation at (and below) 0.5M NaCl. The non-aggregating data for 1M Gd is shown in the figure, and non-aggregation continued until 4M Gd.

Following the electrostatic/HP energetic model above, the results are similar to those for alginate, FIG. 38, except for several distinguishing features: i) the strong time dependence of aggregation for lysozyme, ii) <Uₙₑₜ> for Gd is positive throughout (unlike in FIG. 38, there is no low [Gd] negative potential, as seen for alginate), and so no aggregation occurs, and iii) <Uₙₑₜ> is positive for NaCl up until 0.5M, after which it becomes negative, leading to aggregation NaCl (whereas in FIG. 10 for alginate <U>ₙₑₜ ([NaCl] is always negative). Immunoglobulin (IgG). E and HP interactions. Immunoglobulin has a mass around 150,000 g/mol and presents an interesting profile under dialysis against 6M Gd, seen in FIG. 13. There is an abrupt rise in d_{H,ap} at very low [Gd], from 12 nm to 30 nm, after which d_{H,ap} falls monotonically as [Gd] increases, down to 16 nm. Upon reverse dialysis d_{H,ap} increases from 16 nm to about 27 nm; i.e. it approaches the forward dialysis value it had after the initial abrupt increase.

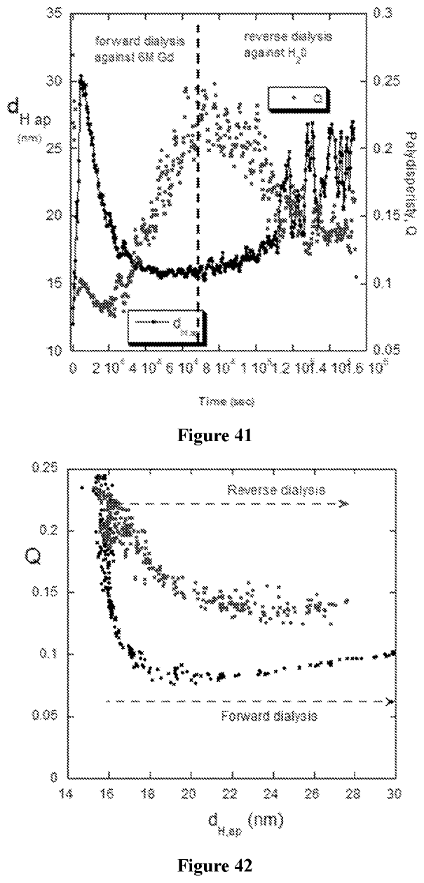

I_{R} almost exactly mirrors the trend of d_{H,ap} in the forward and reverse dialysis, so the second y-axis in FIG. 41 is used for polydispersity, Q, from the DLS second cumulant analysis. At a glance it supports the partial reversibility of the dialysis. Interestingly, Q increases as d_{H,ap} decreases.

An interpretation of the data is that the ionic strength provided at low [Gd] is enough to shield net charge between the IgG, and HP effects cause association, perhaps to an oligomeric form, such as a dimer, tetramer, or higher. This oligomeric form may be well-defined, because Q drops precipitously from 0.27 (medium polydispersity) to <0.10 (low polydispersity) after the abrupt increase in d_{H.ap}. It is further surmised that as [Gd] increases the HP effects are interrupted and the oligomers dissociate, but non-uniformly, so that there is a spread of d_{H,ap} among the associations, leading to markedly increasing polydispersity, back to its original value by the end of the forward dialysis.

Upon reverse dialysis against water there is a re-association which ‘gathers up’ the dissociated fragments and re-assembles them towards the well-defined oligomeric form after the initial abrupt increase, while Q decreases. Hence, the fragmentation and buildup of oligomers in the forward and reverse dialyses, respectively, is at least partially reversible.

This conjectured fragmentation of a ‘stable’ oligomeric form with accompanying increasing polydispersity, and its reverse process can be better appreciated in FIG. 42. In most aggregation processes Q increases or stays the same with increasing aggregation and d_{H,ap}; FIG. 42 shows a remarkable deviation from this trend.

The forward dialysis profile of IgG versus Gd is qualitatively similar to forward dialysis of alginate versus Gd in FIG. 37B; an initial rise in scattering intensity followed by a steady decrease. The difference is that in reverse dialysis alginate is not at all reversible, whereas the IgG oligomers are at least partially reversible. The electrostatic and HP potential profiles for IgG may resemble <Uₙₑₜ>([Gd]) for alginate dialysis against Gd, shown in FIG. 38, including the initial negative portion. This difference in reversibility between alginate and IgG suggests an ordered, associated structure in the reversible case of IgG, as opposed to a random colloidal aggregate for alginate. This seems plausible because globular proteins are known to functionally associate in vivo, whereas alginate, resembling a random coil in space, has no symmetry that might lead to an organized structure.

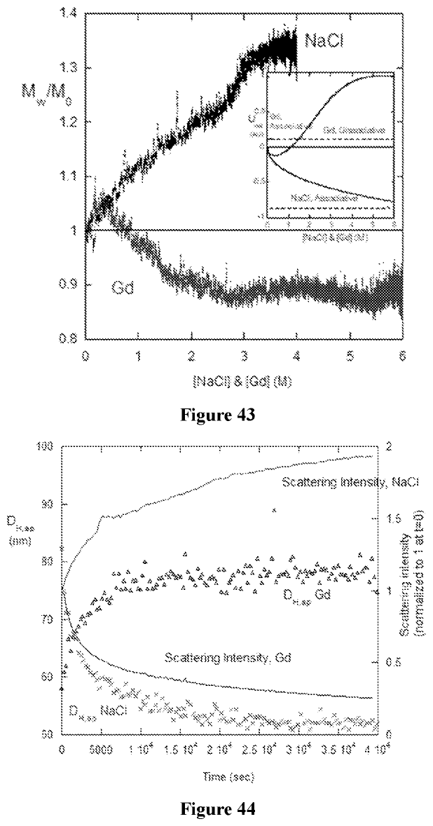

Proteinase k. E and HP interactions. FIG. 43 shows the contrast of proteinase k behavior under dialysis from pure water against 4M NaCl, and from pure water against 6M Gd. With NaCl aggregation sets in immediately and climbs to a maximum. With Gd there is initial aggregation until about 0.5M NaCl, after which dissociation begins. M_{w}/M₀ drops below 1.0 at about 0.8M, suggesting that there were some associations in the initial solution, which after aggregating at low [Gd] then dissociate.

The behavior is qualitatively similar to that of alginate in NaCl and Gd dialysis. This was interpreted with the screened potential of Equation 16a and HP potential of Equations 18a.b.

The inset to FIG. 43 shows the energy model, which involves the <U_{HP}> from Equations 6a (Gd) and 6b (NaCl), and the repulsive polyelectrolyte potential of Equation 5a. The parameters are β=1, rₑ=0.18, [Gd]_{1/2}=2 (M), γ=1 (1/M), U_{hp,0}=−2.0, U_{el,e,0}=2.0. The energy model in the FIG. 43 inset is qualitatively similar to the alginate potential in FIG. 38, including the negative potential at low [Gd] causing associations to form before <Uₙₑₜ> turns positive at around 0.5M Gd.

Casein micelles. E, A, HP and intraparticle interactions. Casein presents an unusual dialysis profile, both against NaCl and Gd, FIG. 44. As NaCl increases the scattering intensity increases but d_{H,ap} decreases. The Gd case is exactly the opposite; as Gd increases scattering decreases but d_{H,ap} increases. Q decreases for NaCl and increases for Gd (data not shown).

It should first be noted that casein micelles are quite complex and not fully understood. There are several different models for the structure of casein micelles, all of which are plausible, but none of which is definitive. The immediate purpose here is to show the new data resulting from the monitored dialysis as a means of providing complementary information to understand more about the micellar behavior, not to solve the structural problem. The interpretive model is used next to attempt a partial phenomenological conjecture of the data trends.

The phosphoproteins in casein micelles give them a strong negative charge in the aqueous solution used. The micelles are held together by hydrophobic and electrostatic interactions. Hence, it can be conjectured that the increase in intensity with increasing [NaCl] is the usual polyelectrolyte effect of charge screening between casein micelles, with subsequent lowering of A₂, such as for PSS in FIGS. 30 and 31. The fact that d_{H,ap} simultaneously decreases suggests that there are attractive intramicellar polyampholyte effects that are suppressed, causing the micelles to partially dissociate into smaller micelles, perhaps subunits, which are still highly charged. If true, this implies that casein micellization is affected by both polyampholyte and hydrophobic interactions. The decreasing Q with [NaCl] suggests that the smaller micelles have a narrowing size distribution.

While Gd at low concentration has a simple polyelectrolyte effect early in the Gd dialysis of alginate—an initial rise in scattering—before its HP interactions begin to dominate and intensity falls, in the Gd dialysis of casein there is an immediate decrease in scattering intensity at low [Gd], which continues to decrease as [Gd] increases. Hence, the ability of Gd to disturb the micelles seems to begin immediately as Gd dialysis begins, and this thoroughly dominates over any polyelectrolyte effect. A conjecture is that Gd begins to immediately weaken the hydrophobic interactions within the micelles, allowing water to penetrate into the interior, swelling the micelles, thus increasing d_{H,ap} and/or changing the morphology; e.g. from spheres to rods or fibers.

The interpretive model as it stands only considers interparticle E, A, and HP interactions, and does not take account of intraparticle E,A, and HP interactions. The extension of the model to include both inter- and intra-particle effects is left to a next phase of research.

### Summary of Results

Monitoring light scattering behavior of macromolecules undergoing membrane dialysis against a salt (NaCl) and a denaturant (Guanidine-HCl) revealed an intricate interplay of potential energies; Positive (repulsive) polyelectrolyte (E), and negative (attractive) polyampholyte (A), and associative H-bond/hydrophobic (HP) potential energies. An interpretive, dimensionless model based on these potential energies rationalizes the associative, aggregative, and dissociative behavior of the protein and polysaccharide biomacromolecules monitored. No attempt was made here, however, to define the absolute strengths of the potentials and find fits to the data. Rather, dimensionless analysis was used to understand the results, and an analysis of the absolute values of the potentials related to macromolecular nanostructure is left to further work.

Table 1 summarizes observations and behavior for the various macromolecules.

TABLE 1
Summary of interactions and behavior for the macromolecules monitored during dialysis.

| | Interactions | | | NaCl | | | Gd | | |
|---|---|---|---|---|---|---|---|---|---|
| Polymer | E | A | HP | [NaCl]ₘₐₓ | Behavior | Rev | [Gd]ₘₐₓ | Behavior | Rev |
| PSS | y | n | N | 0.1M | Polyelectrolyte | Yes | 0.1M | Polyelectrolyte | Yes |
| Alginate | y | n | Y | 2.5M | Aggregative/HP | No | 3.8M | Polyel/ | No |
| | | | | | | | | Dissociative/HP | |
| Gelatin | y | y | Y | 5M | Polyelect/ | No | 6M | Polyel/ | No |
| | | | | | Polyamph/HP | | | Dissociative/HP | |
| BSA | y | y | Y | 4M | Polyelectrolyte/ | NA | 6M | Sharp | No |
| | | | | | HP | | | aggregation | |
| | | | | | | | | threshold | |
| Lysozyme | y | n | Y | 1M | Dialysis | No | 1M | No change | No change |
| | | | | | hindered by | | | | |
| | | | | | time-dependent | | | | |
| | | | | | aggregation | | | | |
| IgG | | | | NA | NA | NA | 6M | Polyel/HP/ | partial |
| | | | | | | | | associative/ | |
| | | | | | | | | dissociative | |
| Proteinase | y | n | Y | 4M | Polyelect/HP/ | no | 6M | HP/dissociative | No |
| | | | | | associative | | | | |
| Casein | y | y | y | 4M | complex | no | 6M | complex | no |

E = Polyelectrolyte potential
A = Polyampholyte potential
HP = hydrophobic and/or H-bond effects
NA = data not available

Polystyrene sulfonate (PSS) was the only non-biological macromolecule investigated. Because only the repulsive polyelectrolyte potential <U_{el,E}> was operative over the range of ionic strength used, the dialysis was fully reversible. Detailed information was obtained on the ionic strength dependence of second and third virial coefficients, A₂ and A₃, diffusion coefficient. A linear relationship was found between A₂ and the hydrodynamic interaction parameter k_{D}.

The dialysis monitoring method can be used in many contexts. Effects on macromolecules and colloids can be found for different types of small molecules, such as electrolytes of varying species, valence, and symmetry, denaturants, chelating agents, surfactants, and excipients in general. Effects of solution tonicity on cells and organelles can also be monitored. Because the dialysis apparatus fits into any standard 1 cm cuvette, it can be used with any instrument that accepts such cuvettes, including UV/visible, fluorescence, and circular dichroism spectrometers.

It is hoped that this approach will both offer new insights into the physics of macromolecules and aid in the formulation and stability of biologic drugs. In the latter case, regimes of stability versus concentration of different electrolytes and agents can be determined as the dialysis process sweeps across a continuous range of concentrations.

### REFERENCES

Dobrynin, A. V., ‘Polyelectrolytes: On the doorsteps of the second century’, Polymer, 202, 122714, 2020
Durmaz, E. N.; Sahin, S.; Ettore, V.; de Beer, S; de Smet, L. C. P. M.; de Vos, W. M., ‘Polyelectrolytes as building blocks for next-generation membranes with advanced functionalities’, ACS Appl Polym. Materials, 3, 9, 4347-4374, 2021
Muthukumar, M., ‘50th Anniversary perspective; A perspective on polyelectrolyte solutions’, Macromolecules, 50,9528-9560, 2017
‘Polymer electrolytes: Characterization techniques and energy applications’, Winier, T, Arof, A. K., Thomas, S., Eds., Wiley VCH, 2020
Patrick Masson and Sofya Lushchekina, “Conformational Stability and Denaturation Processes of Proteins Investigated by Electrophoresis under Extreme Conditions,” Molecules 27, no. 20 (Oct. 13, 2022): 6861, https://doi.org/10.3390/molecules27206861.
Charles Tanford, “Protein Denaturation,” in Advances in Protein Chemistry, vol. 23 (Elsevier, 1968), 121-282, https://doi.org/10.1016/S0065-3233 (08) 60401-5.
Qi-Yi Li et al., “Multi-Level Aggregation of Conjugated Small Molecules and Polymers: From Morphology Control to Physical Insights,” Reports on Progress in Physics 84, no. 7 (July 1,2021): 076601, https://doi.org/10.1088/1361-6633/abfaad.
G. Brankica Janković and Ð. Natalija Polović, “The Protein Folding Problem,” Jul. 19, 2017, https://doi.org/10.5281/ZENODO.827151.
Claudio Soto and Sandra Pritzkow, “Protein Misfolding, Aggregation, and Conformational Strains in Neurodegenerative Diseases,” Nature Neuroscience 21, no. 10 (October 2018): 1332-40, https://doi.org/10.1038/s41593-018-0235-9.
Dobson, C. M., Principles of protein folding, misfolding and aggregation, Semin. Cell Dev. Biol., 15, 3-16, 2004.
Wang, W.; Roberts C. J., ‘Aggregation of therapeutic proteins’, John Wiley & Sons, 2010.
Weiss I V, W. F.; Hodgdon, T. K.; Kaler, E. W.; Lenhoff, A. M.; Roberts, C. J., ‘Nonnative protein polymers: structure, morphology, and relation to nucleation and growth’, Biophysical J. 93, 4392-4403, 2007.
Kayser, V.; Chennamsetty, N.; Voynov, V.; Helk, B.; Forrer, K.; Trout, B. L., ‘Evaluation of a non-arrhenius model for therapeutic monoclonal antibody aggregation’, J. Pharm. Sci. 100 2526-2542, 2011.
Thirumangalathu, R.; Krishnan, S.; Brems, D. N.; Randolph, T. W.; Carpenter, J. F., ‘Effects of pH, temperature, and sucrose on benzyl alcohol-induced aggregation of recombinant human granulocyte colony stimulating factor’, J. Pharm. Sci. 95, 1480-1497, 2006.
Y. Li, B. A. Ogunnaike, C. J. Roberts, Multi-variate approach to global protein aggregation behavior and kinetics: effects of pH, NaCl, and temperature for achymotrypsinogen, A, J. Pharm. Sci. 99 (2010) 645e662.
Sahin, E.; Grillo, A. O.; Perkins, M. D.; Roberts, C. J., ‘Comparative effects of pH and ionic strength on protein-protein interactions, unfolding, and aggregation for IgG1 antibodies’, J. Pharm. Sci. 99, 4830-4848, 2010.
Charles B. Chen et al., “Overview of Albumin Physiology and Its Role in Pediatric Diseases,” Current Gastroenterology Reports 23, no. 8 (August 2021): 11, https://doi.org/10.1007/s11894-021-00813-6.
P. Velos, P. M. H. Cherry, and D. Miller, “An Improved Method for Measuring Human Tear Lysozyme Concentration,” Archives of Ophthalmology 103, no. 1 (Jan. 1, 1985): 31-33, https://doi.org/10.1001/archopht.1985.01050010035012.
Edgar Kraus and Uwe Femfert, “Proteinase K from the Mold Tritirachium Album Limber. Specificity and Mode of Action,” Hoppe-Seyler's Zeitschrift Für Physiologische Chemie 357, no. 2 (January 1976): 937-48, https://doi.org/10.1515/bchm2.1976.357.2.937.
Detlev Riesner, “Biochemistry and Structure of PrPC and PrPSc,” British Medical Bulletin 66, no. 1 (Jun. 1, 2003): 21-33, https://doi.org/10.1093/bmb/66.1.21.
Braun, Hanewald, and Vilgis, “Milk Emulsions: Structure and Stability,” Foods 8, no. 10 (Oct. 11, 2019): 483, https://doi.org/10.3390/foods8100483.
H. M. Farrell, “Models for Casein Micelle Formation,” Journal of Dairy Science 56, no. 9 (September 1973): 1195-1206, https://doi.org/10.3168/jds.S0022-0302 (73) 85335-4.
Verwey, E. J.; Overbeek, J. T. G., Theory of the stability of lyphobic colloids', Elsevier, NY, 1948
Hogg, R.; Healy, T. W.; Fuerstenau, D. W., Transactions Faraday Society, 62, 1638, 1966.
S. C. Lin; W. I. Lee, J. M. Schurr, **, Biopolymers 17, 1041-1064, 1978.
M. Drifford, J. P. Dalbiez, ‘Light scattering by dilute solutions of salt-free polyelectrolytes’, J. Phys. Chem., 88, 5368-5375, 1984.
Smits, R. G.; Kuil, M. E.; Mandel, M., ‘Quasi elastic light scattering on solutions of linear flexible polyelectrolytes at low ionic strengths’, Macromolecules, 27, 5599-5608, 1994.
S. G. Ghosh; R. M. Peitzsch; W. F. Reed, “Aggregates and other particles as the origin of the ‘Extraordinary” diffusional phase in polyelectrolyte solutions”, Biopolymers, 32, 1105-1122, 1992.
Imai, N.; Mandel, M., Macromolecules, 15, 1562, 1982.
Tanahatoe, J. J.; Kuil, M. E., ‘Dynamic light scattering of a flexible highly charged polyelectrolyte in the dilute concentration regime’, Macromolecules, 30, 6102-6106, 1997.
L. Cao; W. Lu; A. Mata; K. Nishinari; Y. Fang, ‘Egg-box model-based gelation of alginate and pectin; A review’ Carbohydrate Polymers, 242, 116389, 2020.
Dalgleish, D. G. ‘Casein micelles as colloids: surface structures and stabilities, J. Dairy Science, 81, 3013-3018, 1998.
Holt, C., ‘Structure and stability of bovine casein micelles’, Advances in Protein Chemistry, 43, 63-151, 1992.
Horne, D. S., ‘Casein interactions’, Int. Dairy Journal, 8, 171-177, 1998.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods in addition to those shown and described herein are intended to fall within the scope of the appended claims. Further, while only certain representative compounds, components, compositions, and method steps disclosed herein are specifically described, other combinations of the compounds, components, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A system (100) comprising:
a receptacle (102) housing a first fluid (106) and a second fluid (104) wherein the first fluid and the second fluid are separated by a membrane (108); and
a principal monitoring instrument (110) configured to repeatedly interrogate the first fluid;
wherein the receptacle is reversibly insertable within the principal monitoring instrument.

2. The system of claim 1, wherein the receptacle is reversibly insertable within a sample holder (112) disposed within the principal monitoring instrument.

3. The system of any of claims 1-2, further comprising a second fluid circulation path (114) fluidly connected to the second fluid.

4. The system of claim 3, wherein the second fluid circulation path comprises a closed-loop circulation path.

5. The system of claim 3, wherein the second fluid circulation path comprises an open-loop circulation path.

6. The system of claim 5, wherein the second fluid circulation path terminates in a waste container.

7. The system of any of claims 3-6, wherein the second fluid circulation path further comprises an external reservoir (116), at least one external monitoring instrument (118) configured to repeatedly interrogate the second fluid present in the second fluid circulation path, or a combination thereof.

8. The system of claim 7, wherein the at least one external monitoring instrument comprises a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a Raman scattering detector, a chromatographic separation system allowing periodic injection of small aliquots of the second fluid present in the fluid circulation path, or a combination thereof.

9. The system of any of claims 3-8, wherein the second fluid circulation path passes through an external monitoring instrument that comprises a flow-cell equipped instrument.

10. The system of any of claims 1-9, further comprising a first fluid circulation path (120) fluidly connected to the first fluid.

11. The system of claim 10, wherein the first fluid circulation path comprises a closed-loop circulation path.

12. The system of claim 10, wherein the first fluid circulation path comprises an open-loop circulation path.

13. The system of claim 12, wherein the first fluid circulation path terminates in a waste container.

14. The system of any of claims 10-13, wherein the first fluid circulation path further comprises an external reservoir (116), at least one external monitoring instrument (118) configured to repeatedly interrogate the first fluid present in the first fluid circulation path, or a combination thereof.

15. The system of claim 14, wherein the at least one external monitoring instrument comprises a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a Raman scattering detector, a chromatographic separation system allowing periodic injection of small aliquots of the first fluid present in the first fluid circulation path, or a combination thereof.

16. The system of any of claims 10-15, wherein the first fluid circulation path passes through an external monitoring instrument that comprises a flow-cell equipped instrument.

17. The system of any of claims 1-16, wherein the first fluid and the second fluid have different compositions.

18. The system of any of claims 1-17, wherein the first fluid comprises a mixture of components.

19. The system of any of claims 1-18, wherein the first fluid comprises a small molecule, a polymer, a colloid, or a combination thereof.

20. The system of any of claims 1-19, wherein the second fluid comprises a mixture of components.

21. The system of any of claims 1-20, wherein the second fluid comprises a small molecule, a polymer, a colloid, or a combination thereof.

22. The system of any of claims 1-21, wherein the membrane comprises a dialysis membrane, an ion-selective membrane, a 3D membrane, a biological membrane, or a synthetic biological membrane.

23. The system of any of claims 1-22, wherein the membrane is hydrophilic or hydrophobic.

24. The system of any of claims 1-23, wherein the receptacle has a perimeter is defined by a geometric shape chosen from square, rectangular, polygonal, hemi-polygonal, and circular.

25. The system of any of claims 1-24, wherein the receptacle comprises a 1 cm pathlength cuvette cell sized to be received within a sample holder of a spectrometer.

26. The system of any of claims 1-25, wherein the receptacle is fabricated from a transparent material, such as quartz, glass, or a plastic.

27. The system of any of claims 1-26, wherein the the principal monitoring instrument is chosen from a static light scattering detector, a dynamic light scattering detector, combined static and dynamic light scattering detector, a fluorimeter, an absorption spectrometer, a refractometer, a differential refractometer, a turbidity monitor, an NMR, a polarimeter, or a circular birefringence or dichroism detector.

28. The system of any of claims 1-27, wherein the principal monitoring instrument can measure more than one property of the first fluid.

29. The system of claim 28, wherein the more than one property comprises static light scattering, dynamic light scattering, fluorescence, ultraviolet absorption, visible absorption, turbidity, and infrared absorption.

30. The system of any of claims 1-29, wherein the principal monitoring instrument is configured to continuously interrogate the first fluid.

31. The system of any of claims 1-29, wherein the principal monitoring instrument is configured to interrogate the first fluid.

32. The system of any of claims 1-31, wherein the receptacle comprises a cap assembly (122), and wherein the membrane is mounted on the cap assembly.

33. The system of any of claims 1-32, wherein the fluid contents of the receptacle are partitioned by a sheet formed from the membrane secured by a hermetically sealing means.

34. The system of any of claims 1-33, further comprising an electrode assembly configured to apply an electric field within the receptacle.

35. The system of any of claims 1-34, further comprising an electrode assembly in electrochemical contact with the first fluid, the second fluid, or a combination thereof.

36. The system of any of claims 1-35, further comprising a stirrer configured to stir the first fluid, the second fluid, or a combination thereof.

37. The system of any of claims 1-36, wherein the system further comprises an access port for adding or withdrawing a material from the first fluid, the second fluid, or a combination thereof.

38. The system of any of claims 1-37, wherein the first fluid, the second fluid, or a combination thereof comprises a biologic active agent.

39. The system of any of claims 1-38, wherein the system is configured for real-time monitoring of a membrane-mediated chemical processes.

40. A device comprising
a cap assembly (122) dimensioned to be received within and seal a receptacle, wherein the cap assembly comprises:
a body portion (124) insertable within an opening of a receptacle;
a mounting post (126) extending from a bottom of the body portion, wherein the mounting post is configured for attachment of a membrane.

41. The device of claim 40, wherein the cap assembly is sized to be received within a 1 cm pathlength cuvette cell.

42. The device of any of claims 40-41, wherein the cap assembly further comprises a first fluid inlet (132) and a first fluid outlet (134) disposed on the body portion and fluidly extending to the bottom of the body portion so as to fluidly connect to a first fluid present within the receptacle when the cap assembly is disposed within an opening of the receptable.

43. The device of any of claims 40-42, wherein the cap assembly further comprises a second fluid inlet (128) and a second fluid outlet (130) disposed on the body portion and fluidly extending to the mounting post so as to fluidly connect to a second fluid present within a membrane affixed to the mounting post

44. The device of any of claims 40-43, wherein the mounting post comprises one or more grooves (136) to facilitate attachment of the membrane via a clamp, clip, or o-rings.

45. The device of any of claims 40-44, further comprising a stirrer (140) extending from the bottom of the body portion of the cap assembly.

46. The device of claim 45, further comprising a motor (150) mounted on the body portion, and a drive shaft (152) operatively coupling the stirrer to the motor.

47. The device of any of claims 40-46, further comprising
an electrode support (142) extending from a bottom of the body portion; and
a first electrode (144) and a second electrode (146) disposed on the electrode support;
wherein the first electrode and the second electrode are each electrically connected to a terminal (148) disposed on the body portion.

48. The device of claim 47, wherein the electrode support is dimensioned such that when the cap assembly is disposed within the receptacle, the electrode support extends into the receptacle such that the electrodes are in contact with a fluid present within the receptacle.

49. The device of any of claims 47-48, wherein the electrode support, the first electrode, and the second electrode are dimensioned to allow for right angle (90°) detection when the cap assembly is seated in a receptacle and positioned within a principal monitoring instrument.

50. The device of any of claims 47-49, wherein the electrode support, the first electrode, and the second electrode are dimensioned to allow for zero angle to low angle detection (0° to 30°) when the cap assembly is seated in a receptacle and positioned within a principal monitoring instrument.

51. The device of any of claims 47-50, wherein the electrode support, the first electrode, and the second electrode are dimensioned to allow for transmission of incident electromagnetic radiation and backscatter detection (at angled of from 150° to 180°) when the cap assembly is seated in a receptacle and positioned within a principal monitoring instrument.

52. The device of any of claims 47-51, wherein the first electrode and the second electrode comprise parallel plate electrodes.

53. The device of any of claims 47-51, wherein the first electrode and the second electrode comprise parallel wire mesh electrodes.

54. The device of any of claims 47-53, wherein the first electrode and the second electrode are sized and positioned to generate an electric field that straddles path length of incident electromagnetic radiation emitted by a principal monitoring instrument when the cap assembly is seated in a receptacle and positioned within the principal monitoring instrument.

55. The device of any of claims 47-54, wherein the first electrode and the second electrode are separated by a distance of less than 10 mm, such as a distance of from 2 mm to 5 mm.

56. The device of any of claims 47-55, further comprising a power supply and a current loop operatively coupled to the first electrode and the second electrode, wherein the current loop comprises:
a resitor
a volmeter configured to measure a voltage across the first electrode and the second electrode; and
an ammeter configured to measure a current in the current loop which passes through the power supply, the resistor, the, the first electrode, and the second electrode.

57. The device of claim 56, wherein the resistor R is chosen so that the power dissipation when the safety resistor alone is connected across the power supply, the following expression is satisfied
V₀²/R<Pₘₐₓ,
where Vₒ is the amplitude of the voltage of of the power supply, R is the resistance of the resistor, and Pₘₐₓ is the minimum value of the maximum power dissipations permissible for the power source and associated circuit components.

58. A method for monitoring of a membrane-mediated chemical processes, the method comprising:
introducing a first fluid and a second fluid into a receptacle, wherein the first fluid and the second fluid are separated by a membrane;
inserting the receptacle into a principal monitoring instrument; and
repeatedly interrogating the first fluid with the principal monitoring instrument.

59. The method of claim 58, wherein the first fluid and the second fluid have different compositions.

60. The method of any of claims 58-59, wherein the first fluid comprises a mixture of components.

61. The method of any of claims 58-60, wherein the first fluid comprises a small molecule, a polymer, a colloid, or a combination thereof.

62. The method of any of claims 58-61, wherein the method comprises monitoring a change in one or more properties of the first fluid using the principal monitoring instrument.

63. The method of any of claims 58-62, wherein the first fluid comprises a polymer, a colloid, or a combination thereof; and
wherein second fluid does not comprise a polymer, a colloid, or a combination thereof, but does comprise an agent that can affect the polymer, the colloid, or the combination thereof present in the first fluid.

64. The method of claim 63, wherein the agent is chosen from an electrolyte, a denaturing agent, an acid, a base, a surfactant, a chelating agent, an emulsifier, a toxin, a dye, a fluorescent probe, a lipid, a biocide, a drug, a dissimilar liquid phase, an artificial or biological oligomer, a sugar, an alcohol, a free amino acid, a buffering solution, or a combination thereof.

65. The method of any of claims 58-64, wherein the membrane comprises a dialysis membrane, an ion-selective membrane, a 3D membrane, a biological membrane, or a synthetic biological membrane.

66. The method of any of claims 58-65, further comprising circulating the second fluid through a second fluid circulation path,
optionally wherein the second fluid circulation path further comprises an external reservoir, at least one external monitoring instrument configured to repeatedly interrogate the second fluid present in the second fluid circulation path, or a combination thereof.

67. The method of claim 66, wherein the method further comprises interrogating the second fluid present in the second fluid circulation path using the at least one external monitoring instrument.

68. The method of any of claims 66-67, wherein the at least one external monitoring instrument comprises a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a chromatographic separation system allowing periodic injection of small aliquots of the circulating fluid, or a combination thereof.

69. The method of any of claims 58-68, further comprising a circulating the first fluid through a first fluid circulation path,
optionally wherein the first fluid circulation path further comprises an external reservoir, at least one external monitoring instrument configured to repeatedly interrogate the first fluid present in the first fluid circulation path, or a combination thereof.

70. The method of claim 69, wherein the method further comprises interrogating the first fluid present in the first fluid circulation path using the at least one external monitoring instrument.

71. The method of any of claims 69-70, wherein the at least one external monitoring instrument comprises a conductivity sensor, a pH sensor, an ion specific sensor, a dissolved gas sensor, a static light scattering detector, a dynamic light scattering detector, a fluorimeter, an absorption spectrophotometer, a polarimeter, a circular dichroism or birefringence detector, a refractometer, an NMR, a turbidity monitor, a chromatographic separation system allowing periodic injection of small aliquots of the circulating fluid, or a combination thereof.

72. The method of any of claims 58-71, wherein repeatedly interrogating the first fluid with the principal monitoring instrument comprises continuously interrogating the first fluid.

73. The method of any of claims 58-71, wherein repeatedly interrogating the first fluid with the principal monitoring instrument comprises interrogating the first fluid.

74. The method of any of claims 58-73, wherein the method further comprises altering a composition of the first fluid over time while repeatedly interrogating the first fluid with the principal monitoring instrument.

75. The method of any of claims 58-74, wherein the method further comprises determining when the membrane-mediated chemical process is acceptably complete.

76. The method of claim 75, wherein the method further comprises altering a composition of the second fluid when the membrane-mediated chemical process is acceptably complete.
